(19) United States
(12) Patent Application Publication
(10) Pub. No.: US 2023/0254746 A1
(43) Pub. Date: Aug. 10, 2023

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/131,884

(22) Filed: Apr. 7, 2023

Related U.S. Application Data
(63) Continuation of application No. PCT/CN2021/122731, filed on Oct. 9, 2021.

(30) Foreign Application Priority Data
Oct. 9, 2020 (CN) 20201071794.2
Oct. 16, 2020 (CN) 202011107247.5
May 21, 2021 (CN) 202110555954.9
May 21, 2021 (CN) 202110556007.1

(51) Int. Cl. H04W 36/30; H04L 5/00; H04W 36/00; H04W 36/08

(52) U.S. Cl. CPC H04W 36/30; H04L 5/0048; H04W 36/00725; H04W 36/0085; H04W 36/08

(57) ABSTRACT

The present application discloses a method and a device in a node for wireless communications. A first node receives a first reference signal group to determine a first-type received quality group; maintains a second counter according to the first-type received quality group; and transmits a first signal. The first signal indicates a first reference signal; when a first counter is no larger than a first threshold, the first reference signal belongs to a first reference signal subset; when the first counter is larger than the first threshold, the first reference signal belongs to a second reference signal subset; a reference signal in the second reference signal subset does not belong to the first reference signal subset; as a response to a first condition set being satisfied, the first signal is triggered. The method above achieves rapid cross-cell beam switch, thus guaranteeing the service quality and avoiding ping-pong effect.

### CROSS REFERENCE TO RELATED APPLICATIONS

This application is the continuation of the international patent application PCT/CN2021/122731, filed on Oct. 9, 2021, and claims the priority benefit of Chinese Patent Application 202011071794.2, filed on Oct. 9, 2020; and claims the priority benefit of Chinese Patent Application 202011107247.5, filed on Oct. 16, 2020; and claims the priority benefit of Chinese Patent Application 202110555954.9, filed on May 21, 2021; and claims the priority benefit of Chinese Patent Application 202110556007.1, filed on May 21, 2021, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In Long-term Evolution (LTE) systems, inter-cell handover is controlled by a base station based on measurements of a User Equipment (UE). And the inter-cell handover in the 3rd Generation Partner Project (3GPP) Release (R) 15 basically adopts the mechanism used in the LTE. As for a New Radio (NR) system, more application scenarios need to be supported. Some scenarios, such as Ultra-Reliable and Low Latency Communications (URLLC), has posed high demands on the delay, and new challenges are also presented against inter-cell handover.

In the NR system, Massive Multiple Input Multiple Output (MIMO) is a significant technical feature. In Massive MIMO, multiple antennas form through beamforming a narrow beam pointing in a specific direction to enhance communication quality. Since the beam formed by multiple antennas through beamforming is generally narrow, beams from both sides of communications are required to be aligned for performing effective communications.

### SUMMARY

Inventors find through researches that beam-based communications will have negative influence on inter-cell handover, such as extra delay and pingpong effect. Then how to reduce the negative impact and go deeper in improving the performance of users at the cell boundary to meet various demands of application scenarios is an issue remaining to be solved.

To address the above problem, the present application provides a solution. It should be noted that although the statement above only took the cellular system, massive MIMO and beam-based communication scenarios for example, the present application is also applicable to other scenarios, such as LTE multi-antenna system, Vehicle-to-Everything (V2X), Device-to-Device (D2D) system and single-antenna system, where technical effects similar to the above-mentioned scenarios can be achieved. Additionally, the adoption of a unified solution for various scenarios, including but not limited to cellular systems, massive MIMO, beam-based communications, and LTE multi-antenna system, V2X, D2D and single-antenna systems, contributes to the reduction of hardcore complexity and costs. In the case of no conflict, the embodiments of a first node and the characteristics in the embodiments may be applied to a second node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first reference signal group to determine a first-type received quality group, the first-type received quality group comprising at least one first-type received quality;

maintaining a second counter according to the first-type received quality group; and

transmitting a first signal;

herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

In one embodiment, a problem to be solved in the present application includes: how to switch between beams of different cells swiftly to improve the performance of cell-boundary users while avoiding the pingpong effect arising from frequent handovers. In the above method, a UE measures reference signals from multiple cells and prioritizes selecting reference signal(s) from a specific cell (such as but not limited to a serving cell, a PCell or a cell in an MCG), thus solving the above problem.

In one embodiment, characteristics of the above method include: each reference signal in the first reference signal subset is from a specific cell, and the first node gives preference to choosing the reference signal(s) of the specific cell.

In one embodiment, characteristics of the above method include: the second reference signal subset comprises reference signals of other cell(s), including but not limited to neighboring cell(s) or cell(s) in an SCG, when none of the reference signal(s) of the specific cell lives up to the performance requirement, the first node will choose the reference signals of the other cell(s) to ensure the quality of services.

In one embodiment, an advantage of the above method includes: achieving quick cross-cell beam handover and enhancing the performance of users at the cell boundary, and meanwhile avoiding the delay and potential service interruption caused by cell handover.

In one embodiment, an advantage of the above method includes: the UE will choose reference signals of a specific cell in the first place, so that the service quality can be guaranteed and the pingpong effect can be prevented.

According to one aspect of the present application, characterized in that there is a reference signal in the first reference signal subset being associated with a first cell, and there is a reference signal in the second reference signal subset being associated with a second cell.

According to one aspect of the present application, characterized in comprising:

as a response to the action of transmitting a first signal, monitoring a first signaling in a first time window;

herein, time-domain resources occupied by the first signal are used to determine the first time window.

According to one aspect of the present application, characterized in comprising:

maintaining the first counter;

herein, when the value of the first counter reaches a third threshold, indicating a random access problem to a higher layer, the third threshold being greater than the first threshold.

According to one aspect of the present application, characterized in comprising:

transmitting a second signal; and

as a response to the action of transmitting a second signal, monitoring a second signaling in a second time window;

herein, time-domain resources occupied by the second signal are used to determine the second time window;

as a response to the first condition being satisfied, the second signal is triggered; the first condition set comprises a second condition, the second condition comprising not receiving the second signaling in the second time window.

According to one aspect of the present application, characterized in that the second signal is used to determine a second reference signal, a transmit (Tx) power of the first signal being equal to a first power value; whether the first reference signal and the second reference signal are a same reference signal is used to determine the first power value.

According to one aspect of the present application, characterized in comprising:

receiving M reference signals, M being a positive integer greater than 1;

herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

According to one aspect of the present application, the first node is a UE.

According to one aspect of the present application, the first node is a relay node.

The present application provides a method in a second node for wireless communications, comprising:

transmitting a first reference signal sub-group, any reference signal in the first reference signal sub-group belonging to a first reference signal group, the first reference signal group being used to determine a first-type received quality group, the first-type received quality group comprising at least one first-type received quality; and

blind detecting a first signal;

herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; the first-type received quality group is used to maintain the second counter.

According to one aspect of the present application, characterized in that there is a reference signal in the first reference signal subset being associated with a first cell, and there is a reference signal in the second reference signal subset being associated with a second cell; the second node is a maintenance base station for the first cell.

According to one aspect of the present application, characterized in comprising:

as a response to an action of detecting the first signal, transmitting a first signaling in a first time window;

where the second node detects the first signal; time-domain resources occupied by the first signal are used to determine the first time window.

According to one aspect of the present application, characterized in that whether the first signaling is received in the first time window is used to maintain the first counter.

According to one aspect of the present application, characterized in comprising:

blind detecting a second signal;

when the second signal is detected, as a response to the action of detecting the second signal, transmitting a second signaling in a second time window;

herein, time-domain resources occupied by the second signal are used to determine the second time window;

as a response to the first condition being satisfied, the second signal is triggered; the first condition set comprises a second condition, the second condition comprising that the second signaling is not received in the second time window.

According to one aspect of the present application, characterized in that the second signal is used to determine a second reference signal, a transmit (Tx) power of the first signal being equal to a first power value; whether the first reference signal and the second reference signal are a same reference signal is used to determine the first power value.

According to one aspect of the present application, characterized in comprising:

transmitting M1 reference signal(s) among M reference signals, M being a positive integer greater than 1 and M1 being a positive integer no greater than M;

herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

According to one aspect of the present application, the second node is a base station.

According to one aspect of the present application, the second node is a UE.

According to one aspect of the present application, the second node is a relay node.

The present application provides a method in a third node for wireless communications, comprising:

blind detecting a first signal;

herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; a first-type received quality group is used to maintain the second counter, and a first reference signal group is used to determine the first-type received quality group, the first-type received quality group comprising at least one first-type received quality.

According to one aspect of the present application, characterized in comprising:

transmitting a second reference signal sub-group;

herein, any reference signal in the second reference signal sub-group belongs to the first reference signal group.

According to one aspect of the present application, characterized in that there is a reference signal in the first reference signal subset being associated with a first cell, and there is a reference signal in the second reference signal subset being associated with a second cell; the third node is a maintenance base station for the second cell.

According to one aspect of the present application, characterized in comprising:

as a response to an action of detecting the first signal, transmitting a first signaling in a first time window;

where the third node detects the first signal; time-domain resources occupied by the first signal are used to determine the first time window.

According to one aspect of the present application, characterized in that whether the first signaling is received in the first time window is used to maintain the first counter.

According to one aspect of the present application, characterized in comprising:

blind detecting a second signal;

when the second signal is detected, as a response to the action of detecting the second signal, transmitting a second signaling in a second time window;

herein, time-domain resources occupied by the second signal are used to determine the second time window; as a response to the first condition being satisfied, the second signal is triggered; the first condition set comprises a second condition, the second condition comprising that the second signaling is not received in the second time window.

According to one aspect of the present application, characterized in that the second signal is used to determine a second reference signal, a transmit (Tx) power of the first signal being equal to a first power value; whether the first reference signal and the second reference signal are a same reference signal is used to determine the first power value.

According to one aspect of the present application, characterized in comprising:

transmitting M2 reference signal(s) among M reference signals, M being a positive integer greater than 1 and M2 being a positive integer less than M;

herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

According to one aspect of the present application, the third node is a base station.

According to one aspect of the present application, the third node is a UE.

According to one aspect of the present application, the third node is a relay node.

The present application provides a first node for wireless communications, comprising:

a first receiver, receiving a first reference signal group to determine a first-type received quality group, the first-type received quality group comprising at least one first-type received quality;

a first processor, maintaining a second counter according to the first-type received quality group; and

a first transmitter, transmitting a first signal;

herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

The present application provides a second node for wireless communications, comprising:

a second transmitter, transmitting a first reference signal sub-group, any reference signal in the first reference signal sub-group belonging to a first reference signal group, the first reference signal group being used to determine a first-type received quality group, the first-type received quality group comprising at least one first-type received quality; and

a second receiver, blind detecting a first signal;

herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; the first-type received quality group is used to maintain the second counter.

The present application provides a third node for wireless communications, comprising:

a second processor, blind detecting a first signal;

herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; a first-type received quality group is used to maintain the second counter, and a first reference signal group is used to determine the first-type received quality group, the first-type received quality group comprising at least one first-type received quality.

The present application provides a method in a first node for wireless communications, comprising:

receiving a first reference signal group to determine a first-type received quality group, the first-type received quality group comprising at least one first-type received quality;

maintaining a third counter according to the first-type received quality group; and

transmitting a first signal;

as a response to the action of transmitting a first signal, monitoring a first channel in a first time window, time-domain resources occupied by the first signal being used to determine the first time window;

herein, as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, a problem to be solved in the present application includes: how to switch between beams of different cells quickly to enhance the performance of users at the cell boundary. the above method allows the UE to measure reference signals from multiple cells and meanwhile attempt to perform accesses to different cells, thus solving the above problem.

In one embodiment, characteristics of the above method include: the first reference signal subset and the second reference signal subset comprise reference signals from different cells, the first node attempts to perform accesses to different cells based on measurement results, and counts numbers of times of attempts for different cells respectively.

In one embodiment, characteristics of the above method include: the first reference signal group is used to determine whether there occurs a beam failure and whether it is necessary for a re-access. Attempts of access for different cells are triggered by a measurement for a same group of reference signals, that is, the first reference signal group.

In one embodiment, an advantage of the above method includes: allowing the UE to attempt accessing to different cells simultaneously, thus achieving a rapid cross-cell beam switch and enhancing the performance of cell-boundary users.

In one embodiment, an advantage of the above method includes: respectively counting numbers of attempting times of accesses for different cells, thus ensuring the fairness in accessing to different cells.

According to one aspect of the present application, characterized in comprising at least one of:

maintaining the first counter;

or maintaining the second counter;

herein, whether there is one condition being satisfied between a fourth condition and a fifth condition is used to determine whether to transmit a random access problem indication to a higher layer; the fourth condition comprises that a value of the first counter reaches a first threshold, and the fifth condition comprises that a value of the second counter reaches a second threshold.

According to one aspect of the present application, characterized in that there is a reference signal in the first reference signal subset being associated with a first cell, and there is a reference signal in the second reference signal subset being associated with a second cell.

According to one aspect of the present application, characterized in that a transmit (Tx) power of the first signal is equal to a first power value; when the first reference signal belongs to the first reference signal subset, a value of a fourth counter is used to determine the first power value; when the first reference signal belongs to the second reference signal subset, a value of a fifth counter is used to determine the first power value.

According to one aspect of the present application, characterized in comprising at least one of:

maintaining the fourth counter;

or maintaining the fifth counter;

herein, a value of the first counter is used to maintain the fourth counter, while a value of the second counter is used to maintain the fifth counter.

According to one aspect of the present application, characterized in comprising:

receiving M reference signals, M being a positive integer greater than 1;

herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

According to one aspect of the present application, characterized in comprising:

transmitting a second signal; and

as a response to the action of transmitting a second signal, monitoring a second channel in a second time window;

herein, time-domain resources occupied by the second signal are used to determine the second time window; as a response to the first condition being satisfied, the second signal is triggered; the first condition set comprises a third condition, the third condition comprising not receiving the second channel in the second time window.

According to one aspect of the present application, the first node is a UE.

According to one aspect of the present application, the first node is a relay node.

The present application provides a method in a second node for wireless communications, comprising:

receiving a first signal;

as a response to the action of receiving a first signal, transmitting a first channel in a first time window, time-domain resources occupied by the first signal being used to determine the first time window;

herein, as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

According to one aspect of the present application, characterized in comprising:

transmitting a first reference signal sub-group;

herein, any reference signal in the first reference signal sub-group belongs to the first reference signal group.

According to one aspect of the present application, characterized in that there is a reference signal in the first reference signal subset being associated with a first cell, and there is a reference signal in the second reference signal subset being associated with a second cell.

According to one aspect of the present application, characterized in that a transmit (Tx) power of the first signal is equal to a first power value; when the first reference signal belongs to the first reference signal subset, a value of a fourth counter is used to determine the first power value; when the first reference signal belongs to the second reference signal subset, a value of a fifth counter is used to determine the first power value.

According to one aspect of the present application, characterized in that a value of the first counter is used to maintain the fourth counter, while a value of the second counter is used to maintain the fifth counter.

According to one aspect of the present application, characterized in comprising:

transmitting M1 reference signal(s), any reference signal of the M1 reference signal(s) being one of the M reference signals, M being a positive integer greater than 1 and M1 being a positive integer no greater than M;

herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

According to one aspect of the present application, characterized in comprising:

receiving a second signal;

as a response to the action of receiving a second signal, transmitting a second channel in a second time window;

herein, time-domain resources occupied by the second signal are used to determine the second time window; as a response to the first condition being satisfied, the second signal is triggered; the first condition set comprises a third condition, the third condition comprising that the second channel is not received in the second time window.

According to one aspect of the present application, the second node is a base station.

According to one aspect of the present application, the second node is a UE.

According to one aspect of the present application, the second node is a relay node.

The present application provides a method in a third node for wireless communications, comprising:

transmitting M2 reference signal(s), M2 being a positive integer;

herein, as a response to a first condition set being satisfied, a first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; as a response to the action of transmitting the first signal, a transmitter of the first signal monitors a first channel in a first time window; time-domain resources occupied by the first signal are used to determine the first time window; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset; any reference signal of the M2 reference signal(s) belongs to the first reference signal subset or the second reference signal subset.

According to one aspect of the present application, characterized in comprising:

transmitting a second reference signal sub-group;

herein, any reference signal in the second reference signal sub-group belongs to the first reference signal group.

According to one aspect of the present application, characterized in that there is a reference signal in the first reference signal subset being associated with a first cell, and there is a reference signal in the second reference signal subset being associated with a second cell.

According to one aspect of the present application, characterized in that a transmit (Tx) power of the first signal is equal to a first power value; when the first reference signal belongs to the first reference signal subset, a value of a fourth counter is used to determine the first power value; when the first reference signal belongs to the second reference signal subset, a value of a fifth counter is used to determine the first power value.

According to one aspect of the present application, characterized in that a value of the first counter is used to maintain the fourth counter, while a value of the second counter is used to maintain the fifth counter.

According to one aspect of the present application, characterized in that any reference signal of the M2 reference signal(s) is one of M reference signals, M being a positive integer greater than 1 and M2 being a positive integer no greater than M; any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

According to one aspect of the present application, characterized in comprising:

receiving a second signal;

as a response to the action of receiving a second signal, transmitting a second channel in a second time window;

herein, time-domain resources occupied by the second signal are used to determine the second time window; as a response to the first condition being satisfied, the second signal is triggered; the first condition set comprises a third condition, the third condition comprising that the second channel is not received in the second time window.

According to one aspect of the present application, the third node is a base station.

According to one aspect of the present application, the third node is a UE.

According to one aspect of the present application, the third node is a relay node.

The present application provides a first node for wireless communications, comprising:

a first receiver, receiving a first reference signal group to determine a first-type received quality group, and as a response to the action of transmitting a first signal, monitoring a first channel in a first time window, the first-type received quality group comprising at least one first-type received quality, and time-domain resources occupied by the first signal being used to determine the first time window;

a first processor, maintaining a third counter according to the first-type received quality group; and

a first transmitter, transmitting the first signal;

herein, as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

The present application provides a second node for wireless communications, comprising:

a second receiver, receiving a first signal; and

a second transmitter, as a response to the action of receiving a first signal, transmitting a first channel in a first time window, time-domain resources occupied by the first signal being used to determine the first time window;

herein, as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

The present application provides a third node for wireless communications, comprising:

a second processor, transmitting M2 reference signal(s), M2 being a positive integer;

herein, as a response to a first condition set being satisfied, a first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; as a response to the action of transmitting the first signal, a transmitter of the first signal monitors a first channel in a first time window; time-domain resources occupied by the first signal are used to determine the first time window; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset; any reference signal of the M2 reference signal(s) belongs to the first reference signal subset or the second reference signal subset.

In one embodiment, compared with the prior art, the present application is advantageous in the following aspects:

achieving a rapid cross-cell beam handover, which further enhances the performance of cell-boundary users.

obtaining improved performance thanks to cell handover, and avoiding the delay and potential service interruption that may follow.

preferring to choose a reference signal of a specific cell, thus avoiding the pingpong effect with the quality of service guaranteed.

In one embodiment, compared with the prior art, the present application is advantageous in the following aspects:

allowing the UE to attempt accessing to different cells simultaneously, thus achieving a rapid cross-cell beam switch and enhancing the performance of cell-boundary users.

respectively counting numbers of attempting times of accesses for different cells, thus ensuring the fairness in accessing to different cells.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first reference signal group, a second counter and a first signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission according to one embodiment of the present application.

FIG. 6 illustrates a flowchart of transmission according to one embodiment of the present application.

FIG. 7 illustrates a schematic diagram of a first reference signal group being used for a first-type received quality group according to one embodiment of the present application.

FIG. 8 illustrates a schematic diagram of maintaining a second counter according to a first-type received quality group according to one embodiment of the present application.

FIG. 9 illustrates a schematic diagram of maintaining a first counter according to one embodiment of the present application.

FIG. 10 illustrates a schematic diagram illustrating that there is a reference signal in a first reference signal subset being associated with a first cell, and there is a reference signal in a second reference signal subset being associated with a second cell according to one embodiment of the present application.

FIG. 11 illustrates a schematic diagram of a first signal and a first signaling according to one embodiment of the present application.

FIG. 12 illustrates a schematic diagram of a second signal and a second signaling according to one embodiment of the present application.

FIG. 13 illustrates a schematic diagram of a first power value according to one embodiment of the present application.

FIG. 14 illustrates a schematic diagram of M reference signals and M second-type received qualities according to one embodiment of the present application.

FIG. 15 illustrates a structure block diagram of a processing device in a first node according to one embodiment of the present application.

FIG. 16 illustrates a structure block diagram of a processing device in a second node according to one embodiment of the present application.

FIG. 17 illustrates a structure block diagram of a processing device in a third node according to one embodiment of the present application.

FIG. 18 illustrates a flowchart of a first reference signal group, a third counter, a first signal and a first channel according to one embodiment of the present application.

FIG. 19 illustrates a flowchart of transmission according to one embodiment of the present application.

FIG. 20 illustrates a schematic diagram of a first reference signal group being used to determine a first-type received quality group according to one embodiment of the present application.

FIG. 21 illustrates a schematic diagram of maintaining a third counter according to a first-type received quality group according to one embodiment of the present application.

FIG. 22 illustrates a schematic diagram of monitoring a first channel in a first time window according to one embodiment of the present application.

FIG. 23 illustrates a schematic diagram of maintaining a given counter according to one embodiment of the present application.

FIG. 24 illustrates a schematic diagram illustrating that there is a reference signal in a first reference signal subset being associated with a first cell, and there is a reference signal in a second reference signal subset being associated with a second cell according to one embodiment of the present application.

FIG. 25 illustrates a schematic diagram of a first power value according to one embodiment of the present application.

FIG. 26 illustrates a schematic diagram of relations among a first counter, a second counter, a fourth counter and a fifth counter according to one embodiment of the present application.

FIG. 27 illustrates a schematic diagram of M reference signals and M second-type received qualities according to one embodiment of the present application.

FIG. 28 illustrates a schematic diagram of a second signal and a second signaling according to one embodiment of the present application.

FIG. 29 illustrates a structure block diagram of a processing device in a first node according to one embodiment of the present application.

FIG. 30 illustrates a structure block diagram of a processing device used in a second node according to one embodiment of the present application.

FIG. 31 illustrates a schematic diagram of monitoring a first channel in a first time window according to one embodiment of the present application.

FIG. 32 illustrates a flowchart of transmission according to one embodiment of the present application.

FIG. 33 illustrates a structure block diagram of a processing device used in a third node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a first reference signal group, a second counter and a first signal according to one embodiment of the present application, as shown in FIG. 1. In 100 illustrated by FIG. 1, each box represents a step. Particularly, the sequential step arrangement in each box herein does not imply a chronological order of steps marked respectively by these boxes.

In Embodiment 1, the first node in the present application receives a first reference signal group in step 101 to determine a first-type received quality group, the first-type received quality group comprising at least one first-type received quality; maintains a second counter according to the first-type received quality group in step 102; and transmits a first signal in step 103. Herein, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

In one embodiment, when a value of the first counter is no greater than the first threshold, the first node selects the first reference signal from the first reference signal subset; when a value of the first counter is greater than the first threshold, the first node selects the first reference signal from the second reference signal subset.

In one embodiment, the reference signal comprises a reference signal resource.

In one embodiment, the reference signal comprises a reference signal port.

In one embodiment, the first reference signal group comprises a positive integer number of reference signal(s).

In one embodiment, the first reference signal group only comprises one reference signal.

In one embodiment, the first reference signal group comprises more than one reference signal.

In one embodiment, modulation symbols comprised in any reference signal in the first reference signal group are known to the first node.

In one embodiment, the first reference signal group comprises a Synchronisation Signal/physical broadcast channel Block (SSB).

In one embodiment, the first reference signal group comprises a Channel State Information-Reference Signal (CSI-RS).

In one embodiment, the first reference signal group comprises a Non-Zero-Power (NZP) CSI-RS.

In one embodiment, the first reference signal group comprises a Sounding Reference Signal (SRS).

In one embodiment, any reference signal in the first reference signal group includes a CSI-RS or an SSB.

In one embodiment, any reference signal in the first reference signal group includes a Non-Zero-Power (NZP) CSI-RS or SSB.

In one embodiment, a reference signal resource occupied by any reference signal in the first reference signal group comprises a CSI-RS resource or SSB resource.

In one embodiment, any reference signal in the first reference signal group is identified by an SSB index or a CSI-RS resource index.

In one embodiment, any reference signal in the first reference signal group is a periodic reference signal.

In one embodiment, any reference signal in the first reference signal group is a periodic reference signal or a semi-persistent reference signal.

In one embodiment, there is a reference signal in the first reference signal group being a semi-persistent reference signal or an aperiodic reference signal.

In one embodiment, all reference signals in the first reference signal group belong to a same Carrier.

In one embodiment, all reference signals in the first reference signal group belong to a same Bandwidth Part (BWP).

In one embodiment, all reference signals in the first reference signal group are associated with the first cell.

In one embodiment, all reference signals in the first reference signal group are associated with the second cell.

In one embodiment, all reference signals in the first reference signal group are associated with a same serving cell of the first node.

In one embodiment, the first reference signal subset only comprises one reference signal.

In one embodiment, the first reference signal subset comprises more than one reference signal.

In one embodiment, modulation symbols comprised in any reference signal in the first reference signal subset are known to the first node.

In one embodiment, the first reference signal subset comprises an SSB.

In one embodiment, the first reference signal subset comprises a CSI-RS.

In one embodiment, the first reference signal subset comprises a Non-Zero-Power (NZP) CSI-RS.

In one embodiment, the first reference signal subset comprises an SRS.

In one embodiment, any reference signal in the first reference signal subset includes a CSI-RS or an SSB.

In one embodiment, any reference signal in the first reference signal subset includes a Non-Zero-Power (NZP) CSI-RS or SSB.

In one embodiment, a reference signal resource occupied by any reference signal in the first reference signal subset comprises a CSI-RS resource or SSB resource.

In one embodiment, any reference signal in the first reference signal subset is identified by an SSB index or a CSI-RS resource index.

In one embodiment, any reference signal in the first reference signal subset is a periodic reference signal.

In one embodiment, any reference signal in the first reference signal subset is a periodic or semi-persistent reference signal.

In one embodiment, there is a reference signal in the first reference signal subset being a semi-persistent or aperiodic reference signal.

In one embodiment, the second reference signal subset only comprises one reference signal.

In one embodiment, the second reference signal subset comprises more than one reference signal.

In one embodiment, modulation symbols comprised in any reference signal in the second reference signal subset are known to the first node.

In one embodiment, the second reference signal subset comprises an SSB.

In one embodiment, the second reference signal subset comprises a CSI-RS.

In one embodiment, the second reference signal subset comprises a Non-Zero-Power (NZP) CSI-RS.

In one embodiment, the second reference signal subset comprises an SRS.

In one embodiment, any reference signal in the second reference signal subset includes a CSI-RS or an SSB.

In one embodiment, any reference signal in the second reference signal subset includes a Non-Zero-Power (NZP) CSI-RS or SSB.

In one embodiment, a reference signal resource occupied by any reference signal in the second reference signal subset comprises a CSI-RS resource or SSB resource.

In one embodiment, any reference signal in the second reference signal subset is identified by an SSB index or a CSI-RS resource index.

In one embodiment, any reference signal in the second reference signal subset is a periodic reference signal.

In one embodiment, any reference signal in the second reference signal subset is a periodic or semi-persistent reference signal.

In one embodiment, there is a reference signal in the second reference signal subset being a semi-persistent or aperiodic reference signal.

In one embodiment, any reference signal in the second reference signal subset is a periodic reference signal.

In one embodiment, any reference signal in the second reference signal subset is a periodic reference signal or semi-persistent reference signal.

In one embodiment, there is a reference signal in the second reference signal subset being a semi-persistent reference signal or an aperiodic reference signal.

In one embodiment, the second reference signal subset comprises the first reference signal subset.

In one embodiment, any reference signal in the first reference signal subset does not belong to the second reference signal subset.

In one embodiment, any reference signal in the second reference signal subset does not belong to the first reference signal subset.

In one embodiment, there is a reference signal in the first reference signal subset belonging to the second reference signal subset.

In one embodiment, there is a reference signal in the second reference signal subset belonging to the first reference signal subset.

In one embodiment, there is a reference signal in the first reference signal subset not belonging to the second reference signal subset.

In one embodiment, the first signal comprises a baseband signal.

In one embodiment, the first signal comprises a radio signal.

In one embodiment, the first signal comprises a radio frequency signal.

In one embodiment, the first signal comprises a first characteristic sequence.

In one embodiment, the first characteristic sequence comprises one or more of a pseudo-random sequence, a Zadoff-Chu sequence or a low-Peak-to-Average Power Ratio (low-PAPR) sequence.

In one embodiment, the first characteristic sequence comprises Cyclic Prefix (CP).

In one embodiment, the first signal comprises a Random Access (RA) Preamble.

In one embodiment, the first signal comprises a Random Access Channel (RACH) Preamble.

In one embodiment, the first signal comprises Uplink control information (UCI).

In one embodiment, the first signal comprises a Link Recovery Request (LRR).

In one embodiment, the first signal comprises a Medium Access Control layer Control Element (MAC CE).

In one embodiment, the first signal comprises a Beam Failure Recovery (BFR) MAC CE or a Truncated BFR MAC CE.

In one embodiment, a channel occupied by the first signal includes a Physical Random Access CHannel (PRACH).

In one embodiment, a channel occupied by the first signal includes a Physical Uplink SharedCHannel (PUSCH).

In one embodiment, a PRACH resource occupied by the first signal implicitly indicates a position of time-frequency resources of a PUSCH occupied by the first signal.

In one embodiment, a channel occupied by the first signal includes an UpLink-Shared CHannel (UL-SCH).

In one embodiment, a PRACH resource occupied by the first signal is used to determine the first reference signal.

In one embodiment, a PRACH resource occupied by the first signal is used to indicate the first reference signal.

In one embodiment, a PRACH resource occupied by the first signal indicates the first reference signal out of the M reference signals.

In one embodiment, a PRACH resource occupied by the first signal is one of M candidate PRACH resources; the M candidate PRACH resources respectively correspond to the M reference signals; the first reference signal is a reference signal corresponding to a PRACH resource occupied by the first signal among the M reference signals.

In one embodiment, the M candidate PRACH resources are configured by a higher layer parameter.

In one embodiment, a higher layer parameter configuring the M candidate PRACH resources comprises all or partial information in a candidateBeamRSList field of a BeamFailureRecoveryConfig Information Element (IE).

In one embodiment, relations of correspondence between the M candidate PRACH resources and the M reference signals are configured by a higher layer parameter.

In one embodiment, a higher layer parameter for configuring relations of correspondence between the M candidate PRACH resources and the M reference signals comprises all or partial information in a candidateBeamRSList field of a BeamFailureRecoveryConfig IE.

In one embodiment, the first signal comprises a first bit field, the first bit field comprising a positive integer number of bit(s); a value of the first bit field indicates the first reference signal.

In one embodiment, the first threshold is a positive integer.

In one embodiment, the first threshold is configurable.

In one embodiment, the first threshold is fixed.

In one embodiment, the first threshold is configured by a higher layer parameter.

In one embodiment, the first threshold is configured by a Radio Resource Control (RRC) parameter.

In one embodiment, the first threshold is configured by a physical layer signaling.

In one embodiment, when the first condition set is satisfied, the first signal is triggered.

In one embodiment, when the first condition set is unsatisfied, the first signal is not triggered.

In one embodiment, the first condition set only comprises the first condition.

In one embodiment, the first condition set comprises P conditions, P being a positive integer greater than 1, where the first condition is one of the P conditions.

In one embodiment, when and only when each condition in the first condition set is satisfied, the first condition set is satisfied.

In one embodiment, if there is one condition unsatisfied in the first condition set, the first condition set is not satisfied.

In one embodiment, when there is one condition unsatisfied in the first condition set, the first condition set is not satisfied.

In one embodiment, the first condition set only comprises the first condition; when the first condition is satisfied, the first condition set is satisfied.

In one embodiment, the first condition set comprises the P conditions; when and only when each of the P conditions is satisfied, the first condition set is satisfied.

In one embodiment, as a response to the first condition being satisfied, the first signal is triggered.

In one embodiment, when the first condition is satisfied, the first signal is triggered.

In one embodiment, when the first condition is unsatisfied, the first signal is not triggered.

In one embodiment, the second threshold is a positive integer.

In one embodiment, the second threshold is configurable.

In one embodiment, the second threshold is fixed.

In one embodiment, the second threshold is configured by a higher layer parameter.

In one embodiment, the second threshold is configured by an RRC parameter.

In one embodiment, the second threshold is configured by a physical layer signaling.

In one embodiment, the second threshold is configured by a higher layer parameter beamFailureInstanceMaxCount.

In one embodiment, the second threshold is equal to the value of a higher layer parameter beamFailureInstanceMaxCount.

In one embodiment, when the first condition is satisfied, a physical layer of the first node receives a first indication information block from a higher layer of the first node; herein, the first indication information block triggers transmission of the first signal.

In one embodiment, the first indication information block indicates the first reference signal.

### Embodiment 2

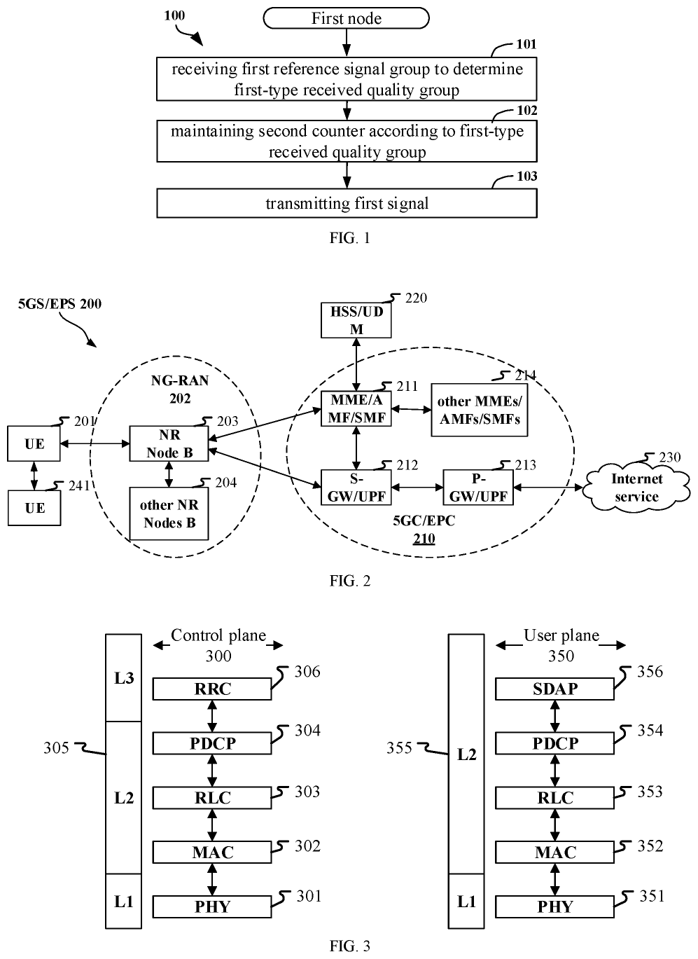

Embodiment 2 illustrates a schematic diagram of a network architecture according to one embodiment of the present application, as shown in FIG. 2.

FIG. 2 is a diagram illustrating a network architecture of Long-Term Evolution (LTE), Long-Term Evolution Advanced (LTE-A) and future 5G systems. The LTE, or LTE-A or future 5G network architecture 200 may be called an Evolved Packet System (EPS) 200. The 5G NR or LTE network 200 can be called a 5G System/Evolved Packet System (5GS/EPS) 200 or other appropriate terms. The 5GS/EPS 200 may comprise one or more UEs 201, a UE 241 in sidelink communication with the UE(s) 201, an NG-RAN 202, a 5G CoreNetwork/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises a New Radio (NR) node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning System (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the first node in the present application includes the UE 241.

In one embodiment, the second node in the present application includes the gNB203.

In one embodiment, the third node in the present application includes the gNB204.

In one embodiment, a radio link between the UE201 and the gNB203 is a cellular link.

In one embodiment, a transmitter for the first reference signal group in the present application includes the gNB203.

In one embodiment, a transmitter for the first reference signal group in the present application includes the gNB204.

In one embodiment, a receiver for the first reference signal group in the present application includes the UE201.

In one embodiment, a transmitter for the first signal in the present application includes the UE201.

In one embodiment, a receiver for the first signal in the present application includes the gNB203.

In one embodiment, a receiver for the first signal in the present application includes the gNB204.

In one embodiment, a transmitter for the first channel in the present application includes the gNB203.

In one embodiment, a receiver for the first channel in the present application includes the UE201.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first reference signal group is generated by the PHY 301, or the PHY 351.

In one embodiment, the first signal is generated by the PHY 301, or the PHY 351.

In one embodiment, the first signal is generated by the MAC sublayer 302, or the MAC sublayer 352.

In one embodiment, the first channel is generated by the PHY 301, or the PHY 351.

### Embodiment 4

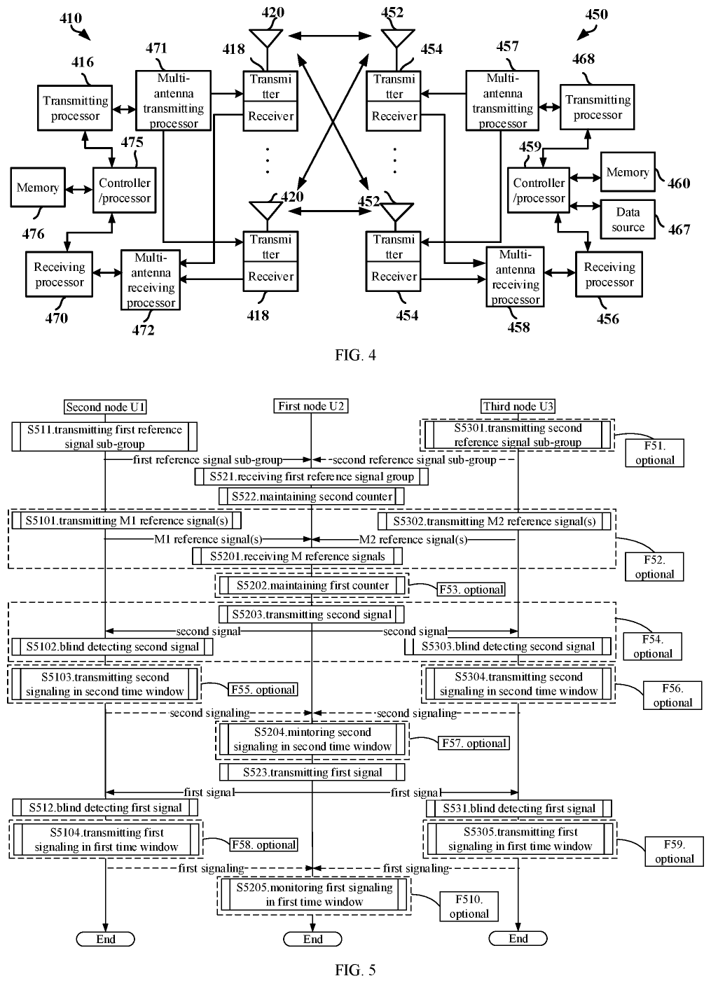

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any parallel stream targeting the second communication device 450. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives the first reference signal group to determine the first-type received quality group; maintains the second counter according to the first-type received quality group; and transmits the first signal. Herein, the first-type received quality group comprises at least one first-type received quality. the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; at least one reference signal in the second reference signal subset does not belong to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

In one embodiment, the second communication device 450 comprises a memory that stores a computer readable instruction program, the computer readable instruction program generates actions when executed by at least one processor, which include: receiving the first reference signal group to determine the first-type received quality group; maintaining the second counter according to the first-type received quality group; and transmitting the first signal. Herein, the first-type received quality group comprises at least one first-type received quality. the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; at least one reference signal in the second reference signal subset does not belong to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits the first reference signal sub-group; and blind detects the first signal. Herein, any reference signal in the first reference signal sub-group belonging to a first reference signal group, the first reference signal group being used to determine a first-type received quality group, the first-type received quality group comprising at least one first-type received quality; and the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; at least one reference signal in the second reference signal subset does not belong to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; the first-type received quality group is used to maintain the second counter.

In one embodiment, the first communication device 410 comprises a memory that stores a computer readable instruction program, the computer readable instruction program generates actions when executed by at least one processor, which include: transmitting the first reference signal sub-group; and blind detecting the first signal. Herein, any reference signal in the first reference signal sub-group belonging to a first reference signal group, the first reference signal group being used to determine a first-type received quality group, the first-type received quality group comprising at least one first-type received quality; and the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; at least one reference signal in the second reference signal subset does not belong to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; the first-type received quality group is used to maintain the second counter.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives the first reference signal group to determine a first-type received quality group; maintains the third counter according to the first-type received quality group; and transmits the first signal; as a response to the action of transmitting a first signal, monitors the first channel in the first time window. Herein, the first-type received quality group comprises at least one first-type received quality; time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the second communication device 450 comprises a memory that stores a computer readable instruction program, the computer readable instruction program generates actions when executed by at least one processor, which include: receiving the first reference signal group to determine a first-type received quality group; maintaining the third counter according to the first-type received quality group; and transmitting the first signal; as a response to the action of transmitting a first signal, monitoring the first channel in the first time window. Herein, the first-type received quality group comprises at least one first-type received quality; time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: receives the first signal; and as a response to the action of receiving a first signal, transmits the first channel in the first time window. Herein, time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the first communication device 410 comprises a memory that stores a computer readable instruction program, the computer readable instruction program generates actions when executed by at least one processor, which include: receiving the first signal; and as a response to the action of receiving a first signal, transmitting the first channel in the first time window. Herein, time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the first node in the present application comprises the second communication device 450.

In one embodiment, the second node in the present application comprises the first communication device 410.

In one embodiment, the third node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive the first reference signal group; at least one of the antenna 420, the transmitter 418, the transmitting processor 416, the multi-antenna transmitting processor 471, the controller/processor 475 or the memory 476 is used to transmit the first reference signal sub-group.

In one embodiment, at least one of the antenna 420, the transmitter 418, the transmitting processor 416, the multi-antenna transmitting processor 471, the controller/processor 475 or the memory 476 is used to transmit the second reference signal sub-group.

In one embodiment, at least one of the antenna 452, the receiver 454, the receiving processor 456, the multi-antenna receiving processor 458, the controller/processor 459, the memory 460 or the data source 467 is used to maintain the second counter according to the first-type received quality group.

In one embodiment, at least one of the antenna 420, the receiver 418, the receiving processor 470, the multi-antenna receiving processor 472, the controller/processor 475 or the memory 476 is used to blind detect the first signal; at least one of the antenna 452, the transmitter 454, the transmitting processor 468, the multi-antenna transmitting processor 457, the controller/processor 459, or the memory 460 is used to transmit the first signal.

In one embodiment, at least one of the antenna 452, the receiver 454, the receiving processor 456, the multi-antenna receiving processor 458, the controller/processor 459, the memory 460 or the data source 467 is used to monitor the first signaling in the first time window; at least one of the antenna 420, the transmitter 418, the transmitting processor 416, the multi-antenna transmitting processor 471, the controller/processor 475 or the memory 476 is used to transmit the first signaling in the first time window.

In one embodiment, at least one of the antenna 420, the receiver 418, the receiving processor 470, the multi-antenna receiving processor 472, the controller/processor 475 or the memory 476 is used to blind detect the second signal; at least one of the antenna 452, the transmitter 454, the transmitting processor 468, the multi-antenna transmitting processor 457, the controller/processor 459, or the memory 460 is used to transmit the second signal.

In one embodiment, at least one of the antenna 452, the receiver 454, the receiving processor 456, the multi-antenna receiving processor 458, the controller/processor 459, the memory 460 or the data source 467 is used to monitor the second signaling in the second time window; at least one of the antenna 420, the transmitter 418, the transmitting processor 416, the multi-antenna transmitting processor 471, the controller/processor 475 or the memory 476 is used to transmit the second signaling in the second time window.

In one embodiment, at least one of the antenna 452, the receiver 454, the receiving processor 456, the multi-antenna receiving processor 458, the controller/processor 459, the memory 460 or the data source 467 is used to maintain the first counter.

In one embodiment, at least one of the antenna 452, the receiver 454, the receiving processor 456, the multi-antenna receiving processor 458, the controller/processor 459, the memory 460 or the data source 467 is used to receive the M reference signals; at least one of the antenna 420, the transmitter 418, the transmitting processor 416, the multi-antenna transmitting processor 471, the controller/processor 475 or the memory 476 is used to transmit the M1 reference signal(s).

In one embodiment, at least one of the antenna 420, the transmitter 418, the transmitting processor 416, the multi-antenna transmitting processor 471, the controller/processor 475 or the memory 476 is used to transmit the M2 reference signal(s).

In one embodiment, at least one of the antenna 452, the receiver 454, the receiving processor 456, the multi-antenna receiving processor 458, the controller/processor 459, the memory 460 or the data source 467 is used to maintain the third counter according to the first-type received quality group.

In one embodiment, at least one of the antenna 420, the receiver 418, the receiving processor 470, the multi-antenna receiving processor 472, the controller/processor 475 or the memory 476 is used to receive the first signal; at least one of the antenna 452, the transmitter 454, the transmitting processor 468, the multi-antenna transmitting processor 457, the controller/processor 459, or the memory 460 is used to transmit the first signal.

In one embodiment, at least one of the antenna 452, the receiver 454, the receiving processor 456, the multi-antenna receiving processor 458, the controller/processor 459, the memory 460 or the data source 467 is used to monitor the first channel in the first time window; at least one of the antenna 420, the transmitter 418, the transmitting processor 416, the multi-antenna transmitting processor 471, the controller/processor 475 or the memory 476 is used to transmit the first channel in the first time window.

In one embodiment, at least one of the receiving processor 456, the multi-antenna receiving processor 458, the controller/processor 459, the memory 460 or the data source 467 is used to maintain the first counter.

In one embodiment, at least one of the receiving processor 456, the multi-antenna receiving processor 458, the controller/processor 459, the memory 460 or the data source 467 is used to maintain the second counter.

In one embodiment, at least one of the receiving processor 456, the multi-antenna receiving processor 458, the controller/processor 459, the memory 460 or the data source 467 is used to maintain the fourth counter.

In one embodiment, at least one of the receiving processor 456, the multi-antenna receiving processor 458, the controller/processor 459, the memory 460 or the data source 467 is used to maintain the fifth counter.

In one embodiment, at least one of the antenna 420, the receiver 418, the receiving processor 470, the multi-antenna receiving processor 472, the controller/processor 475 or the memory 476 is used to receive the second signal; at least one of the antenna 452, the transmitter 454, the transmitting processor 468, the multi-antenna transmitting processor 457, the controller/processor 459, or the memory 460 is used to transmit the second signal.

In one embodiment, at least one of the antenna 452, the receiver 454, the receiving processor 456, the multi-antenna receiving processor 458, the controller/processor 459, the memory 460 or the data source 467 is used to monitor the second channel in the second time window; at least one of the antenna 420, the transmitter 418, the transmitting processor 416, the multi-antenna transmitting processor 471, the controller/processor 475 or the memory 476 is used to transmit the second channel in the second time window.

### Embodiment 5

Embodiment 5 illustrates a flowchart of wireless transmission according to one embodiment of the present application, as shown in FIG. 5. In FIG. 5, a second node U1, a first node U2 and a third node U3 are communication nodes that mutually transmit through air interfaces. In FIG. 5, steps marked by boxes F51 to F510 are optional, respectively; the transmission marked by dotted lines is optional.

The second node U1 transmits a first reference signal sub-group in step S511; transmits M1 reference signal(s) in step S5101; and blind detects a second signal in step S5102; transmits a second signaling in a second time window in step S5103; and blind detects a first signal in step S512; and transmits a first signaling in a first time window in step S5104.

The first node U2 receives a first reference signal group in step S521; maintains a second counter in step S522; and receives M reference signals in step S5201; maintains a first counter in step S5202; and transmits a second signal in step S5203; monitors a second signaling in a second time window in step S5204; transmits a first signal in step S523; and monitors a first signaling in a first time window in step S5205.

The third node U3 transmits a second reference signal sub-group in step S5301; transmits M2 reference signal(s) in step S5302; and blind detects a second signal in step S5303; transmits a second signaling in a second time window in step S5304; and blind detects a first signal in step S531; and transmits a first signaling in a first time window in step S5305.

In Embodiment 5, any reference signal in the first reference signal sub-group belongs to the first reference signal group; the first reference signal group is used by the first node U2 to determine a first-type received quality group, the first-type received quality group comprising at least one first-type received quality; the first signal is used by the first node U2 for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

In one embodiment, the first node U2 is the first node in the present application.

In one embodiment, the second node U1 is the second node in the present application.

In one embodiment, the third node U3 is the third node in the present application.

In one embodiment, an air interface between the second node U1 and the first node U2 includes a radio interface between a base station and a UE.

In one embodiment, an air interface between the third node U3 and the first node U2 includes a radio interface between a base station and a UE.

In one embodiment, the second node U1 is a maintenance base station for a serving cell of the first node U2.

In one embodiment, the blind detection refers to blind decoding, that is, to receive a signal and perform decoding operation; if the decoding is determined as correct according to a Cyclic Redundancy Check (CRC) bit, it is determined that a given signal is detected; otherwise, it is determined that a given signal is not detected; the given signal is the first signal or the second signal.

In one embodiment, the blind detection refers to coherent detection, that is, to perform coherent reception and measure energy of a signal obtained by the coherent reception; if the energy of the signal obtained by the coherent reception is larger than a first given threshold, it is determined that a given signal is detected; otherwise, it is determined that a given signal is not detected; the given signal is the first signal or the second signal.

In one embodiment, the blind detection refers to energy detection, that is, to sense energies of radio signals and average to obtain a received energy; if the received energy is larger than a second given threshold, it is determined that a given signal is detected; otherwise, it is determined that a given signal is not detected; the given signal is the first signal or the second signal.

In one embodiment, the sentence of blind detecting a given signal comprises: determining according to CRC whether the given signal is to be transmitted; the given signal is the first signal or the second signal.

In one embodiment, the sentence of blind detecting a given signal comprises: being unsure of whether the given signal is to be transmitted before it is determined whether decoding is correct according to CRC; the given signal is the first signal or the second signal.

In one embodiment, the sentence of blind detecting a given signal comprises: determining according to coherent detection whether the given signal is to be transmitted; the given signal is the first signal or the second signal.

In one embodiment, the sentence of blind detecting a given signal comprises: being unsure of whether the given signal is to be transmitted before coherent detection; the given signal is the first signal or the second signal.

In one embodiment, the sentence of blind detecting a given signal comprises: determining according to energy detection whether the given signal is to be transmitted; the given signal is the first signal or the second signal.

In one embodiment, the sentence of blind detecting a given signal comprises: being unsure of whether the given signal is to be transmitted before energy detection; the given signal is the first signal or the second signal.

In one embodiment, the second node is not a maintenance base station for the second cell.

In one embodiment, the first signal is transmitted on a PRACH.

In one embodiment, the first signal is transmitted on a PUSCH.

In one embodiment, the first signal is comprised of two parts, and the two parts are respectively transmitted on a PRACH and a PUSCH.

In one embodiment, the first reference signal sub-group comprises a positive integer number of reference signal(s) in the first reference signal group.

In one embodiment, there is one reference signal in the first reference signal group that does not belong to the first reference signal sub-group.

In one embodiment, the first reference signal sub-group comprises only one reference signal in the first reference signal group.

In one embodiment, the first reference signal sub-group comprises multiple reference signals in the first reference signal group.

In one embodiment, the first reference signal sub-group is the first reference signal group.

In one embodiment, the first reference signal sub-group comprises all reference signals in the first reference signal group.

In one embodiment, the step marked by the box F51 in FIG. 5 exists, the second reference signal sub-group comprising a positive integer number of reference signal(s) in the first reference signal group.

In one embodiment, there is one reference signal in the first reference signal group that does not belong to the second reference signal sub-group.

In one embodiment, the second reference signal sub-group comprises only one reference signal in the first reference signal group.

In one embodiment, the second reference signal sub-group comprises multiple reference signals in the first reference signal group.

In one embodiment, the first reference signal group consists of the first reference signal sub-group and the second reference signal sub-group.

In one embodiment, any reference signal in the first reference signal sub-group does not belong to the second reference signal sub-group.

In one embodiment, any reference signal in the second reference signal sub-group does not belong to the first reference signal sub-group.

In one embodiment, there isn't any reference signal in the first reference signal group that belongs to both the first reference signal sub-group and the second reference signal sub-group.

In one embodiment, any reference signal in the first reference signal group belongs to the first reference signal sub-group or the second reference signal sub-group.

In one embodiment, there is a reference signal in the first reference signal group that belongs to neither the first reference signal sub-group nor the second reference signal sub-group.

In one embodiment, steps marked by the box F52 in FIG. 5 exist, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold; any reference signal of the M1 reference signal(s) is one of the M reference signals, while any reference signal of the M2 reference signal(s) is one of the M reference signals; M1 and M2 are respectively positive integers less than M.

In one embodiment, M1 is equal to 1.

In one embodiment, M1 is greater than 1.

In one embodiment, there is one reference signal among the M reference signals that does not belong to the M1 reference signal(s).

In one embodiment, any of the M1 reference signal(s) belongs to the first reference signal subset.

In one embodiment, any reference signal in the first reference signal subset belongs to the M1 reference signal(s).

In one embodiment, the first reference signal subset comprises the M1 reference signal(s).

In one embodiment, there is one reference signal in the first reference signal subset that does not belong to the M1 reference signal(s).

In one embodiment, any reference signal in the second reference signal subset does not belong to the M1 reference signal(s).

In one embodiment, there is one reference signal in the second reference signal subset that does not belong to the M1 reference signal(s).

In one embodiment, there is one reference signal in the second reference signal subset that belongs to the M1 reference signal(s).

In one embodiment, any of the M1 reference signal(s) does not belong to the second reference signal subset.

In one embodiment, any of the M1 reference signal(s) belongs to the second reference signal subset.

In one embodiment, there is one reference signal among the M1 reference signal(s) that belongs to the second reference signal subset.

In one embodiment, M2 is equal to 1.

In one embodiment, M2 is greater than 1.

In one embodiment, any of the M1 reference signal(s) does not belong to the M2 reference signal(s).

In one embodiment, any of the M2 reference signal(s) does not belong to the M1 reference signal(s).

In one embodiment, there isn't any reference signal among the M reference signals belonging to both the M1 reference signal(s) and the M2 reference signal(s).

In one embodiment, a sum of M1 and M2 is less than the M.

In one embodiment, a sum of M1 and M2 is equal to the M.

In one embodiment, there is a reference signal among the M reference signals belonging to neither the M1 reference signal(s) nor the M2 reference signal(s).

In one embodiment, any of the M reference signals belongs to the M1 reference signal(s) or the M2 reference signal(s).

In one embodiment, the M reference signals consist of the M1 reference signal(s) and the M2 reference signal(s).

In one embodiment, any of the M2 reference signal(s) belongs to the second reference signal subset.

In one embodiment, any reference signal in the second reference signal subset belongs to the M2 reference signal(s).

In one embodiment, the second reference signal subset comprises the M2 reference signal(s).

In one embodiment, there is one reference signal in the second reference signal subset that does not belong to the M2 reference signal(s).

In one embodiment, any of the M2 reference signal(s) does not belong to the first reference signal subset.

In one embodiment, there is a reference signal in the first reference signal group that is earlier than one of M reference signals in time domain.

In one embodiment, there is a reference signal in the first reference signal group that is later than one of M reference signals in time domain.

In one embodiment, a first PRACH resource subset consists of candidate PRACH resource(s) corresponding to the M1 reference signal(s) among the M candidate PRACH resources, and the second node blind detects the first signal in the first PRACH resource subset.

In one subembodiment, the second node blind detects the first signal in only the first PRACH resource subset in the M candidate PRACH resources.

In one embodiment, a second PRACH resource subset consists of candidate PRACH resource(s) corresponding to the M2 reference signal(s) among the M candidate PRACH resources; the third node blind detects the first signal in the second PRACH resource subset.

In one subembodiment, the third node blind detects the first signal in only the second PRACH resource subset in the M candidate PRACH resources.

In one embodiment, the second node blind detects the first signal respectively in the M candidate PRACH resources.

In one embodiment, the third node blind detects the first signal respectively in the M candidate PRACH resources.

In one embodiment, the steps marked by the box F53 in FIG. 5 exist; when the value of the first counter reaches a third threshold, the first node U2 indicates a random access problem to a higher layer, the third threshold being greater than the first threshold.

In one embodiment, the steps marked by the box F54 in FIG. 5 exist; as a response to the first condition being satisfied, the second signal is triggered.

In one embodiment, when the first condition is satisfied, a physical layer of the first node receives a first indication information block from a higher layer of the first node; herein, the first indication information block triggers transmission of the second signal.

In one embodiment, the first indication information block indicates the second reference signal.

In one embodiment, steps in the box F55 and the box F56 in FIG. 5 cannot co-exist.

In one embodiment, the steps marked by the box F54 and the F55 in FIG. 5 exist, while the step marked by the box F56 in FIG. 5 does not exist; the second node U1 detects the second signal; as a response to the action of detecting the second signal, the second node U1 transmits the second signaling in the second time window.

In one embodiment, the step marked by the box F55 in FIG. 5 does not exist, while the steps marked by the box F54 and the box F56 in FIG. 5 exist; the third node U3 detects the second signal; as a response to the action of detecting the second signal, the third node U3 transmits the second signaling in the second time window.

In one embodiment, steps marked by the box F54 and the box F57 in FIG. 5 exist; as a response to the action of transmitting a second signal, the first node U2 monitors the second signaling in the second time window.

In one embodiment, the second signal is transmitted on a PRACH.

In one embodiment, the second signal is transmitted on a PUSCH.

In one embodiment, the second signal is comprised of two parts, and the two parts are respectively transmitted on a PRACH and a PUSCH.

In one embodiment, the second signaling is transmitted on a Physical Downlink Control Channel (PDCCH).

In one embodiment, the second signaling is transmitted on a Physical Downlink Shared CHannel (PDSCH).

In one embodiment, steps in the box F58 and the box F59 in FIG. 5 cannot co-exist.

In one embodiment, the step marked by the box F58 in FIG. 5 exists, while the step marked by the box F59 in FIG. 5 does not exist; the second node U1 detects the first signal; as a response to the action of detecting the first signal, the second node U1 transmits the first signaling in the first time window.

In one embodiment, the step marked by the box F58 in FIG. 5 does not exist, while the step marked by the box F59 in FIG. 5 exists; the third node U3 detects the first signal; as a response to the action of detecting the first signal, the third node U3 transmits the first signaling in the first time window.

In one embodiment, the step marked by the box F510 in FIG. 5 exists; as a response to the action of transmitting a first signal, the first node U2 monitors the first signaling in the first time window.

In one embodiment, the first signaling is transmitted on a PDCCH.

In one embodiment, the first signaling is transmitted on a PDSCH.

### Embodiment 6

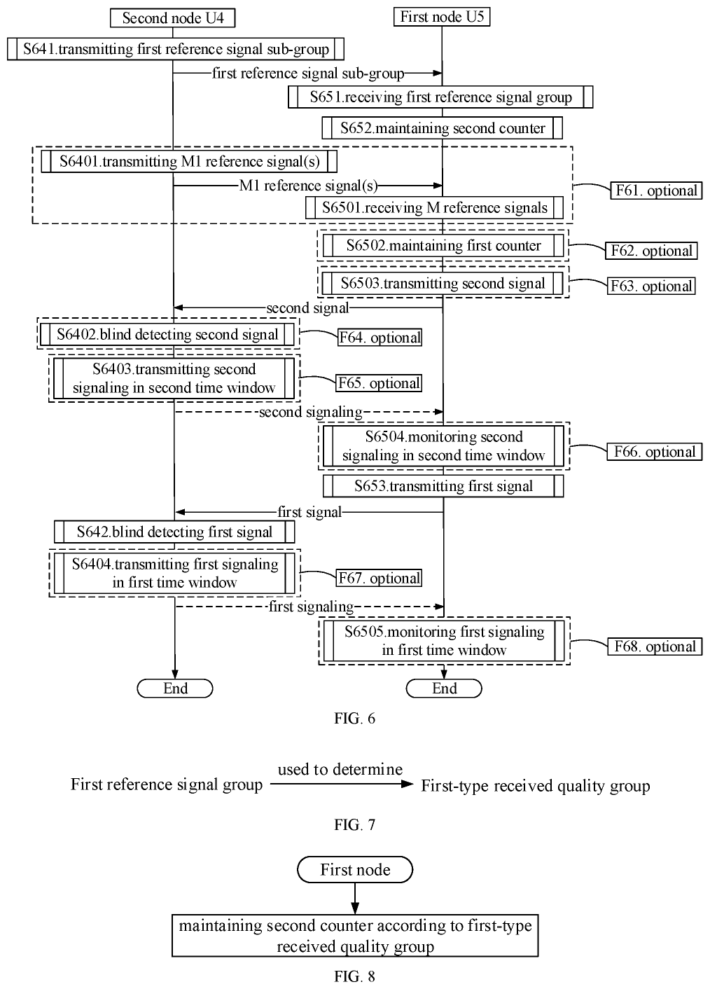

Embodiment 6 illustrates a flowchart of wireless transmission according to one embodiment of the present application, as shown in FIG. 6. In FIG. 6, a second node U4 and a first node U5 are communication nodes that transmit via an air interface. In FIG. 6, steps marked by the box F61 to the box F68 are optional, respectively.

The second node U4 transmits a first reference signal sub-group in step S641; transmits M1 reference signal(s) in step S6401; and blind detects a second signal in step S6402; transmits a second signaling in a second time window in step S6403; and blind detects a first signal in step S642; and transmits a first signaling in a first time window in step S6404.

The first node U5 receives a first reference signal group in step S651; maintains a second counter in step S652; receives M reference signals in step S6501; and maintains a first counter in step S6502; transmits a second signal in step S6503; and monitors a second signaling in a second time window in step S6504; transmits a first signal in step S653; and monitors a first signaling in a first time window in step S6505.

In one embodiment, the first node U5 is the first node in the present application.

In one embodiment, the second node U4 is the second node in the present application.

In one embodiment, M1 is equal to M.

In one embodiment, M1 is less than M.

In one embodiment, the M1 reference signals are the M reference signals.

In one embodiment, the second node is a maintenance base station for the second cell.

### Embodiment 7

Embodiment 7 illustrates a schematic diagram of a first reference signal group being used to determine a first-type received quality group according to one embodiment of the present application; as shown in FIG. 7.

In one embodiment, a measurement on the first reference signal group is used to determine the first-type received quality group.

In one embodiment, a number of reference signal(s) comprised in the first reference signal group is equal to a number of first-type received quality/qualities comprised in the first-type received quality group; the reference signal(s) comprised in the first reference signal group corresponds/correspond respectively to the first-type received quality (qualities) comprised in the first-type received quality group.

In one embodiment, the first reference signal group only comprises one reference signal, and the first-type received quality group only comprises one first-type received quality, measuring the reference signal being used to determine the first-type received quality.

In one embodiment, the first reference signal group comprises S reference signals, and the first-type received quality group comprises S first-type received qualities, S being a positive integer greater than 1; measurements on the S reference signals are respectively used to determine the S first-type received qualities.

In one embodiment, for any given reference signal in the first reference signal group, measuring the given reference signal within a first time interval is used to determine a first-type received quality corresponding to the given reference signal.

In one embodiment, for any given reference signal in the first reference signal group, the first node obtains a measurement used for computing a first-type received quality corresponding to the given reference signal only according to the given reference signal received within a first time interval.

In one embodiment, the measurement includes a channel measurement.

In one embodiment, the measurement includes an interference measurement.

In one embodiment, the first time interval is a consecutive duration.

In one embodiment, a length of the first time interval is equal to T_{Evaluate_BFD_SSB} ms or T_{Evaluate_BFD_CSI-RS} ms.

In one embodiment, the definitions of T_{Evaluate_BFD_SSB} and T_{Evaluate_BFD_CSI-RS} can be found in 3GPP TS38.133.

In one embodiment, any first-type received quality in the first-type received quality group comprises a Reference Signal Received Power (RSRP).

In one embodiment, any first-type received quality in the first-type received quality group comprises a L1-RSRP.

In one embodiment, any first-type received quality in the first-type received quality group is a L1-RSRP.

In one embodiment, any first-type received quality in the first-type received quality group comprises a Signal-to-noise and interference ratio (SINR).

In one embodiment, any first-type received quality in the first-type received quality group comprises a L1-SINR.

In one embodiment, any first-type received quality in the first-type received quality group is a L1-SINR.

In one embodiment, any first-type received quality in the first-type received quality group comprises a BLock Error Rate (BLER).

In one embodiment, any first-type received quality in the first-type received quality group is a BLER.

In one embodiment, a given reference signal is a reference signal in the first reference signal group.

In one subembodiment, an RSRP of the given reference signal is used to determine a first-type received quality in the first-type received quality group that corresponds to the given reference signal.

In one subembodiment, a first-type received quality in the first-type received quality group that corresponds to the given reference signal is equal to an RSRP of the given reference signal.

In one subembodiment, a L1-RSRP of the given reference signal is used to determine a first-type received quality in the first-type received quality group that corresponds to the given reference signal.

In one subembodiment, a first-type received quality in the first-type received quality group that corresponds to the given reference signal is equal to a L1-RSRP of the given reference signal.

In one subembodiment, a SINR of the given reference signal is used to determine a first-type received quality in the first-type received quality group that corresponds to the given reference signal.

In one subembodiment, a first-type received quality in the first-type received quality group that corresponds to the given reference signal is equal to a SINR of the given reference signal.

In one subembodiment, a L1-SINR of the given reference signal is used to determine a first-type received quality in the first-type received quality group that corresponds to the given reference signal.

In one subembodiment, a first-type received quality in the first-type received quality group that corresponds to the given reference signal is equal to a L1-SINR of the given reference signal.

In one subembodiment, the given reference signal is any reference signal in the first reference signal group.

In one embodiment, any first-type received quality in the first-type received quality group is obtained by looking up in tables of an RSRP, a L1-RSRP, a SINR or a L1-SINR of a corresponding reference signal.

In one embodiment, any first-type received quality in the first-type received quality group is obtained according to hypothetical PDCCH transmission parameters.

In one embodiment, the specific definition of the hypothetical PDCCH transmission parameters can be found in 3GPP TS38.133.

### Embodiment 8

Embodiment 8 illustrates a schematic diagram of maintaining a second counter according to a first-type received quality group according to one embodiment of the present application; as shown in FIG. 8.

In one embodiment, the second counter is a BFI COUNTER.

In one embodiment, an initial value of the second counter is 0.

In one embodiment, an initial value of the second counter is a positive integer.

In one embodiment, a value of the second counter is a non-negative integer.

In one embodiment, the action of maintaining a second counter according to the first-type received quality group comprises that: the first-type received quality group is used to determine whether a value of the second counter is to be incremented by 1.

In one embodiment, the action of maintaining a second counter according to the first-type received quality group comprises that: when each first-type received quality in the first-type received quality group is poorer than a first reference threshold, the value of the second counter is incremented by 1.

In one embodiment, the action of maintaining a second counter according to the first-type received quality group comprises that: when each first-type received quality in the first-type received quality group is poorer than or equal to a first reference threshold, the value of the second counter is incremented by 1.

In one embodiment, the action of maintaining a second counter according to the first-type received quality group comprises that: when at least one first-type received quality in the first-type received quality group is better than or equal to a first reference threshold, the value of the second counter is kept unchanged.

In one embodiment, the action of maintaining a second counter according to the first-type received quality group comprises that: when at least one first-type received quality in the first-type received quality group is better than a first reference threshold, the value of the second counter is kept unchanged.

In one embodiment, the action of maintaining a second counter according to the first-type received quality group comprises that: when an average value of the first-type received qualities in the first-type received quality group is poorer than a first reference threshold, the value of the second counter is incremented by 1.

In one embodiment, the sentence that a given received quality is poorer/better than the first reference threshold means that: the given received quality is one of an RSRP, a L1-RSRP, a SINR or a L1-SINR, the given received quality being smaller/larger than the first reference threshold; the given received quality is any first-type received quality in the first-type received quality group.

In one embodiment, the sentence that a given received quality is poorer/better than the first reference threshold means that: the given received quality is a BLER, the given received quality being larger/smaller than the first reference threshold; the given received quality is any first-type received quality in the first-type received quality group.

In one embodiment, the first reference threshold is a real number.

In one embodiment, the first reference threshold is a non-negative real number.

In one embodiment, the first reference threshold is a non-negative real number no greater than 1.

In one embodiment, the first reference threshold is equal to one of Q_{out_L}, Q_{out_LR_SSB} or Q_{out_LR_CSI-RS}.

In one embodiment, for definitions of the Q_{out_LR}, Q_{out_LR_SSB} and Q_{out_LR_CSI-RS}, refer to 3GPP TS38.133.

In one embodiment, the first reference threshold is determined by a higher layer parameter rlmInSyncOutOfSyncThreshold.

In one embodiment, when each first-type received quality in the first-type received quality group is poorer than the first reference threshold, a physical layer of the first node transmits an indication of a beam failure instance to a higher layer of the first node.

In one embodiment, when each first-type received quality in the first-type received quality group is poorer than or equal to the first reference threshold, a physical layer of the first node transmits a beam failure instance indication to a higher layer of the first node.

In one embodiment, when an average value of first-type received qualities in the first-type received quality group is poorer than the first reference threshold, a physical layer of the first node transmits a beam failure instance indication to a higher layer of the first node.

In one embodiment, a higher layer of the first node initializes the value of the second counter to 0.

In one embodiment, upon reception of a beam failure instance indication from a physical layer of the first node, a higher layer of the first node starts or restarts a first timer, and increments the value of the second counter by 1.

In one embodiment, as a response to receiving a beam failure instance indication from a physical layer of the first node, a higher layer of the first node starts or restarts a first timer, and increments the value of the second counter by 1.

In one embodiment, when the first counter expires, the value of the second counter is cleared to 0.

In one embodiment, what serves as the first timer is a beamFailureDetectionTimer.

In one embodiment, an initial value of the first timer is a positive integer.

In one embodiment, an initial value of the first timer is a positive real number.

In one embodiment, a unit of measuring an initial value of the first timer is a Q_{out,LR} reporting periodicity of a beam failure detection RS.

In one embodiment, an initial value of the first timer is configured by a higher-layer parameter beamFailureDetectionTimer.

In one embodiment, an initial value of the first timer is configured by an IE.

In one embodiment, names of an IE for configuring an initial value of the first timer include RadioLinkMonitoring.

In one embodiment, when a random access procedure corresponding to the first signal is successfully finished, the value of the second counter is cleared to zero.

In one embodiment, when the first node receives a first PDCCH, the value of the second counter is cleared to zero; where the first signal comprises a BFR MAC CE or a Truncated BFR MAC CE, and a Hybrid Automatic Repeat reQuest (HARQ) process number corresponding to the first signal is a first HARQ process number; the first PDCCH indicates a new UL grant transmission corresponding to the first HARQ process number, with CRC of the first PDCCH being scrambled by a Cell-Radio Network Temporary Identifier (C-RNTI).

### Embodiment 9

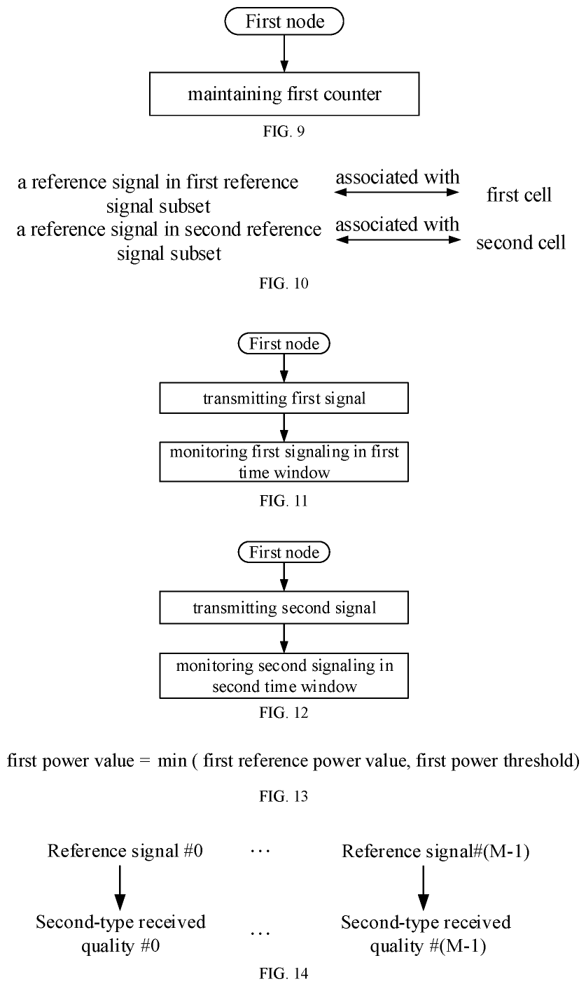

Embodiment 9 illustrates a schematic diagram of maintaining a first counter according to one embodiment of the present application; as shown in FIG. 9.

In one embodiment, the first counter is a PREAMBLE_TRANSMISSION_COUNTER.

In one embodiment, an initial value of the first counter is 0.

In one embodiment, an initial value of the first counter is 1.

In one embodiment, an initial value of the first counter is a positive integer.

In one embodiment, a value of the first counter is a non-negative integer.

In one embodiment, a value of the first counter is a positive integer.

In one embodiment, when a value of the first counter is equal to the third threshold, the random access problem indication is transmitted to a higher layer.

In one embodiment, the third threshold is a positive integer.

In one embodiment, the third threshold is configurable.

In one embodiment, the third threshold is fixed.

In one embodiment, the third threshold is configured by a higher layer parameter.

In one embodiment, names of a higher layer parameter for configuring the third threshold include preambleTransMax.

In one embodiment, the third threshold is configured by an RRC parameter.

In one embodiment, the third threshold is configured by a physical layer signaling.

In one embodiment, the third threshold is equal to preambleTransMax+1.

In one embodiment, the third threshold is equal to preambleTransMax.

In one embodiment, the action of maintaining the first counter comprises: setting the value of the first counter to 1 when a random access procedure is started.

In one embodiment, the action of maintaining the first counter comprises: setting the value of the first counter to an initial value when a random access procedure is started.

In one embodiment, the action of maintaining the first counter comprises: setting the value of the first counter to 1 as a response to a random access procedure being started.

In one embodiment, when the random access procedure is started, the first signal is triggered.

In one embodiment, as a response to the random access procedure being started, the first signal is triggered.

In one embodiment, as a response to the random access procedure being started, a random access preamble is triggered.

In one embodiment, when a random access preamble is triggered, the random access procedure is started.

In one embodiment, as a response to a random access preamble being triggered, the random access procedure is started.

In one embodiment, when the first signal is triggered, the random access procedure is started.

In one embodiment, the first signal comprises a random access preamble that belongs to the random access procedure.

In one embodiment, the action of maintaining the first counter comprises: incrementing the value of the first counter by 1, provided that a random access preamble is transmitted and a random access procedure to which the random access preamble belongs is not determined to be successful.

In one embodiment, the action of maintaining the first counter comprises: incrementing the value of the first counter by 1, provided that a random access preamble is transmitted and a random access response corresponding to the random access preamble is determined to be unsuccessful.

In one embodiment, the first signaling comprises a random access response (RAR) corresponding to the first signal.

In one embodiment, the action of maintaining the first counter comprises: keeping the value of the first counter unchanged, provided that a random access preamble is transmitted and a random access procedure to which the random access preamble belongs is determined to be successful.

In one embodiment, the action of maintaining the first counter comprises: keeping the value of the first counter unchanged, provided that a random access preamble is transmitted and a random access response corresponding to the random access preamble is determined to be successful.

In one embodiment, the action of maintaining the first counter comprises: incrementing the value of the first counter by 1, provided that a random access preamble is transmitted and contention resolution corresponding to the random access preamble is not determined to be successful.

In one embodiment, the action of maintaining the first counter comprises: keeping the value of the first counter unchanged, provided that a random access preamble is transmitted and contention resolution corresponding to the random access preamble is determined to be successful.

In one embodiment, whether the first signaling is received in the first time window is used to maintain the first counter.

In one embodiment, whether the first signaling is received in the first time window is used to determine whether the value of the first counter is incremented by 1.

In one embodiment, the action of maintaining the first counter comprises: if the first node receives the first signaling in the first time window, a value of the first counter keeps unchanged.

In one embodiment, the action of maintaining the first counter comprises: if the first node does not receive the first signaling in the first time window, a value of the first counter is incremented by 1.

In one embodiment, the action of maintaining the first counter comprises: if a random access response corresponding to a random access preamble comprised in the first signal is not received in the first time window, incrementing the value of the first counter by 1.

In one embodiment, the action of maintaining the first counter comprises: if a random access response corresponding to a random access preamble comprised in the first signal is not received before the first time window expires, incrementing the value of the first counter by 1.

In one embodiment, when the first condition is satisfied, a value of the first counter is set to an initial value.

In one embodiment, as a response to the first condition being satisfied, a value of the first counter is set to an initial value.

In one embodiment, whether the first condition is satisfied is used to determine whether the random access procedure is started.

In one embodiment, when the first condition is satisfied, the random access procedure is started.

In one embodiment, as a response to the first condition being satisfied, the random access procedure is started.

In one embodiment, if the first condition is not satisfied, the random access procedure is not started.

In one embodiment, when the first condition is satisfied, a random access preamble is triggered.

In one embodiment, as a response to the first condition being satisfied, a random access preamble is triggered.

In one embodiment, if an Msg2 triggered by the random access preamble is correctly received, a random access procedure to which the random access preamble belongs is determined to be successful.

In one embodiment, if a PDCCH transmission identified by a C-RNTI indicated by an MsgA associated with the random access preamble is correctly received, a random access procedure to which the random access preamble belongs is determined to be successful.

In one embodiment, if a PDCCH transmission identified by a C-RNTI indicated by an Msg3 associated with the random access preamble is correctly received, a random access procedure to which the random access preamble belongs is determined to be successful.

In one embodiment, if an Msg4 associated with the random access preamble is correctly received, a random access procedure to which the random access preamble belongs is determined to be successful.

In one embodiment, if a PDCCH transmission identified by a temporary-C-RNTI triggered by an Msg3 associated with the random access preamble is correctly received and a MAC Protocol Data Unit (PDU) scheduled by the PDCCH transmission comprises a UE contention resolution identifier matching with a Common Control Channel (CCCH) Service Data Unit (SDU) indicated by the Msg3 associated with the random access preamble, a random access procedure to which the random access preamble belongs is determined to be successful.

In one embodiment, if a PDCCH transmission identified by a C-RNTI triggered by the random access preamble is correctly received, a random access procedure to which the random access preamble belongs is determined to be successful.

In one embodiment, if a PDCCH transmission identified by a C-RNTI indicated by an MsgA or Msg3 associated with the random access preamble that is triggered by the random access preamble is correctly received, a random access procedure to which the random access preamble belongs is determined to be successful.

In one embodiment, if a random access response (RAR) triggered by the random access preamble is correctly received, a random access procedure to which the random access preamble belongs is determined to be successful.

In one embodiment, if a random access response (RAR) triggered by the random access preamble is correctly received and the RAR comprises a random access preamble identifier for the random access preamble, a random access procedure to which the random access preamble belongs is determined to be successful.

In one embodiment, if a random access response (RAR) triggered by the random access preamble is correctly received and the RAR comprises a MAC subPDU with only a RAPID, a random access procedure to which the random access preamble belongs is determined to be successful.

In one embodiment, if the first node receives the first signaling in the first time window, a random access procedure to which a random access preamble comprised in the first signal belongs is determined to be successful.

In one embodiment, when the random access procedure is determined to be successful, a value of the second counter is cleared to zero.

In one embodiment, as a response to the random access procedure being determined to be successful, a value of the second counter is cleared to zero.

In one embodiment, as a response to a random access procedure to which the random access preamble belongs being determined to be successful, a value of the second counter is cleared to zero.

In one embodiment, if a random access procedure to which a random access preamble comprised in the first signal belongs is determined to be successful, a value of the second counter is cleared to zero.

In one embodiment, whether the first signaling is received in the first time window is used to determine whether the value of the second counter is cleared to zero.

In one embodiment, if the first node receives the first signaling in the first time window, a value of the second counter is cleared to zero.

In one embodiment, as a response to receiving the first signaling in the first time window, a value of the second counter is cleared to zero.

In one embodiment, when the random access procedure is initiated, a second timer is started; when the second timer is expired, the random access problem indication is transmitted to a higher layer.

In one embodiment, the second timer is a beamFailureRecoveryTimer.

In one embodiment, an initial value of the second timer is configured by a higher layer parameter.

In one embodiment, names of a higher layer parameter for configuring an initial value of the second timer include beamFailureRecoveryTimer.

In one embodiment, when the random access procedure is determined to be successful, the second timer is stopped.

### Embodiment 10

Embodiment 10 illustrates a schematic diagram illustrating that there is a reference signal in a first reference signal subset being associated with a first cell, and there is a reference signal in a second reference signal subset being associated with a second cell according to one embodiment of the present application; as shown in FIG. 10.

In one embodiment, the sentence that a reference signal is associated with a given cell means that: a Physical Cell Identity (PCI) of the given cell is used for generating the reference signal; the given cell is the first cell or the second cell.

In one embodiment, the sentence that a reference signal is associated with a given cell means that: the reference signal is Quasi-Co-Located (QCL) with an SSB of the given cell; the given cell is the first cell or the second cell.

In one embodiment, the sentence that a reference signal is associated with a given cell means that: the reference signal is transmitted by the given cell; the given cell is the first cell or the second cell.

In one embodiment, the sentence that a reference signal is associated with a given cell means that: a radio resource occupied by the reference signal is indicated by a configuration signaling, and a Radio Link Control (RLC) Bearer through which the configuration signaling is conveyed is configured via a CellGroupConfig IE, where a Special cell (Spcell) configured by the CellGroupConfig IE includes the given cell; the given cell is the first cell or the second cell.

In one embodiment, the configuration signaling comprises an RRC signaling.

In one embodiment, the radio resource comprises a time-frequency resource.

In one embodiment, the radio resource comprises an RS sequence.

In one embodiment, the radio resource comprises a code-domain resource.

In one embodiment, the code-domain resource comprises one or more of a pseudo-random sequence, a low-PAPR sequence, a cyclic shift, an Orthogonal Cover Code (OCC), an orthogonal sequence, a frequency-domain orthogonal sequence or a time-domain orthogonal sequence.

In one embodiment, any reference signal in the first reference signal subset is associated with the first cell.

In one embodiment, there is a reference signal in the first reference signal subset being associated with the second cell.

In one embodiment, there is a reference signal in the first reference signal subset being associated with a cell different from the first cell.

In one embodiment, any reference signal in the first reference signal subset is associated with a serving cell of the first node.

In one embodiment, any reference signal in the second reference signal subset is associated with the second cell.

In one embodiment, there is a reference signal in the second reference signal subset being associated with the first cell.

In one embodiment, any reference signal in the second reference signal subset is associated with the first cell or the second cell.

In one embodiment, there is a reference signal in the second reference signal subset being associated with a cell different from the first cell and the second cell.

In one embodiment, there is a reference signal in the second reference signal subset being associated with a non-serving cell of the first node.

In one embodiment, any reference signal in the second reference signal subset is associated with a non-serving cell of the first node.

In one embodiment, the non-serving cell in the present application can be used for transmitting data.

In one embodiment, the non-serving cell in the present application refers to a cell available as a candidate for receiving and transmitting data.

In one embodiment, there is a reference signal in the second reference signal subset being associated with a serving cell of the first node.

In one embodiment, the first cell is different from the second cell.

In one embodiment, the first cell corresponds to a different PCI from the second cell.

In one embodiment, the first cell corresponds to a different CellIdentity from the second cell.

In one embodiment, the first cell corresponds to a different SCellIndex from the second cell.

In one embodiment, the first cell corresponds to a different ServCellIndex from the second cell.

In one embodiment, a maintenance base station for the first cell is different from a maintenance base station for the second cell.

In one embodiment, a maintenance base station for the first cell is the same as a maintenance base station for the second cell.

In one embodiment, the first cell and the second cell are respectively a Primary Cell (Pcell) and a Primary Secondary Cell (PScell) Group Cell of the first node.

In one embodiment, the first cell and the second cell respectively belong to a Master Cell Group (MCG) and a Secondary Cell Group (SCG) of the first node.

In one embodiment, the first cell and the second cell respectively belong to two different Cell Groups (CGs) of the first node.

In one embodiment, the first cell and the second cell belong to a same CG of the first node.

In one embodiment, a frequency-domain resource occupied by the first cell and a frequency-domain resource occupied by the second cell are overlapping.

In one embodiment, the first cell is a serving cell of the first node.

In one embodiment, the second cell is a non-serving cell of the first node.

In one embodiment, the second cell is a serving cell of the first node.

In one embodiment, the sentence that a given cell is a non-serving cell of the first node means that: the first node does not perform SCell addition for the given cell; the given cell is the first cell or the second cell.

In one embodiment, the sentence that a given cell is a non-serving cell of the first node means that: a latest sCellToAddModList received by the first node does not comprise the given cell; the given cell is the first cell or the second cell.

In one embodiment, the sentence that a given cell is a non-serving cell of the first node means that: neither of a latest sCellToAddModList and a latest sCellToAddModListSCG received by the first node comprises the given cell; the given cell is the first cell or the second cell.

In one embodiment, the sentence that a given cell is a non-serving cell of the first node means that: the first node is not assigned with an SCellIndex for the given cell; the given cell is the first cell or the second cell.

In one embodiment, the SCellIndex is a positive integer no greater than 31.

In one embodiment, the sentence that a given cell is a non-serving cell of the first node means that: the first node is not assigned with a ServCellIndex for the given cell; the given cell is the first cell or the second cell.

In one embodiment, the ServCellIndex is a positive integer no greater than 31.

In one embodiment, the sentence that a given cell is a non-serving cell of the first node means that: the given cell is not a PCell of the first node; the given cell is the first cell or the second cell.

In one embodiment, the sentence that a given cell is a non-serving cell of the first node means that: no RRC connection is established between the first node and the given cell; the given cell is the first cell or the second cell.

In one embodiment, the sentence that a given cell is a non-serving cell of the first node means that: the C-RNTI of the first node is not assigned by the given cell; the given cell is the first cell or the second cell.

In one embodiment, the sentence that a given cell is a serving cell of the first node means that: the first node performs SCell addition for the given cell; the given cell is the first cell or the second cell.

In one embodiment, the sentence that a given cell is a serving cell of the first node means that: a latest sCellToAddModList received by the first node comprises the given cell; the given cell is the first cell or the second cell.

In one embodiment, the sentence that a given cell is a serving cell of the first node means that: a latest sCellToAddModList or a latest sCellToAddModListSCG received by the first node comprises the given cell; the given cell is the first cell or the second cell.

In one embodiment, the sentence that a given cell is a serving cell of the first node means that: the first node is assigned with an SCellIndex for the given cell; the given cell is the first cell or the second cell.

In one embodiment, the sentence that a given cell is a serving cell of the first node means that: the first node is assigned with a ServCellIndex for the given cell; the given cell is the first cell or the second cell.

In one embodiment, the sentence that a given cell is a serving cell of the first node means that: an RRC connection has been established between the first node and the given cell; the given cell is the first cell or the second cell.

In one embodiment, the sentence that a given cell is a serving cell of the first node means that: the C-RNTI of the first node is assigned by the given cell; the given cell is the first cell or the second cell.

In one embodiment, both the first cell and the second cell keep RRC connection with the first node.

In one embodiment, of the first cell and the second cell only the first cell keeps RRC connection with the first node.

### Embodiment 11

Embodiment 11 illustrates a schematic diagram of a first signal and a first signaling according to one embodiment of the present application; as shown in FIG. 11. In Embodiment 11, as a response to the action of transmitting a first signal, the first node monitors the first signaling in the first time window; time-domain resources of the first signal are used by the first node to determine the first time window.

In one embodiment, time-domain resources occupied by the first signal are used by the second node or the third node to determine the first time window.

In one embodiment, the first signaling comprises a physical-layer signaling.

In one embodiment, the first signaling comprises a layer 1 (L1) signaling.

In one embodiment, the first signaling comprises Downlink Control Information (DCI).

In one embodiment, an RNTI used for scrambling CRC of the first signaling includes a C-RNTI.

In one embodiment, CRC of the first signaling is scrambled by a C-RNTI.

In one embodiment, an RNTI used for scrambling CRC of the first signaling includes a Modulation and Coding Scheme (MCS)-C-RNTI.

In one embodiment, an RNTI used for scrambling CRC of the first signaling includes a Random Access (RA)-RNTI.

In one embodiment, the first signaling comprises a random access response (RAR).

In one embodiment, the first signaling comprises a random access response (RAR) corresponding to a random access preamble comprised in the first signal.

In one embodiment, the first signaling comprises a first random access preamble identifier, the first random access preamble identifier matching with a random access preamble comprised in the first signal.

In one embodiment, the monitoring refers to blind decoding, that is, to receive a signal and perform decoding operation; if the decoding is determined to be correct according to a CRC bit, it is then determined that the first signaling is received; otherwise, it is determined that the first signaling is not received.

In one embodiment, the monitoring refers to coherent detection, that is, to perform coherent reception and measure energy of a signal obtained by the coherent reception; if the energy of the signal obtained by the coherent reception is larger than a first given threshold, it is determined that the first signaling is received; otherwise, it is determined that the first signaling is not received.

In one embodiment, the monitoring refers to energy detection, that is, to sense energies of radio signals and average to obtain a received energy; if the received energy is larger than a second given threshold, it is determined that the first signaling is received; otherwise, it is determined that the first signaling is not received.

In one embodiment, the phrase of monitoring a first signaling means: determining according to CRC whether the first signaling is to be transmitted.

In one embodiment, the phrase of monitoring a first signaling means: being unsure of whether the first signaling is to be transmitted before it is determined whether decoding is correct according to CRC.

In one embodiment, the phrase of monitoring a first signaling means: determining according to coherent detection whether the first signaling is to be transmitted.

In one embodiment, the phrase of monitoring a first signaling means: being unsure of whether the first signaling is to be transmitted before coherent detection.

In one embodiment, the phrase of monitoring a first signaling means: determining according to energy detection whether the first signaling is to be transmitted.

In one embodiment, the phrase of monitoring a first signaling means: being unsure of whether the first signaling is to be transmitted before energy detection.

In one embodiment, for the monitoring on the first signaling in the first time window, the first node assumes a QCL parameter the same as the first reference signal.

In one embodiment, the QCL parameter comprises a Transmission Configuration Indicator (TCI) state.

In one embodiment, the QCL parameter comprises a QCL assumption.

In one embodiment, the QCL parameter comprises a QCL relation.

In one embodiment, the QCL parameter comprises a spatial setting.

In one embodiment, the QCL parameter comprises a Spatial Relation.

In one embodiment, the QCL parameter comprises a spatial domain filter.

In one embodiment, the QCL parameter comprises a spatial domain transmission filter.

In one embodiment, the QCL parameter comprises a spatial domain receive filter.

In one embodiment, the QCL parameter comprises a Spatial Tx parameter.

In one embodiment, the QCL parameter comprises a Spatial Rx parameter.

In one embodiment, the QCL parameter comprises large-scale properties.

In one embodiment, the large-scale properties include one or more of a delay spread, a Doppler spread, a Doppler shift, an average delay or a Spatial Rx parameter.

In one embodiment, the first node assumes that an antenna port of the first signaling and the first reference signal are QCL.

In one embodiment, the first node assumes that an antenna port of the first signaling and the first reference signal are QCL with QCL-TypeD.

In one embodiment, the first node assumes that an antenna port of the first signaling and the first reference signal are QCL with QCL-TypeA.

In one embodiment, the first node assumes that DeModulation Reference Signals (DMRS) of a PDCCH occupied by the first signaling and the first reference signal are QCL.

In one embodiment, the first node assumes that DMRS of a PDCCH occupied by the first signaling and the first reference signal are QCL with QCL-TypeD.

In one embodiment, the first node assumes that DMRS of a PDCCH occupied by the first signaling and the first reference signal are QCL with QCL-TypeA.

In one embodiment, the first node receives the first reference signal and monitors the first signaling in the first time window using a same spatial domain filter.

In one embodiment, the first node transmits the first reference signal and monitors the first signaling in the first time window using a same spatial domain filter.

In one embodiment, large-scale properties of a channel over which the first reference signal is conveyed can be used to infer large-scale properties of a channel over which the first signaling is conveyed.

In one embodiment, large-scale properties of a channel over which the first reference signal is conveyed can be used to infer large-scale properties of a channel over which DMRS of a PDCCH occupied by the first signaling is conveyed.

In one embodiment, for the monitoring on the first signaling in the first time window, the first node assumes a QCL parameter the same as the third reference signal.

In one embodiment, the third reference signal comprises a CSI-RS or an SSB.

In one embodiment, the third reference signal and the first reference signal cannot be assumed to be QCL.

In one embodiment, the third reference signal is unrelated to the first reference signal.

In one embodiment, a PRACH resource occupied by the first signal is used to determine the third reference signal.

In one embodiment, a PRACH resource occupied by the first signal is used to indicate the third reference signal.

In one embodiment, the third reference signal is configured by a higher layer parameter.

In one embodiment, the action of monitoring a first signaling in a first time window is performed in a target resource set.

In one embodiment, the target resource set comprises a search space set.

In one embodiment, the target resource set is a search space set

In one embodiment, the target resource set comprises one or more PDCCH candidates.

In one embodiment, the target resource set comprises all or partial PDCCH candidates in a search space set.

In one embodiment, the target resource set comprises a COntrol REsource SET (CORESET).

In one embodiment, the target resource set is a CORESET.

In one embodiment, a search space set to which the target resource set belongs is identified by a recoverySearchSpaceId.

In one embodiment, a search space set to which the target resource set belongs is configured by a higher layer parameter ra-SearchSpace.

In one embodiment, a search space set to which the target resource set belongs is identified by a SearchSpaceId different from a recoverySearchSpaceId.

In one embodiment, the target resource set comprises a positive integer number of Resource Element(s) (RE(s)) in time-frequency domain.

In one embodiment, an RE occupies a multicarrier symbol in time domain, and a subcarrier in frequency domain.

In one embodiment, the multicarrier symbol is an Orthogonal Frequency Division Multiplexing (OFDM) Symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the target resource set comprises more than one Physical Resource block (PRB) in frequency domain.

In one embodiment, the target resource set comprises a positive integer number of multicarrier symbol(s) in time domain.

In one embodiment, when a value of the first counter is no greater than the first threshold, the target resource set is a first resource set; when a value of the first counter is greater than the first threshold, the target resource set is a second resource set.

In one embodiment, if a value of the first counter is no greater than the first threshold, the target resource set is a first resource set; if a value of the first counter is greater than the first threshold, the target resource set is a second resource set.

In one embodiment, the target resource set is unrelated to whether the value of the first counter is greater than the first threshold.

In one embodiment, the first resource set comprises a search space set.

In one embodiment, the first resource set is a search space set.

In one embodiment, the first resource set comprises one or more PDCCH candidates.

In one embodiment, the first resource set comprises all or partial PDCCH candidates in a search space set.

In one embodiment, the first resource set comprises a CORESET.

In one embodiment, the first resource set is a CORESET.

In one embodiment, a search space set to which the first resource set belongs is identified by a recoverySearchSpaceId.

In one embodiment, a search space set to which the first resource set belongs is identified by a SearchSpaceId different from a recoverySearchSpaceId.

In one embodiment, a search space set to which the first resource set belongs is configured by a higher layer parameter ra-SearchSpace.

In one embodiment, the second resource set comprises a search space set.

In one embodiment, the second resource set is a search space set.

In one embodiment, the second resource set comprises one or more PDCCH candidates.

In one embodiment, the second resource set comprises all or partial PDCCH candidates in a search space set.

In one embodiment, the second resource set comprises a CORESET.

In one embodiment, the second resource set is a CORESET.

In one embodiment, a search space set to which the second resource set belongs is identified by a recoverySearchSpaceId.

In one embodiment, a search space set to which the second resource set belongs is identified by a SearchSpaceId different from a recoverySearchSpaceId.

In one embodiment, a search space set to which the second resource set belongs is configured by a higher layer parameter ra-SearchSpace.

In one embodiment, the first resource set and the second resource set respectively belong to different search space sets.

In one embodiment, the first resource set and the second resource set respectively belong to different CORESETs.

In one embodiment, a search space set to which the first resource set belongs and a search space set to which the second resource set belongs are respectively identified by different SearchSpaceIds.

In one embodiment, a search space set to which the first resource set belongs and a CORESET to which the second resource set belongs are respectively identified by different ControlResourceSetIds.

In one embodiment, the first time window is a consecutive duration.

In one embodiment, the first time window includes a ra-ResponseWindow.

In one embodiment, the first time window is a ra-ResponseWindow.

In one embodiment, the first time window comprises a time unit in which a ra-Response Window is running.

In one embodiment, the first time window comprises a time unit in which a ra-ContentionResolutionTimer is running.

In one embodiment, the first time window includes a msgB-ResponseWindow.

In one embodiment, the first time window is a msgB-ResponseWindow.

In one embodiment, the first time window comprises a time unit in which a msgB-ResponseWindow is running.

In one embodiment, the first time window comprises at least one time unit.

In one embodiment, a number of time unit(s) comprised in the first time window is configurable.

In one embodiment, a number of time unit(s) comprised in the first time window is configured by a higher layer parameter.

In one embodiment, names of a higher layer parameter for configuring a number of time unit(s) comprised in the first time window include ra-ResponseWindow.

In one embodiment, a first time unit occupied by the first signal is used to determine a first time unit in the first time window.

In one embodiment, a last time unit occupied by the first signal is used to determine a first time unit in the first time window.

In one embodiment, a start of the first time window is later than an end time of time-domain resources occupied by the first signal.

In one embodiment, a first time unit in the first time window is a L-th time unit after a time unit occupied by the first signal, L being a positive integer.

In one embodiment, a first time unit in the first time window is a L-th time unit after a time unit to which a PRACH resource occupied by the first signal belongs, L being a positive integer.

In one embodiment, L is 1.

In one embodiment, L is configurable.

In one embodiment, a first time unit in the first time window is a time unit to which a first PDCCH occasion following an end of a PRACH resource occupied by the first signal belongs.

In one embodiment, a first time unit in the first time window is a time unit to which a PDCCH occasion for a first said target resource set following an end of a PRACH resource occupied by the first signal belongs.

In one embodiment, the first time window starts with a first PDCCH occasion following an end of a PRACH resource occupied by the first signal.

In one embodiment, the first time window starts with a PDCCH occasion for a first said target resource set following an end of a PRACH resource occupied by the first signal.

In one embodiment, a said time unit is a slot.

In one embodiment, a said time unit is a sub-slot.

In one embodiment, a said time unit is a subframe.

In one embodiment, a said time unit comprises a positive integer number of consecutive multicarrier symbols.

In one embodiment, a number of multicarrier symbol(s) comprised in a said time unit is configured by a higher-layer signaling.

In one embodiment, the first signal carries an MsgA, while the first signaling comprises an MsgB, the first time window being a msgB-ResponseWindow.

In one embodiment, the first signal carries an Msg1, while the first signaling comprises an Msg2, the first time window being a ra-ResponseWindow.

In one embodiment, the first signal carries an Msg3, while the first signaling comprises an Msg4, the first time window comprising a time unit in which a ra-ContentionResolutionTimer is running.

### Embodiment 12

Embodiment 12 illustrates a schematic diagram of a second signal and a second signaling according to one embodiment of the present application; as shown in FIG. 12. In Embodiment 12, as a response to the action of transmitting a second signal, the first node monitors the second signaling in the second time window; time-domain resources of the second signal are used by the first node to determine the second time window.

In one embodiment, time-domain resources occupied by the second signal are used by the second node or the third node to determine the second time window.

In one embodiment, as a response to not receiving the second signaling in the second time window, the first signal is triggered.

In one embodiment, if the first node does not receive the second signaling in the second time window, the first signal is triggered.

In one embodiment, the second signal comprises a baseband signal.

In one embodiment, the second signal comprises a radio signal.

In one embodiment, the second signal comprises a radio frequency signal.

In one embodiment, the second signal comprises a second characteristic sequence.

In one embodiment, the second characteristic sequence comprises one or more of a pseudo-random sequence, a Zadoff-Chu sequence or a low-PAPR sequence.

In one embodiment, the second characteristic sequence is different from the first characteristic sequence.

In one embodiment, the second characteristic sequence comprises a CP.

In one embodiment, the second signal comprises a first characteristic sequence.

In one embodiment, the second signal comprises a random access preamble.

In one embodiment, the second signal comprises a RACH preamble.

In one embodiment, the second signal comprises UCI.

In one embodiment, the second signal comprises an LRR.

In one embodiment, the second signal comprises a MAC CE.

In one embodiment, the second signal comprises a BFR MAC CE or a Truncated BFR MAC CE.

In one embodiment, a channel occupied by the second signal includes a PRACH.

In one embodiment, a channel occupied by the second signal includes a PUSCH.

In one embodiment, a PRACH resource occupied by the second signal implicitly indicates a position of time-frequency resources of a PUSCH occupied by the second signal.

In one embodiment, a channel occupied by the second signal includes a UL-SCH.

In one embodiment, a random access preamble comprised in the first signal and a random access preamble comprised in the second signal correspond to a same random access preamble identifier.

In one embodiment, a random access preamble comprised in the first signal and a random access preamble comprised in the second signal correspond to different random access preamble identifiers.

In one embodiment, when the first condition is satisfied, the second signal is triggered.

In one embodiment, the first condition set comprises the first condition and the second condition.

In one embodiment, when and only when the first condition and the second condition are both satisfied, the first condition set is satisfied.

In one embodiment, if the second condition is unsatisfied, the first condition set is not satisfied.

In one embodiment, when the first condition and the second condition are both satisfied, the first signal is triggered.

In one embodiment, when and only when the first condition and the second condition are both satisfied, the first signal is triggered.

In one embodiment, as a response to the first condition and the second condition being both satisfied, the first signal is triggered.

In one embodiment, the second signaling comprises a physical-layer signaling.

In one embodiment, the second signaling comprises a layer 1 (L1) signaling.

In one embodiment, the second signaling comprises DCI.

In one embodiment, an RNTI used for scrambling CRC of the second signaling includes a C-RNTI.

In one embodiment, CRC of the second signaling is scrambled by a C-RNTI.

In one embodiment, an RNTI used for scrambling CRC of the second signaling includes an MCS-C-RNTI.

In one embodiment, an RNTI used for scrambling CRC of the second signaling includes a RA-RNTI.

In one embodiment, the second signaling comprises a random access response (RAR).

In one embodiment, the second signaling comprises a random access response (RAR) corresponding to a random access preamble comprised in the second signal.

In one embodiment, the second signaling comprises a second random access preamble identifier, the second random access preamble identifier matching with a random access preamble comprised in the second signal.

In one embodiment, the action of monitoring a second signaling in a second time window is performed in a third resource set.

In one embodiment, the third resource set comprises a search space set.

In one embodiment, the third resource set is a search space set.

In one embodiment, the third resource set comprises one or more PDCCH candidates.

In one embodiment, the third resource set comprises all or partial PDCCH candidates in a search space set.

In one embodiment, the third resource set comprises a CORESET.

In one embodiment, the third resource set is a CORESET.

In one embodiment, a search space set to which the third resource set belongs is identified by a recoverySearchSpaceId.

In one embodiment, a search space set to which the third resource set belongs is identified by a SearchSpaceId different from a recoverySearchSpaceId.

In one embodiment, a search space set to which the third resource set belongs is configured by a higher layer parameter ra-SearchSpace.

In one embodiment, the third resource set is the target resource set.

In one embodiment, the third resource set is the first resource set.

In one embodiment, the third resource set is the second resource set.

In one embodiment, the third resource set and the target resource set belong to a same search space set.

In one embodiment, the third resource set and the target resource set are identified by a same SearchSpaceId.

In one embodiment, the third resource set and the target resource set are associated with a same CORESET.

In one embodiment, the third resource set and the target resource set are respectively associated with different CORESETs.

In one embodiment, the second time window is a consecutive duration.

In one embodiment, the second time window includes a ra-Response Window.

In one embodiment, the second time window is a ra-Response Window.

In one embodiment, the second time window comprises a time unit in which a ra-ResponseWindow is running.

In one embodiment, the second time window comprises a time unit in which a ra-ContentionResolutionTimer is running.

In one embodiment, the second time window includes a msgB-ResponseWindow.

In one embodiment, the second time window is a msgB-ResponseWindow.

In one embodiment, the second time window comprises a time unit in which a msgB-Response Window is running.

In one embodiment, the second time window comprises at least one time unit.

In one embodiment, a number of time unit(s) comprised in the second time window is configurable.

In one embodiment, a number of time unit(s) comprised in the second time window is configured by a higher layer parameter.

In one embodiment, names of a higher layer parameter for configuring a number of time unit(s) comprised in the second time window include ra-Response Window.

In one embodiment, a first time unit in the second time window is after a time unit occupied by the second signal.

In one embodiment, a first time unit in the second time window is a time unit to which a PDCCH occasion for a first said third resource set following an end of a PRACH resource occupied by the second signal belongs.

In one embodiment, the second time window starts with a PDCCH occasion for a first said third resource set following an end of a PRACH resource occupied by the second signal.

In one embodiment, an end of the second time window is earlier than a start of the first time window.

In one embodiment, the second signal is earlier than the first signal in time domain.

In one embodiment, a length of the second time window is the same as a length of the first time window.

In one embodiment, a length of the second time window is different from a length of the first time window.

In one embodiment, the second signal carries an MsgA, while the second signaling comprises an MsgB, the second time window being a msgB-ResponseWindow.

In one embodiment, the second signal carries an Msg1, while the second signaling comprises an Msg2, the second time window being a ra-Response Window.

In one embodiment, the second signal carries an Msg3, while the second signaling comprises an Msg4, the second time window comprising a time unit in which a ra-ContentionResolutionTimer is running.

In one embodiment, when the random access procedure is started, the second signal is triggered.

In one embodiment, as a response to the random access procedure being started, the second signal is triggered.

In one embodiment, when the second signal is triggered, the random access procedure is started.

In one embodiment, the second signal comprises a random access preamble that belongs to the random access procedure.

In one embodiment, if the second signaling is received in the second time window, a random access procedure to which a random access preamble comprised in the second signal belongs is determined to be successful.

In one embodiment, if the second signaling is not received in the second time window, a random access procedure to which a random access preamble comprised in the second signal belongs is determined to be unsuccessful.

In one embodiment, whether the second signaling is received in the second time window is used to maintain the first counter.

In one embodiment, whether the second signaling is received in the second time window is used to determine whether the value of the first counter is incremented by 1.

In one embodiment, the action of maintaining the first counter comprises: if the second signaling is received in the second time window, a value of the first counter keeping unchanged.

In one embodiment, the action of maintaining the first counter comprises: if the second signaling is not received in the second time window, a value of the first counter being incremented by 1.

In one embodiment, the action of maintaining the first counter comprises: if a random access response corresponding to a random access preamble comprised in the second signal is not received in the second time window, incrementing the value of the first counter by 1.

In one embodiment, the action of maintaining the first counter comprises: if a random access response corresponding to a random access preamble comprised in the second signal is not received before the second time window expires, incrementing the value of the first counter by 1.

In one embodiment, the first signal and the second signal respectively comprise two random access preambles that belong to a same random access procedure.

In one embodiment, the first signal and the second signal respectively comprise two random access preambles that belong to the random access procedure.

In one embodiment, whether the second signaling is received in the second time window is used to determine whether the value of the second counter is cleared to zero.

In one embodiment, if the second signaling is received in the second time window, the value of the second counter is cleared to zero.

### Embodiment 13

Embodiment 13 illustrates a schematic diagram of a first power value according to one embodiment of the present application; as shown in FIG. 13. In Embodiment 13, the first power value is a smallest value between a first reference power value and a first power threshold; the first reference power value is linear with a first target power value, where a linear coefficient between the first reference power value and the first target power value is equal to 1.

In one embodiment, the second signal is used by the second node to determine the second reference signal.

In one embodiment, the second signal is used by the third node to determine the second reference signal.

In one embodiment, whether the first reference signal and the second reference signal are a same reference signal is used by the first node to determine the first power value.

In one embodiment, the first power value is measured in Watts.

In one embodiment, the first power value is measured in dBm.

In one embodiment, the first power threshold is measured in Watts.

In one embodiment, the first power threshold is measured in dBm.

In one embodiment, the first power threshold is a maximum output power configured by the first node.

In one embodiment, the first power threshold is a maximum power for the first node in the uplink.

In one embodiment, the first target power value is related to whether the first reference signal and the second reference signal are a same reference signal.

In one embodiment, the first target power value is linear with a first component, where a linear coefficient between the first target power value and the first component is equal to 1; the first component is equal to a product of a third counter's value minus 1 being multiplied by a first step-size, whether the first reference signal and the second reference signal are a same reference signal is used to determine whether the third counter's value is incremented by 1; the first step-size is a positive real number.

In one embodiment, whether the first reference signal and the second reference signal are a same reference signal is used to determine whether the third counter's value is incremented by 1 before transmitting the first signal.

In one embodiment, the third counter is a PREAMBLE_POWER_RAMPING_COUNTER.

In one embodiment, an initial value of the third counter equals 1.

In one embodiment, when the random access procedure is started, the value of the third counter is set to 1.

In one embodiment, if the first reference signal and the second reference signal are a same reference signal, the value of the third counter is incremented by 1.

In one embodiment, if the first reference signal and the second reference signal are a same reference signal and a value of the first counter is greater than 1, the value of the third counter is incremented by 1.

In one embodiment, if the first reference signal and the second reference signal are not a same reference signal, the value of the third counter is kept unchanged.

In one embodiment, if the first reference signal and the second reference signal are a same reference signal, the value of the third counter is set to 1.

In one embodiment, the first component is equal to 0.

In one embodiment, the first component is greater than 0.

In one embodiment, the first step-size is configured by a higher layer parameter.

In one embodiment, names of a higher layer parameter configuring the first step-size include powerRampingStep.

In one embodiment, the first step-size is equal to PREAMBLE_POWER_RAMPING_STEP.

In one embodiment, the first target power value is linear with a second component, where a linear coefficient between the first target power value and the second component is equal to 1; the second component is a random access preamble power.

In one embodiment, the second component is configured by a higher layer parameter.

In one embodiment, names of a higher layer parameter configuring the second component include preambleReceivedTargetPower.

In one embodiment, the first target power value is linear with a third component, where a linear coefficient between the first target power value and the third component is equal to 1; the third component is a random access preamble power offset.

In one embodiment, a value of the third component is related to a format of a random access preamble comprised in the first signal.

In one embodiment, the first reference power value is linear with a first pathloss value, with a linear coefficient between the first reference power value and the first pathloss value being 1.

In one embodiment, the first pathloss value is measured in dB.

In one embodiment, the first pathloss value is equal to a transmit power of the first reference signal being subtracted by an RSRP of the first reference signal.

In one embodiment, the first pathloss value is equal to a transmit power of a third reference signal being subtracted by an RSRP of the third reference signal.

In one embodiment, a PRACH resource occupied by the second signal is used to determine the second reference signal.

In one embodiment, a PRACH resource occupied by the second signal is used to indicate the second reference signal.

In one embodiment, a PRACH resource occupied by the second signal indicates the second reference signal out of the M reference signals.

In one embodiment, a PRACH resource occupied by the second signal is one of the M candidate PRACH resources; the second reference signal is a reference signal corresponding to a PRACH resource occupied by the second signal among the M reference signals.

In one embodiment, the second signal comprises a second bit field, the second bit field comprising a positive integer number of bit(s); a value of the second bit field indicates the second reference signal.

In one embodiment, for the monitoring on the second signaling in the second time window, the first node assumes a QCL parameter the same as the second reference signal.

In one embodiment, the first node assumes that an antenna port of the second signaling and the second reference signal are QCL.

In one embodiment, the first node assumes that DMRS of a PDCCH occupied by the second signaling and the second reference signal are QCL.

In one embodiment, the first node receives the second reference signal and monitors the second signaling in the second time window using a same spatial domain filter.

In one embodiment, large-scale properties of a channel over which the second reference signal is conveyed can be used to infer large-scale properties of a channel over which the second signaling is conveyed.

In one embodiment, large-scale properties of a channel over which the second reference signal is conveyed can be used to infer large-scale properties of a channel over which DMRS of a PDCCH occupied by the second signaling is conveyed.

In one embodiment, the sentence that the first reference signal and the second reference signal are a same reference signal comprises a meaning that: the first reference signal and the second reference signal occupy a same reference signal resource.

In one embodiment, the sentence that the first reference signal and the second reference signal are a same reference signal comprises a meaning that: the first reference signal and the second reference signal correspond to a same reference signal identifier.

In one embodiment, the sentence that the first reference signal and the second reference signal are a same reference signal comprises a meaning that: the first reference signal and the second reference signal are identified by a same SSB index or CSI-RS resource index.

In one embodiment, the sentence that the first reference signal and the second reference signal are a same reference signal comprises a meaning that: the first reference signal and the second reference signal are QCL.

In one embodiment, the sentence that the first reference signal and the second reference signal are a same reference signal comprises a meaning that: the first reference signal and the second reference signal correspond to a same candidate PRACH resource among the M candidate PRACH resources.

In one embodiment, the sentence that the first reference signal and the second reference signal are not a same reference signal comprises a meaning that: the first reference signal and the second reference signal respectively occupy different reference signal resource.

In one embodiment, the sentence that the first reference signal and the second reference signal are not a same reference signal comprises a meaning that: the first reference signal and the second reference signal correspond to different reference signal identifiers.

In one embodiment, the reference signal identifier includes at least one of an SSB index or a CSI-RS resource index.

In one embodiment, the sentence that the first reference signal and the second reference signal are not a same reference signal comprises a meaning that: the first reference signal and the second reference signal are non-QCL.

In one embodiment, the sentence that the first reference signal and the second reference signal are not a same reference signal comprises a meaning that: the first reference signal and the second reference signal respectively correspond to different candidate PRACH resources among the M candidate PRACH resources.

In one embodiment, the first reference signal is the second reference signal.

In one embodiment, the first reference signal is not the second reference signal.

In one embodiment, the second reference signal is one of the M reference signals.

In one embodiment, the second reference signal belongs to the first reference signal subset or the second reference signal subset.

### Embodiment 14

Embodiment 14 illustrates a schematic diagram of M reference signals and M second-type received qualities according to one embodiment of the present application; as shown in FIG. 14. In Embodiment 14, measurements on the M reference signals are respectively used to determine the M second-type received qualities; a second-type received quality corresponding to the first reference signal among the M second-type received qualities is no worse than the second reference threshold. In FIG. 14, indexes of the M reference signals and the M second-type received qualities are respectively #0 . . . , and #(M−1).

In one embodiment, the first reference signal subset comprises a positive integer number of reference signal(s) among the M reference signals.

In one embodiment, the first reference signal subset only comprises one reference signal among the M reference signals.

In one embodiment, the first reference signal subset comprises multiple reference signals among the M reference signals.

In one embodiment, there is one reference signal among the M reference signals that does not belong to the first reference signal subset.

In one embodiment, the first reference signal subset comprises the M reference signals.

In one embodiment, the second reference signal subset comprises a positive integer number of reference signal(s) among the M reference signals.

In one embodiment, the second reference signal subset only comprises one reference signal among the M reference signals.

In one embodiment, the second reference signal subset comprises multiple reference signals among the M reference signals.

In one embodiment, there is one reference signal among the M reference signals that does not belong to the second reference signal subset.

In one embodiment, the second reference signal subset comprises the M reference signals.

In one embodiment, the second reference signal subset comprises all reference signals among the M reference signals.

In one embodiment, the M reference signals consist of the first reference signal subset and the second reference signal subset.

In one embodiment, there isn't any reference signal among the M reference signals that belongs to the first reference signal subset and the second reference signal subset simultaneously.

In one embodiment, there is a reference signal among the M reference signals that belongs to the first reference signal subset and the second reference signal subset simultaneously.

In one embodiment, any reference signal among the M reference signals belongs to at least one of the first reference signal subset or the second reference signal subset.

In one embodiment, any of the M reference signals comprises a CSI-RS or an SSB.

In one embodiment, a reference signal resource occupied by any reference signal among the M reference signals comprises a CSI-RS resource or SSB resource.

In one embodiment, for any given reference signal among the M reference signals, measuring the given reference signal within a second time interval is used to determine a second-type received quality corresponding to the given reference signal.

In one embodiment, for any given reference signal among the M reference signals, the first node obtains a measurement used for computing a second-type received quality corresponding to the given reference signal only according to the given reference signal received within a second time interval.

In one embodiment, the second time interval is a consecutive duration.

In one embodiment, a length of the second time interval is equal to T_{Evaluate_CBD_SSB} ms or T_{Evaluate_CBD_CSI-RS} MS.

In one embodiment, the definitions of T_{Evaluate_CBD_SSB} and T_{Evaluate_CBD_CSI-RS} can be found in 3GPPTS38.133.

In one embodiment, any second-type received quality among the M second-type received qualities is an RSRP.

In one embodiment, any second-type received quality among the M second-type received qualities is a L1-RSRP.

In one embodiment, any second-type received quality among the M second-type received qualities is a SINR.

In one embodiment, any second-type received quality among the M second-type received qualities is a L1-SINR.

In one embodiment, any second-type received quality among the M second-type received qualities is a BLER.

In one embodiment, the sentence that a second-type received quality corresponding to the first reference signal among the M second-type received qualities is no worse than a second reference threshold means: the second-type received quality corresponding to the first reference signal is one of an RSRP, a L1-RSRP, a SINR or a L1-SINR, and the second-type received quality corresponding to the first reference signal is greater than or equal to the second reference threshold.

In one embodiment, the sentence that a second-type received quality corresponding to the first reference signal among the M second-type received qualities is no worse than a second reference threshold means: the second-type received quality corresponding to the first reference signal is a BLER, and the second-type received quality corresponding to the first reference signal is less than or equal to the second reference threshold.

In one embodiment, a given reference signal is a reference signal among the M reference signals.

In one subembodiment, an RSRP of the given reference signal is used to determine a second-type received quality among the M second-type received qualities that corresponds to the given reference signal.

In one subembodiment, a second-type received quality among the M second-type received qualities that corresponds to the given reference signal is equal to an RSRP of the given reference signal.

In one subembodiment, a L1-RSRP of the given reference signal is used to determine a second-type received quality among the M second-type received qualities that corresponds to the given reference signal.

In one subembodiment, a second-type received quality among the M second-type received qualities that corresponds to the given reference signal is equal to a L1-RSRP of the given reference signal.

In one subembodiment, a second-type received quality among the M second-type received qualities that corresponds to the given reference signal is equal to a L1-RSRP obtained by scaling a receiving power of the given reference signal according to a value indicated by a higher-layer parameter powerControlOffsetSS.

In one subembodiment, a SINR of the given reference signal is used to determine a second-type received quality among the M second-type received qualities that corresponds to the given reference signal.

In one subembodiment, a second-type received quality among the M second-type received qualities that corresponds to the given reference signal is equal to a SINR of the given reference signal.

In one subembodiment, the given reference signal is any reference signal among the M reference signals.

In one embodiment, any second-type received quality among the M second-type received qualities is obtained by looking up in tables of an RSRP, a L1-RSRP, a SINR or a L1-SINR of a corresponding reference signal.

In one embodiment, the second reference threshold is a real number.

In one embodiment, the second reference threshold is a non-negative real number.

In one embodiment, the second reference threshold is a non-negative real number no greater than 1.

In one embodiment, the second reference threshold is equal to Q_{in_LR}.

In one embodiment, the definition of the Q_{in_LR} can be found in 3GPP TS38.133.

In one embodiment, the second reference threshold is configured by a higher layer parameter rsrp-ThresholdSSB.

In one embodiment, a second-type received quality corresponding to the second reference signal is no poorer than the second reference threshold.

In one embodiment, the M second-type received qualities respectively correspond to M reference thresholds, where the second reference threshold is a reference threshold corresponding to the first reference signal among the M reference thresholds.

In one embodiment, any of the M reference thresholds is equal to the second reference threshold.

In one embodiment, any of the M reference thresholds is a real number.

In one embodiment, any of the M reference thresholds is a positive real number.

In one embodiment, there are two equal reference thresholds among the M reference thresholds.

In one embodiment, there are two unequal reference thresholds among the M reference thresholds.

In one embodiment, the M reference thresholds are mutually unequal.

In one embodiment, a reference threshold corresponding to any reference signal in the first reference signal subset among the M reference thresholds is equal to a first value, while a reference threshold corresponding to any reference signal in the second reference signal subset among the M reference thresholds is equal to a second value; the first value and the second value are respectively real numbers, the first value being unequal to the second value.

In one embodiment, a second-type received quality corresponding to the second reference signal is no poorer than a corresponding reference threshold.

In one embodiment, upon reception of a higher-layer request, a physical layer of the first node transmits a second information block to a higher layer; herein, the second information block indicates M0 reference signal(s) and M0 second-type received quality/qualities, any one of the M0 reference signal(s) being one of the M reference signals, M0 being a positive integer no greater than the M; the M0 second-type received quality/qualities is/are respectively second-type received quality/qualities corresponding to the M0 reference signal(s) among the M second-type received qualities.

In one subembodiment, M0 is equal to 1.

In one subembodiment, M0 is greater than 1.

In one subembodiment, any of the M0 second-type received quality/qualities is no poorer than the second reference threshold.

In one subembodiment, any of the M0 second-type received quality/qualities is no poorer than a corresponding reference threshold.

In one subembodiment, the first reference signal is one of the M0 reference signal(s).

In one embodiment, the first condition set comprises a third condition, the third condition comprising that there exists a second-type received quality among the M second-type received qualities that is no poorer than the second reference threshold.

In one embodiment, the first condition set comprises a third condition, the third condition comprising that there exists a second-type received quality among the M second-type received qualities that is no poorer than a corresponding reference threshold.

In one embodiment, the first condition set comprises a third condition, the third condition comprising that there exists a reference signal in a target reference signal subset to which a second-type received quality corresponds is no poorer than a corresponding reference threshold; any reference signal in the target reference signal subset is one of the M reference signals; a value of the first counter is used to determine the target reference signal subset; when a value of the first counter is no greater than the first threshold, the target reference signal subset is the first reference signal subset; when a value of the first counter is greater than the first threshold, the target reference signal subset is the second reference signal subset.

In one embodiment, the first condition set comprises the first condition, the second condition and the third condition.

In one embodiment, the first condition set consists of the first condition, the second condition and the third condition.

In one embodiment, when and only when all of the first condition, the second condition and the third condition are satisfied, the first condition set is satisfied.

In one embodiment, if the third condition is unsatisfied, the first condition set is not satisfied.

In one embodiment, when and only when all of the first condition, the second condition and the third condition are satisfied, the first signal is triggered.

In one embodiment, M configuration information blocks respectively indicate the M reference signals; among the M configuration information blocks each configuration information block corresponding to a reference signal transmitted by the first cell comprises a first index, the first index being used to indicate the first cell; among the M configuration information blocks each configuration information block corresponding to a reference signal transmitted by the second cell comprises a second index, the second index being used to indicate the second cell; the first index and the second index are non-negative integers, respectively.

In one embodiment, the first index and the second index are respectively comprised of Q1 bits and Q2 bits, where Q1 and Q2 are two positive integers different from each other; Q2 is greater than Q1.

In one embodiment, any configuration information block among the M configuration information blocks is carried by an RRC signaling.

In one embodiment, any configuration information block among the M configuration information blocks comprises information in all or partial fields in an IE.

In one embodiment, any configuration information block among the M configuration information blocks comprises partial or all information in a candidateBeamRSList field in a BeamFailureRecoveryConfig IE.

In one embodiment, the first index is a SCellIndex corresponding to the first cell.

In one embodiment, the first index is a ServCellIndex corresponding to the first cell.

In one embodiment, the first index is a CellIdentity corresponding to the first cell.

In one embodiment, the first index is a PhysCellId corresponding to the first cell.

In one embodiment, the second index is a SCellIndex corresponding to the second cell.

In one embodiment, the second index is a ServCellIndex corresponding to the second cell.

In one embodiment, the second index is a CellIdentity corresponding to the second cell.

In one embodiment, the second index is a PhysCellId corresponding to the second cell.

### Embodiment 15

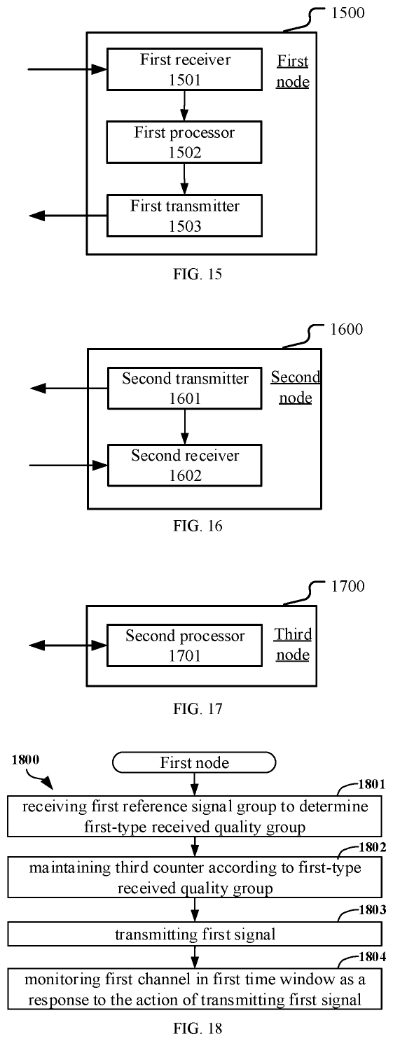

Embodiment 15 illustrates a structure block diagram of a processing device used in a first node according to one embodiment of the present application; as shown in FIG. 15. In FIG. 15, a processing device 1500 in a first node comprises a first receiver 1501, a first processor 1502 and a first transmitter 1503.

In Embodiment 15, the first receiver 1501 receives a first reference signal group to determine a first-type received quality group; the first processor 1502 maintains a second counter according to the first-type received quality group; and the first transmitter 1503 transmits a first signal.

In Embodiment 15, the first-type received quality group comprises at least one first-type received quality; the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

In one embodiment, there is a reference signal in the first reference signal subset being associated with a first cell, and there is a reference signal in the second reference signal subset being associated with a second cell.

In one embodiment, as a response to the action of transmitting a first signal, the first receiver 1501 monitors a first signaling in a first time window; herein, time-domain resources occupied by the first signal are used to determine the first time window.

In one embodiment, the first processor 1502 maintains the first counter; herein, when the value of the first counter reaches a third threshold, indicating a random access problem to a higher layer, the third threshold being greater than the first threshold.

In one embodiment, the first transmitter 1503 transmits a second signal; as a response to the action of transmitting a second signal, the first receiver 1501 monitors a second signaling in a second time window; herein, time-domain resources occupied by the second signal are used to determine the second time window; as a response to the first condition being satisfied, the second signal is triggered; the first condition set comprises a second condition, the second condition comprising not receiving the second signaling in the second time window.

In one embodiment, the second signal is used to determine a second reference signal, a transmit (Tx) power of the first signal being equal to a first power value; whether the first reference signal and the second reference signal are a same reference signal is used to determine the first power value.

In one embodiment, the first receiver 1501 receives M reference signals, where M is a positive integer greater than 1; herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

In one embodiment, the first node is a UE.

In one embodiment, the first node is a relay node.

In one embodiment, the first receiver 1501 comprises at least one of the antenna 452, the receiver 454, the receiving processor 456, the multi-antenna receiving processor 458, the controller/processor 459, the memory 460 or the data source 467 in Embodiment 4.

In one embodiment, the first processor 1502 comprises at least one of the receiver/transmitter 454, the receiving processor 456, the transmitting processor 468, the multi-antenna receiving processor 458, the multi-antenna transmitting processor 457, the controller/processor 459, the memory 460 or the data source 467 in Embodiment 4.

In one embodiment, the first transmitter 1503 comprises at least one of the antenna 452, the transmitter 454, the transmitting processor 468, the multi-antenna transmitting processor 457, the controller/processor 459, the memory 460 or the data source 467 in Embodiment 4.

### Embodiment 16

Embodiment 16 illustrates a structure block diagram of a processing device used in a second node according to one embodiment of the present application; as shown in FIG. 16. In FIG. 16, a processing device 1600 in a second node comprises a second transmitter 1601 and a second receiver 1602.

In Embodiment 16, the second transmitter 1601 transmits a first reference signal sub-group; and the second receiver 1602 blind detects a first signal.

In Embodiment 16, any reference signal in the first reference signal sub-group belonging to a first reference signal group, the first reference signal group being used to determine a first-type received quality group, the first-type received quality group comprising at least one first-type received quality; and the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; the first-type received quality group is used to maintain the second counter.

In one embodiment, there is a reference signal in the first reference signal subset being associated with a first cell, and there is a reference signal in the second reference signal subset being associated with a second cell; the second node is a maintenance base station for the first cell.

In one embodiment, as a response to an action of detecting the first signal, the second transmitter 1601 transmits a first signaling in a first time window; where the second receiver 1602 detects the first signal; time-domain resources occupied by the first signal are used to determine the first time window.

In one embodiment, whether the first signaling is received in the first time window is used to maintain the first counter.

In one embodiment, the second receiver 1602 blind detects a second signal; when the second signal is detected, as a response to the action of detecting the second signal, the second transmitter 1601 transmits a second signaling in a second time window; herein, time-domain resources occupied by the second signal are used to determine the second time window; as a response to the first condition being satisfied, the second signal is triggered; the first condition set comprises a second condition, the second condition comprising that the second signaling is not received in the second time window.

In one embodiment, the second signal is used to determine a second reference signal, a transmit (Tx) power of the first signal being equal to a first power value; whether the first reference signal and the second reference signal are a same reference signal is used to determine the first power value.

In one embodiment, the second transmitter 1601 transmits M1 reference signal(s) of the M reference signals, where M is a positive integer greater than 1 and M1 is a positive integer no greater than M; herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

In one embodiment, the second node is a base station.

In one embodiment, the second node is a UE.

In one embodiment, the second node is a relay node.

In one embodiment, the second transmitter 1601 comprises at least one of the antenna 420, the transmitter 418, the transmitting processor 416, the multi-antenna transmitting processor 471, the controller/processor 475 or the memory 476 in Embodiment 4.

In one embodiment, the second receiver 1602 comprises at least one of the antenna 420, the receiver 418, the receiving processor 470, the multi-antenna receiving processor 472, the controller/processor 475 or the memory 476 in Embodiment 4.

### Embodiment 17

Embodiment 17 illustrates a structure block diagram of a processing device used in a third node according to one embodiment of the present application; as shown in FIG. 17. In FIG. 17, a processing device 1700 in a third node comprises a second processor 1701.

In Embodiment 17, the second processor 1701 blind detects a first signal.

In Embodiment 17, the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; a first-type received quality group is used to maintain the second counter, and a first reference signal group is used to determine the first-type received quality group, the first-type received quality group comprising at least one first-type received quality.

In one embodiment, the second processor 1701 transmits a second reference signal sub-group; herein, any reference signal in the second reference signal sub-group belongs to the first reference signal group.

In one embodiment, there is a reference signal in the first reference signal subset being associated with a first cell, and there is a reference signal in the second reference signal subset being associated with a second cell; the third node is a maintenance base station for the second cell.

In one embodiment, as a response to an action of detecting the first signal, the second processor 1701 transmits a first signaling in a first time window; where the second processor 1701 detects the first signal; time-domain resources occupied by the first signal are used to determine the first time window.

In one embodiment, whether the first signaling is received in the first time window is used to maintain the first counter.

In one embodiment, the second processor 1701 blind detects a second signal; when the second signal is detected, as a response to the action of detecting the second signal, the second processor 1701 transmits a second signaling in a second time window; herein, time-domain resources occupied by the second signal are used to determine the second time window; as a response to the first condition being satisfied, the second signal is triggered; the first condition set comprises a second condition, the second condition comprising that the second signaling is not received in the second time window.

In one embodiment, the second signal is used to determine a second reference signal, a transmit (Tx) power of the first signal being equal to a first power value; whether the first reference signal and the second reference signal are a same reference signal is used to determine the first power value.

In one embodiment, the second processor 1701 transmits M2 reference signal(s) among M reference signals, M being a positive integer greater than 1 and M2 being a positive integer less than M; herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

In one embodiment, the third node is a base station.

In one embodiment, the third node is a UE.

In one embodiment, the third node is a relay node.

In one embodiment, the second processor 1701 comprises at least one of the antenna 420, the transmitter/receiver 418, the transmitting processor 416, the receiving processor 470, the multi-antenna transmitting processor 471, the multi-antenna receiving processor 472, the controller/processor 475 or the memory 476 in Embodiment 4.

### Embodiment 18

Embodiment 18 illustrates a flowchart of a first reference signal group, a third counter, a first signal and a first channel according to one embodiment of the present application, as shown in FIG. 18. In 1800 illustrated by FIG. 18, each box represents a step. Particularly, the sequential step arrangement in each box herein does not imply a chronological order of steps marked respectively by these boxes.

In Embodiment 18, the first node in the present application receives a first reference signal group in step 1801 to determine a first-type received quality group; maintains a third counter according to the first-type received quality group in step 1802; and transmits a first signal in step 1803; and in step 1804, as a response to the action of transmitting a first signal, monitors a first channel in a first time window. Herein, the first-type received quality group comprises at least one first-type received quality; time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the first reference signal subset corresponds to the first counter, while the second reference signal subset corresponds to the second counter.

In one embodiment, a value of only one counter of the first counter and the second counter is related to whether the first channel is received in the first time window.

In one embodiment, the first reference signal is used to determine a value of which one of the first counter and the second counter is related to whether the first channel is received in the first time window.

In one embodiment, if the first reference signal belongs to the first reference signal subset, a value of the second counter is unrelated to whether the first channel is received in the first time window.

In one embodiment, if the first reference signal belongs to the second reference signal subset, a value of the first counter is unrelated to whether the first channel is received in the first time window.

In one embodiment, if the first reference signal belongs to the first reference signal subset, whether the first channel is received in the first time window is used to determine whether a value of the first counter is incremented by 1; if the first reference signal belongs to the second reference signal subset, whether the first channel is received in the first time window is used to determine whether a value of the second counter is incremented by 1.

In one embodiment, the sentence of whether the first channel is received means: whether a transmission of the first channel is received.

In one embodiment, the phrase of monitoring a first channel means: monitoring a Physical Downlink Control Channel (PDCCH) candidate to determine whether the first channel is received.

In one embodiment, the action of monitoring a first channel is performed in a target resource set.

In one embodiment, the phrase of monitoring a first channel means: monitoring a PDCCH candidate in a target resource set to determine whether the first channel is received.

In one embodiment, the sentence that the first channel is received means: detecting a Downlink control information (DCI) format in a PDCCH candidate.

In one embodiment, the sentence that the first channel is received means: detecting a DCI format whose Cyclic Redundancy Check (CRC) is scrambled by an identifier in a first identifier set in a PDCCH candidate; the first identifier set comprises a positive integer number of Radio Network Temporary Identifier(s) (RNTI(s)).

In one embodiment, the sentence that the first channel is received means: detecting a DCI format in a PDCCH candidate comprised in the target resource set.

In one embodiment, the sentence that the first channel is received means: detecting a DCI format whose CRC is scrambled by an identifier in a first identifier set in a PDCCH candidate comprised in the target resource set; the first identifier set comprises a positive integer number of RNTI(s).

In one embodiment, the sentence that the first channel is not received means: not detecting a DCI format in a PDCCH candidate.

In one embodiment, the sentence that the first channel is not received means: not detecting a DCI format whose CRC is scrambled by an identifier in the first identifier set in a PDCCH candidate.

In one embodiment, the sentence that the first channel is not received means: not detecting a DCI format in any PDCCH candidate comprised in the target resource set.

In one embodiment, the sentence that the first channel is not received means: not detecting a DCI format whose CRC is scrambled by an identifier in the first identifier set in any PDCCH candidate comprised in the target resource set.

In one embodiment, the first identifier set only comprises one RNTI.

In one embodiment, the first identifier set comprises multiple RNTIs.

In one embodiment, the first identifier set comprises a Cell-RNTI (C-RNTI).

In one embodiment, the first identifier set comprises a Modulation and Coding Scheme (MCS)-C-RNTI.

In one embodiment, the first identifier set comprises a Random Access (RA)-RNTI.

In one embodiment, if it is determined that decoding is correct in a PDCCH candidate according to a CRC bit, it is then determined that a DCI format is detected in the PDCCH candidate; otherwise, it is determined that no DCI format is detected in the PDCCH candidate.

In one embodiment, if it is determined that decoding is correct in a PDCCH candidate according to a CRC bit scrambled by an identifier, it is then determined that a DCI format whose CRC is scrambled by the identifier is detected in the PDCCH candidate; otherwise, it is determined that no DCI format whose CRC is scrambled by the identifier is detected in the PDCCH candidate.

In one embodiment, the first channel comprises a physical layer channel.

In one embodiment, the first channel comprises a layer 1 (L1) channel.

In one embodiment, the first channel is for an RNTI in a first identifier set.

In one embodiment, the first channel is identified by an RNTI in a first identifier set.

In one embodiment, the first channel comprises a downlink physical layer control channel (i.e., a downlink channel only capable of bearing physical layer signaling).

In one embodiment, the first channel comprises a PDCCH.

In one embodiment, the first channel is a PDCCH.

In one embodiment, the first channel is a PDCCH for an RNTI in a first identifier set.

In one embodiment, the monitoring refers to blind decoding, that is, to receive a signal and perform decoding operation; if the decoding is determined to be correct according to a CRC bit, it is then determined that the first channel is received; otherwise, it is determined that the first channel is not received.

In one embodiment, the monitoring refers to coherent detection, that is, to perform coherent reception and measure energy of a signal obtained by the coherent reception; if the energy of the signal obtained by the coherent reception is larger than a first given threshold, it is determined that the first channel is received; otherwise, it is determined that the first channel is not received.

In one embodiment, the monitoring refers to energy detection, that is, to sense energies of radio signals and average to obtain a received energy; if the received energy is larger than a second given threshold, it is determined that the first channel is received; otherwise, it is determined that the first channel is not received.

In one embodiment, the phrase of monitoring a first channel means: determining according to CRC whether the first channel is to be transmitted.

In one embodiment, the phrase of monitoring a first channel means: being unsure of whether the first channel is to be transmitted before it is determined whether decoding is correct according to CRC.

In one embodiment, the phrase of monitoring a first channel means: determining according to coherent detection whether the first channel is to be transmitted.

In one embodiment, the phrase of monitoring a first channel means: being unsure of whether the first channel is to be transmitted before coherent detection.

In one embodiment, the phrase of monitoring a first channel means: determining according to energy detection whether the first channel is to be transmitted.

In one embodiment, the phrase of monitoring a first channel means: being unsure of whether the first channel is to be transmitted before energy detection.

In one embodiment, a first signaling is transmitted in the first channel.

In one embodiment, the first channel bears a first signaling.

In one embodiment, the first node monitors the first channel to detect a first signaling.

In one embodiment, the sentence of whether the first channel is received means: whether the first signaling is detected.

In one embodiment, the phrase of monitoring a first channel means: the first signaling being detected.

In one embodiment, if decoding is determined to be correct according to a CRC bit, it is then determined that the first signaling is detected; otherwise, it is determined that the first signaling is not detected.

In one embodiment, if the energy of a signal obtained by coherent reception is larger than a first given threshold, it is determined that the first signaling is detected; otherwise, it is determined that the first signaling is not detected.

In one embodiment, the phrase of monitoring a first channel means: determining according to CRC whether the first signaling is to be transmitted.

In one embodiment, the phrase of monitoring a first channel means: determining according to coherent detection whether the first signaling is to be transmitted.

In one embodiment, the first signaling comprises DCI.

In one embodiment, the first signaling comprises a DCI format.

In one embodiment, the first signaling is a DCI format.

In one embodiment, an RNTI used for scrambling CRC of the first signaling includes a C-RNTI.

In one embodiment, CRC of the first signaling is scrambled by a C-RNTI.

In one embodiment, an RNTI used for scrambling CRC of the first signaling includes a MCS-C-RNTI.

In one embodiment, an RNTI used for scrambling CRC of the first signaling includes a RA-RNTI.

In one embodiment, CRC of the first signaling is scrambled by a RA-RNTI.

In one embodiment, the first signaling comprises a random access response (RAR).

In one embodiment, the first signaling comprises a random access response (RAR) corresponding to a random access preamble comprised in the first signal.

In one embodiment, the first signaling comprises a first random access preamble identifier, the first random access preamble identifier matching with a random access preamble comprised in the first signal.

In one embodiment, the first signaling is transmitted on a PDCCH.

In one embodiment, the first condition is that a value of the third counter is no less than the third threshold.

In one embodiment, when the first condition set is satisfied, the first signal is triggered.

In one embodiment, when the first condition set is unsatisfied, the first signal is not triggered.

In one embodiment, when and only when the first condition set is satisfied, the first signal is triggered.

In one embodiment, the first condition set only comprises the first condition.

In one embodiment, the first condition set comprises a positive integer number of conditions.

In one embodiment, when and only when each condition in the first condition set is satisfied, the first condition set is satisfied.

In one embodiment, if there is one condition unsatisfied in the first condition set, the first condition set is not satisfied.

In one embodiment, the first condition set only comprises the first condition; when the first condition is satisfied, the first condition set is satisfied; when the first condition is unsatisfied, the first condition set is unsatisfied.

In one embodiment, as a response to the first condition being satisfied, the first signal is triggered.

In one embodiment, if the first condition is unsatisfied, the first signal is not triggered.

In one embodiment, when the first condition is satisfied, a physical layer of the first node receives a first indication information block from a higher layer of the first node; herein, the first indication information block triggers transmission of the first signal.

In one embodiment, the first condition set comprises P conditions, P being a positive integer greater than 1, where the first condition is one of the P conditions; when and only when each of the P conditions is satisfied, the first condition set is satisfied.

In one embodiment, when the first condition set is satisfied, a physical layer of the first node receives a first indication information block from a higher layer of the first node; herein, the first indication information block triggers transmission of the first signal.

In one embodiment, the first indication information block indicates the first reference signal.

In one embodiment, the reference signal comprises a reference signal resource.

In one embodiment, the reference signal comprises a reference signal port.

In one embodiment, modulation symbols comprised in the reference signal are known to the first node.

In one embodiment, the first reference signal group comprises a positive integer number of reference signal(s).

In one embodiment, the first reference signal group only comprises one reference signal.

In one embodiment, the first reference signal group comprises more than one reference signal.

In one embodiment, the first reference signal group comprises a Synchronisation Signal/physical broadcast channel Block (SSB).

In one embodiment, the first reference signal group comprises a Channel State Information-Reference Signal (CSI-RS).

In one embodiment, the first reference signal group comprises a Non-Zero-Power (NZP) CSI-RS.

In one embodiment, the first reference signal group comprises a Sounding Reference Signal (SRS).

In one embodiment, any reference signal in the first reference signal group includes a CSI-RS or an SSB.

In one embodiment, any reference signal in the first reference signal group is a Non-Zero-Power (NZP) CSI-RS or SSB.

In one embodiment, a reference signal resource occupied by any reference signal in the first reference signal group comprises a CSI-RS resource or SSB resource.

In one embodiment, any reference signal in the first reference signal group is identified by an SSB index or a CSI-RS resource index.

In one embodiment, any reference signal in the first reference signal group is a periodic reference signal.

In one embodiment, any reference signal in the first reference signal group is a periodic reference signal or a semi-persistent reference signal.

In one embodiment, there is a reference signal in the first reference signal group being a semi-persistent reference signal or an aperiodic reference signal.

In one embodiment, all reference signals in the first reference signal group belong to a same Carrier.

In one embodiment, all reference signals in the first reference signal group belong to a same Bandwidth Part (BWP).

In one embodiment, there are two reference signals in the first reference signal group that respectively belong to different carriers.

In one embodiment, there are two reference signals in the first reference signal group that respectively belong to different BWPs in frequency domain.

In one embodiment, all reference signals in the first reference signal group are associated with the first cell.

In one embodiment, all reference signals in the first reference signal group are associated with the second cell.

In one embodiment, there are two reference signals in the first reference signal group being respectively associated with the first cell and the second cell.

In one embodiment, any reference signal in the first reference signal group is associated with a serving cell of the first node.

In one embodiment, all reference signals in the first reference signal group are associated with a same serving cell of the first node.

In one embodiment, there are two reference signals in the first reference signal group being respectively associated with two different serving cells of the first node.

In one embodiment, the first reference signal subset only comprises one reference signal.

In one embodiment, the first reference signal subset comprises more than one reference signal.

In one embodiment, the first reference signal subset comprises an SSB.

In one embodiment, the first reference signal subset comprises a CSI-RS.

In one embodiment, the first reference signal subset comprises a Non-Zero-Power (NZP) CSI-RS.

In one embodiment, the first reference signal subset comprises an SRS.

In one embodiment, any reference signal in the first reference signal subset includes a CSI-RS or an SSB.

In one embodiment, any reference signal in the first reference signal subset is a Non-Zero-Power (NZP) CSI-RS or SSB.

In one embodiment, a reference signal resource occupied by any reference signal in the first reference signal subset comprises a CSI-RS resource or SSB resource.

In one embodiment, any reference signal in the first reference signal subset is identified by an SSB index or a CSI-RS resource index.

In one embodiment, any reference signal in the first reference signal subset is a periodic reference signal.

In one embodiment, any reference signal in the first reference signal subset is a periodic or semi-persistent reference signal.

In one embodiment, there is a reference signal in the first reference signal subset being a semi-persistent or aperiodic reference signal.

In one embodiment, the second reference signal subset only comprises one reference signal.

In one embodiment, the second reference signal subset comprises more than one reference signal.

In one embodiment, the second reference signal subset comprises an SSB.

In one embodiment, the second reference signal subset comprises a CSI-RS.

In one embodiment, the second reference signal subset comprises a Non-Zero-Power (NZP) CSI-RS.

In one embodiment, the second reference signal subset comprises an SRS.

In one embodiment, any reference signal in the second reference signal subset includes a CSI-RS or an SSB.

In one embodiment, any reference signal in the second reference signal subset is a Non-Zero-Power (NZP) CSI-RS or SSB.

In one embodiment, a reference signal resource occupied by any reference signal in the second reference signal subset comprises a CSI-RS resource or SSB resource.

In one embodiment, any reference signal in the second reference signal subset is identified by an SSB index or a CSI-RS resource index.

In one embodiment, any reference signal in the second reference signal subset is a periodic reference signal.

In one embodiment, any reference signal in the second reference signal subset is a periodic or semi-persistent reference signal.

In one embodiment, there is a reference signal in the second reference signal subset being a semi-persistent or aperiodic reference signal.

In one embodiment, any reference signal in the first reference signal subset does not belong to the second reference signal subset.

In one embodiment, any reference signal in the second reference signal subset does not belong to the first reference signal subset.

In one embodiment, the second reference signal subset comprises the first reference signal subset.

In one embodiment, there is a reference signal in the first reference signal subset not belonging to the second reference signal subset.

In one embodiment, there is a reference signal in the first reference signal subset belonging to the second reference signal subset.

In one embodiment, there is a reference signal in the second reference signal subset belonging to the first reference signal subset.

In one embodiment, the first signal comprises a baseband signal.

In one embodiment, the first signal comprises a radio signal.

In one embodiment, the first signal comprises a radio frequency signal.

In one embodiment, the first signal comprises a first characteristic sequence.

In one embodiment, the first characteristic sequence comprises one or more of a pseudo-random sequence, a Zadoff-Chu sequence or a low-Peak-to-Average Power Ratio (low-PAPR) sequence.

In one embodiment, the first characteristic sequence comprises Cyclic Prefix (CP).

In one embodiment, the first signal comprises a Random Access Preamble.

In one embodiment, the first signal comprises a Random Access Channel (RACH) Preamble.

In one embodiment, the first signal comprises a contention-free random access preamble.

In one embodiment, the first signal comprises a contention-free random access preamble used for a Beam Failure Recovery Request.

In one embodiment, the first signal comprises Uplink control information (UCI).

In one embodiment, the first signal comprises a Link Recovery Request (LRR).

In one embodiment, the first signal comprises a Medium Access Control layer Control Element (MAC CE).

In one embodiment, the first signal comprises a Beam Failure Recovery (BFR) MAC CE or a Truncated BFR MAC CE.

In one embodiment, the first channel bears a random access response (RAR) corresponding to a random access preamble comprised in the first signal.

In one embodiment, a channel occupied by the first signal includes a Physical Random Access CHannel (PRACH).

In one embodiment, a channel occupied by the first signal includes a Physical Uplink SharedCHannel (PUSCH).

In one embodiment, a radio resource occupied by the first signal comprises a PRACH resource.

In one embodiment, a PRACH resource occupied by the first signal implicitly indicates a position of time-frequency resources of a PUSCH occupied by the first signal.

In one embodiment, a channel occupied by the first signal includes an UpLink-Shared CHannel (UL-SCH).

In one embodiment, a PRACH resource occupied by the first signal is used to determine the first reference signal.

In one embodiment, a PRACH resource occupied by the first signal is used to indicate the first reference signal.

In one embodiment, a PRACH resource occupied by the first signal belongs to a target PRACH resource set among the M PRACH resource sets; the M PRACH resource sets respectively correspond to the M reference signals; the first reference signal is a reference signal corresponding to the target PRACH resource set among the M reference signals; any of the M PRACH resource sets comprises at least one PRACH resource.

In one embodiment, there is one PRACH resource set among the M PRACH resource sets that only comprises 1 PRACH resource.

In one embodiment, there is one PRACH resource set among the M PRACH resource sets that comprises multiple PRACH resources.

In one embodiment, the M PRACH resource sets are configured by a higher layer parameter.

In one embodiment, a higher layer parameter configuring the M PRACH resource sets comprises all or partial information in a candidateBeamRSList field of a BeamFailureRecoveryConfig Information Element (IE).

In one embodiment, relations of correspondence between the M PRACH resource sets and the M reference signals are configured by a higher layer parameter.

In one embodiment, a higher layer parameter for configuring relations of correspondence between the M PRACH resource sets and the M reference signals comprises all or partial information in a candidateBeamRSList field of a BeamFailureRecoveryConfig IE.

In one embodiment, a PRACH resource comprises a PRACH occasion.

In one embodiment, a PRACH resource comprises a random access preamble.

In one embodiment, a PRACH resource comprises a random access preamble index.

In one embodiment, a PRACH resource comprises time-frequency resources.

In one embodiment, a PRACH resource comprises code-domain resources.

In one embodiment, the code-domain resources comprise one or more of a random access preamble, a PRACH preamble, a preamble sequence, a cyclic shift, a logical root sequence, a root sequence or a Zadoff-Chu sequence.

In one embodiment, the first signal comprises a first bit field, the first bit field comprising a positive integer number of bit(s); a value of the first bit field indicates the first reference signal.

In one embodiment, when the first reference signal belongs to the first reference signal subset, a PRACH resource occupied by the first signal belongs to a first PRACH resource set; when the first reference signal belongs to the second reference signal subset, a PRACH resource occupied by the first signal belongs to a second PRACH resource set; the first PRACH resource set and the second PRACH resource set respectively comprise a positive integer number of PRACH resource(s).

In one embodiment, the first PRACH resource set only comprises one PRACH resource.

In one embodiment, the first PRACH resource set comprises multiple PRACH resources.

In one embodiment, the second PRACH resource set only comprises one PRACH resource.

In one embodiment, the second PRACH resource set comprises multiple PRACH resources.

In one embodiment, any PRACH resource in the first PRACH resource set and any PRACH resource in the second PRACH resource set occupy mutually orthogonal time-frequency resources or/and different random access (RA) preambles.

In one embodiment, the first reference signal is used to determine a spatial relation of the first signal.

In one embodiment, the spatial relation comprises a Transmission Configuration Indicator (TCI) state.

In one embodiment, the spatial relation comprises a Quasi-Co-Located (QCL) parameter.

In one embodiment, the spatial relation comprises a QCL assumption.

In one embodiment, the spatial relation comprises a spatial setting.

In one embodiment, the spatial relation comprises a spatial domain filter.

In one embodiment, the spatial relation comprises a spatial domain transmission filter.

In one embodiment, the spatial relation comprises a spatial domain receive filter.

In one embodiment, the spatial relation comprises a Spatial Tx parameter.

In one embodiment, the spatial relation comprises a Spatial Rx parameter.

In one embodiment, the spatial relation comprises large-scale properties.

In one embodiment, the large-scale properties include one or more of a delay spread, a Doppler spread, a Doppler shift, an average delay or a Spatial Rx parameter.

In one embodiment, if a reference signal is used to determine a spatial relation of a signal, the first node assumes that a transmission antenna port of the signal and the reference signal are QCL.

In one embodiment, if a reference signal is used to determine a spatial relation of a signal, the first node assumes that a transmission antenna port of the signal and the reference signal are QCL with QCL-TypeD.

In one embodiment, if a reference signal is used to determine a spatial relation of a signal, the reference signal is used to determine a spatial domain filter of the signal.

In one embodiment, if a reference signal is used to determine a spatial relation of a signal, the first node uses a same spatial domain filter for receiving the reference signal and transmitting the signal, or, the first node uses a same spatial domain filter for transmitting the reference signal and the signal.

In one embodiment, a spatial relation of the first signal is unrelated to the first reference signal.

In one embodiment, a third reference signal is used to determine a spatial relation of the first signal; the third reference signal is different from the first reference signal.

In one embodiment, the third reference signal comprises a CSI-RS or an SSB.

In one embodiment, the third reference signal and the first reference signal are non-QCL.

In one embodiment, the third reference signal and the first reference signal cannot be assumed to be QCL.

In one embodiment, if a reference signal and another reference signal correspond to different reference signal resources, the reference signal is different from the other reference signal.

In one embodiment, if a reference signal and another reference signal correspond to different reference signal identifiers, the reference signal is different from the other reference signal.

In one embodiment, a reference signal identifier of a reference signal comprises an SSB index or a CSI-RS resource index.

In one embodiment, a reference signal identifier of a reference signal comprises an SSB index or a CSI-RS resource index or an SRS resource index.

In one embodiment, for the monitoring on the first channel in the first time window, the first node assumes a QCL parameter the same as the first reference signal.

In one embodiment, the QCL parameter comprises a TCI state.

In one embodiment, the QCL parameter comprises a QCL assumption.

In one embodiment, the QCL parameter comprises a QCL relation.

In one embodiment, the QCL parameter comprises a Spatial Relation.

In one embodiment, the QCL parameter comprises a spatial domain filter.

In one embodiment, the QCL parameter comprises a spatial domain transmission filter.

In one embodiment, the QCL parameter comprises a spatial domain receive filter.

In one embodiment, the QCL parameter comprises a Spatial Tx parameter.

In one embodiment, the QCL parameter comprises a Spatial Rx parameter.

In one embodiment, the QCL parameter comprises large-scale properties.

In one embodiment, for the monitoring on the first channel in the first time window, the first node assumes a QCL parameter the same as the fourth reference signal; the fourth reference signal is different from the first reference signal.

In one embodiment, the fourth reference signal comprises a CSI-RS or an SSB.

In one embodiment, the fourth reference signal and the first reference signal are non-QCL.

In one embodiment, the fourth reference signal and the first reference signal cannot be assumed to be QCL.

In one embodiment, a PRACH resource occupied by the first signal is used to determine the fourth reference signal.

In one embodiment, a PRACH resource occupied by the first signal is used to indicate the fourth reference signal.

In one embodiment, the fourth reference signal is configured by a higher layer parameter.

In one embodiment, the fourth reference signal and the first reference signal correspond to different reference signal identifiers.

In one embodiment, if the first node assumes a same QCL parameter as a reference signal for a monitoring on a channel, the first node assumes that a transmission antenna port of the channel and the reference signal are QCL.

In one embodiment, if the first node assumes a same QCL parameter as a reference signal for a monitoring on a channel, the first node assumes that a transmission antenna port of the channel and the reference signal are QCL with QCL-TypeD.

In one embodiment, if the first node assumes a same QCL parameter as a reference signal for a monitoring on a channel, the first node assumes that a transmission antenna port of the channel and the reference signal are QCL with QCL-TypeA.

In one embodiment, if the first node assumes a same QCL parameter as a reference signal for a monitoring on a channel, the first node assumes that DeModulation Reference Signals (DMRS) of the channel and the reference signal are QCL.

In one embodiment, if the first node assumes a same QCL parameter as a reference signal for a monitoring on a channel, the reference signal is used to determine a spatial domain filter used for monitoring the channel.

In one embodiment, if the first node assumes a same QCL parameter as a reference signal for a monitoring on a channel, the first node uses a same spatial domain filter for receiving the reference signal and monitoring the channel, or, the first node uses a same spatial domain filter for transmitting the reference signal and monitoring the channel.

In one embodiment, if the first node assumes a same QCL parameter as a reference signal for a monitoring on a channel, large-scale properties of a channel over which the channel is conveyed can be inferred from large-scale properties of a channel over which the reference signal is conveyed.

In one embodiment, if the first node assumes a same QCL parameter as a reference signal for a monitoring on a channel, large-scale properties of a channel over which the DMRS of the channel is conveyed can be inferred from large-scale properties of a channel over which the reference signal is conveyed.

In one embodiment, time-domain resources occupied by the first signal are used by the first node and/or the second node to determine the first time window.

In one embodiment, the first time window is a consecutive duration.

In one embodiment, the first time window includes a ra-ResponseWindow.

In one embodiment, the first time window is a ra-ResponseWindow.

In one embodiment, the first time window comprises a time unit in which a ra-Response Window is running.

In one embodiment, the first time window comprises a time unit in which a ra-ContentionResolutionTimer is running.

In one embodiment, the first time window includes a msgB-ResponseWindow.

In one embodiment, the first time window is a msgB-ResponseWindow.

In one embodiment, the first time window comprises a time unit in which a msgB-ResponseWindow is running.

In one embodiment, the first time window comprises one or more than one time units.

In one embodiment, a unit of length of the first time window is a time unit.

In one embodiment, a number of time unit(s) comprised in the first time window is configurable.

In one embodiment, a number of time unit(s) comprised in the first time window is configured by a higher layer parameter.

In one embodiment, names of a higher layer parameter for configuring a number of time unit(s) comprised in the first time window include ra-ResponseWindow.

In one embodiment, a first time unit occupied by the first signal is used to determine a first time unit in the first time window.

In one embodiment, a last time unit occupied by the first signal is used to determine a first time unit in the first time window.

In one embodiment, a start of the first time window is later than an end time of time-domain resources occupied by the first signal.

In one embodiment, a first time unit in the first time window is a L-th time unit after a time unit occupied by the first signal, L being a positive integer.

In one embodiment, a first time unit in the first time window is a L-th time unit after a time unit to which a PRACH resource occupied by the first signal belongs, L being a positive integer.

In one embodiment, L is 1.

In one embodiment, L is configurable.

In one embodiment, a first time unit in the first time window is a time unit to which a first PDCCH occasion following an end of a PRACH resource occupied by the first signal belongs.

In one embodiment, a first time unit in the first time window is a time unit to which a PDCCH occasion for a first said target resource set following an end of a PRACH resource occupied by the first signal belongs.

In one embodiment, the first time window starts with a first PDCCH occasion following an end of a PRACH resource occupied by the first signal.

In one embodiment, the first time window starts with a PDCCH occasion for a first said target resource set following an end of a PRACH resource occupied by the first signal.

In one embodiment, a said time unit is a slot.

In one embodiment, a said time unit is a sub-slot.

In one embodiment, a said time unit is a subframe.

In one embodiment, a said time unit is a multicarrier symbol.

In one embodiment, a said time unit comprises a positive integer number of consecutive multicarrier symbols.

In one embodiment, a number of multicarrier symbol(s) comprised in a said time unit is configured by a higher-layer signaling.

In one embodiment, the first signal carries an MsgA, while the first channel bears an MsgB, the first time window being a msgB-ResponseWindow.

In one embodiment, the first signal carries an Msg1, while the first channel bears an Msg2, the first time window being a ra-Response Window.

In one embodiment, the first signal carries an Msg3, while the first channel bears an Msg4, the first time window comprising a time unit in which a ra-ContentionResolutionTimer is running.

### Embodiment 19

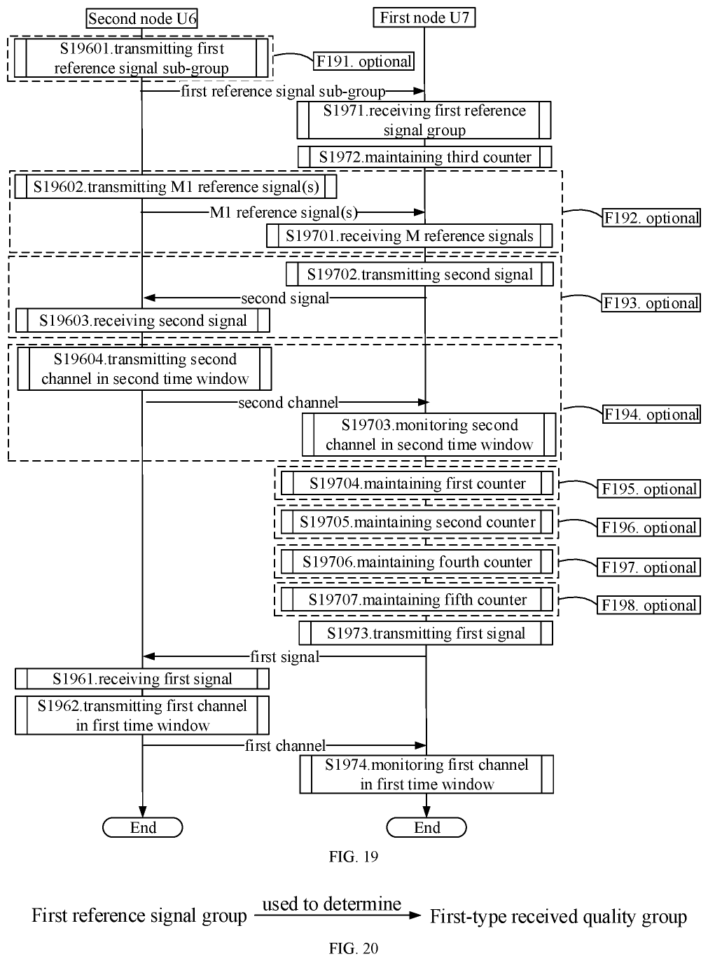

Embodiment 19 illustrates a flowchart of wireless transmission according to one embodiment of the present application, as shown in FIG. 19. In FIG. 19, a second node U6 and a first node U7 are communication nodes that transmit via an air interface. In FIG. 19, steps marked by the box F191 to the box F198 are optional, respectively.

The second node U6 transmits a first reference signal sub-group in step S19601; transmits M1 reference signal(s) in step S19602; receives a second signal in step S19603; and as a response to the action of receiving a second signal, transmits a second channel in a second time window in step S19604; receives a first signal in step S1961; and as a response to the action of receiving a first signal, transmits a first channel in a first time window in step S1962.

The first node U7 receives a first reference signal group in step S1971; maintains a third counter in step S1972; receives M reference signals in step S19701; transmits a second signal in step S19702; and as a response to the action of transmitting a second signal, monitors a second channel in a second time window in step S19703; maintains a first counter in step S19704; maintains a second counter in step S19705; maintains a fourth counter in step S19706; and maintains a fifth counter in step S19707; transmits a first signal in step S1973; and in step 1974, as a response to the action of transmitting a first signal, monitors a first channel in a first time window.

In Embodiment 19, the first reference signal group is used to determine a first-type received quality group, the first-type received quality group comprising at least one first-type received quality; the first-type received quality group is used to maintain the third counter; time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received by the first node U7 in the first time window is used by the first node U7 to determine whether a value of a first counter is incremented by 1; when the first reference signal belongs to the second reference signal subset, whether the first channel is received by the first node U7 in the first time window is used by the first node U7 to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the first node U7 is the first node in the present application.

In one embodiment, the second node U6 is the second node in the present application.

In one embodiment, an air interface between the second node U6 and the first node U7 includes a radio interface between a base station and a UE.

In one embodiment, the second node U6 is a maintenance base station for a serving cell of the transmitter of the first signal.

In one embodiment, the second node U6 is a maintenance base station for a non-serving cell of the transmitter of the first signal.

In one embodiment, the phrase of transmitting a first channel means: transmitting a DCI format in the first channel.

In one embodiment, the phrase of transmitting a first channel means: transmitting the first signaling in the first channel.

In one embodiment, the phrase of transmitting a first channel means: transmitting the first signaling in PDCCH candidate(s) occupied by the first channel.

In one embodiment, the second node U6 is a maintenance base station for a Primary Cell (PCell) of a transmitter of the first signal.

In one embodiment, the second node U6 is a maintenance base station for a Primary Secondary Cell Group Cell (PSCell) of a transmitter of the first signal.

In one embodiment, the first signal is transmitted on a PRACH.

In one embodiment, the first signal is transmitted on a Physical Uplink Shared Channel (PUSCH).

In one embodiment, the first signal is comprised of two parts, and the two parts are respectively transmitted on a PRACH and a PUSCH.

In one embodiment, the step marked by the box F191 in FIG. 19 exists, any reference signal in the first reference signal sub-group belonging to the first reference signal group.

In one embodiment, the first reference signal sub-group comprises a positive integer number of reference signal(s) in the first reference signal group.

In one embodiment, there is one reference signal in the first reference signal group that does not belong to the first reference signal sub-group.

In one embodiment, the first reference signal sub-group comprises only one reference signal in the first reference signal group.

In one embodiment, the first reference signal sub-group comprises multiple reference signals in the first reference signal group.

In one embodiment, the first reference signal sub-group is the first reference signal group.

In one embodiment, the first reference signal sub-group comprises all reference signals in the first reference signal group.

In one embodiment, steps marked by the box F192 in FIG. 19 exist, any reference signal in the first reference signal subset is one of the M reference signals, and any reference signal in the second reference signal subset is one of the M reference signals; measurements on the M reference signals are respectively used by the first node to determine M second-type received qualities; a second-type received quality corresponding to the first reference signal among the M second-type received qualities is no worse than a second reference threshold; any reference signal of the M1 reference signal(s) is one of the M reference signals.

In one embodiment, there is a reference signal in the first reference signal group that is earlier than one of M reference signals in time domain.

In one embodiment, there is a reference signal in the first reference signal group that is later than one of M reference signals in time domain.

In one embodiment, M1 is equal to 1.

In one embodiment, M1 is greater than 1.

In one embodiment, M1 is equal to M.

In one embodiment, M1 is less than M.

In one embodiment, the M1 reference signals are the M reference signals.

In one embodiment, there is one reference signal among the M reference signals that does not belong to the M1 reference signal(s).

In one embodiment, any of the M1 reference signal(s) belongs to the first reference signal subset.

In one embodiment, there is one reference signal among the M1 reference signal(s) that belongs to the first reference signal subset.

In one embodiment, any reference signal in the first reference signal subset belongs to the M1 reference signal(s).

In one embodiment, there is one reference signal in the first reference signal subset that belongs to the M1 reference signal(s).

In one embodiment, the first reference signal subset comprises the M1 reference signal(s).

In one embodiment, any of the M1 reference signal(s) belongs to the second reference signal subset.

In one embodiment, there is one reference signal among the M1 reference signal(s) that belongs to the second reference signal subset.

In one embodiment, any reference signal in the second reference signal subset belongs to the M1 reference signal(s).

In one embodiment, there is one reference signal in the second reference signal subset that belongs to the M1 reference signal(s).

In one embodiment, the second reference signal subset comprises the M1 reference signal(s).

In one embodiment, there aren't two reference signals among the M1 reference signals that belong to the first reference signal subset and the second reference signal subset respectively.

In one embodiment, there are two reference signals among the M1 reference signals that belong to the first reference signal subset and the second reference signal subset respectively.

In one embodiment, steps marked by the box F193 and the box F194 in FIG. 19 both exist, where time-domain resources occupied by the second signal are used by the first node U7 and/or the second node U6 to determine the second time window; as a response to the first condition being satisfied, the second signal is triggered; the first condition set comprises a third condition, the third condition comprising not receiving the second channel in the second time window.

In one embodiment, the second signal is transmitted on a PRACH.

In one embodiment, the second signal is transmitted on a PUSCH.

In one embodiment, the second signal is comprised of two parts, and the two parts are respectively transmitted on a PRACH and a PUSCH.

In one embodiment, the step marked by the box F195 and the step marked by the box F196 in FIG. 19 both exist.

In one embodiment, the first node maintains the first counter and the second counter simultaneously.

In one embodiment, the first node maintains the first counter and the second counter.

In one embodiment, a time duration in which the first node maintains the first counter and a time duration in which the first node maintains the second counter are overlapped.

In one embodiment, the step marked by the box F195 in FIG. 19 exists, while the step marked by the box F196 in FIG. 19 does not exist.

In one embodiment, the first node only maintains the first counter of the first counter and the second counter.

In one embodiment, the step marked by the box F195 in FIG. 19 does not exist, while the step marked by the box F196 in FIG. 19 exists.

In one embodiment, the first node only maintains the second counter of the first counter and the second counter.

In one embodiment, whether there is one condition being satisfied between a fourth condition and a fifth condition is used by the first node U7 to determine whether to transmit a random access problem indication to a higher layer; the fourth condition comprises that a value of the first counter reaches a first threshold, and the fifth condition comprises that a value of the second counter reaches a second threshold.

In one embodiment, a time at which the first counter is set to an initial value is earlier than a time at which the first signal is transmitted.

In one embodiment, a time at which the first counter is set to an initial value is later than a time at which the first signal is transmitted.

In one embodiment, a time at which the first counter is set to an initial value is earlier than a time at which the second signal is transmitted.

In one embodiment, a time at which the first counter is set to an initial value is later than a time at which the second signal is transmitted.

In one embodiment, a time at which the second counter is set to an initial value is earlier than a time at which the first signal is transmitted.

In one embodiment, a time at which the second counter is set to an initial value is later than a time at which the first signal is transmitted.

In one embodiment, a time at which the second counter is set to an initial value is earlier than a time at which the second signal is transmitted.

In one embodiment, a time at which the second counter is set to an initial value is later than a time at which the second signal is transmitted.

In one embodiment, a time at which the third counter is set to an initial value is earlier than a time at which the first counter is set to an initial value.

In one embodiment, a time at which the third counter is set to an initial value is later than a time at which the first counter is set to an initial value.

In one embodiment, a time at which the third counter is set to an initial value is earlier than a time at which the second counter is set to an initial value.

In one embodiment, a time at which the third counter is set to an initial value is later than a time at which the second counter is set to an initial value.

In one embodiment, a time at which the third counter is set to an initial value is earlier than a time at which a reference signal in the first reference signal group is transmitted.

In one embodiment, a time at which the third counter is set to an initial value is later than a time at which a reference signal in the first reference signal group is transmitted.

In one embodiment, a time at which the third counter is set to an initial value is earlier than a time at which a reference signal in the M reference signal groups is transmitted.

In one embodiment, a time at which the third counter is set to an initial value is later than a time at which a reference signal in the M reference signal groups is transmitted.

In one embodiment, the step marked by the box F197 and the step marked by the box F198 in FIG. 19 both exist.

In one embodiment, the first node maintains the fourth counter and the fifth counter simultaneously.

In one embodiment, the first node maintains the fourth counter and the fifth counter.

In one embodiment, a time duration in which the first node maintains the fourth counter and a time duration in which the first node maintains the fifth counter are overlapped.

In one embodiment, the step marked by the box F197 in FIG. 19 exists, while the step marked by the box F198 in FIG. 19 does not exist.

In one embodiment, the first node only maintains the fourth counter of the fourth counter and the fifth counter.

In one embodiment, the step marked by the box F197 in FIG. 19 does not exist, while the step marked by the box F198 in FIG. 19 exists.

In one embodiment, the first node only maintains the fifth counter of the fourth counter and the fifth counter.

In one embodiment, the first counter and the fourth counter are both set to an initial value.

In one embodiment, the second counter and the fifth counter are both set to an initial value.

In one embodiment, the value of the first counter is used by the first node U7 for maintaining the fourth counter, while the value of the second counter is used by the first node U7 for maintaining the fifth counter.

### Embodiment 20

Embodiment 20 illustrates a schematic diagram of a first reference signal group being used to determine a first-type received quality group according to one embodiment of the present application; as shown in FIG. 20. In Embodiment 20, a measurement on the first reference signal group is used to determine the first-type received quality group.

In one embodiment, a number of reference signal(s) comprised in the first reference signal group is equal to a number of first-type received quality/qualities comprised in the first-type received quality group; the reference signal(s) comprised in the first reference signal group corresponds/correspond respectively to the first-type received quality (qualities) comprised in the first-type received quality group.

In one embodiment, the first reference signal group only comprises one reference signal, and the first-type received quality group only comprises one first-type received quality, measuring the reference signal being used to determine the first-type received quality.

In one embodiment, the first reference signal group comprises S reference signals, and the first-type received quality group comprises S first-type received qualities, S being a positive integer greater than 1; measurements on the S reference signals are respectively used to determine the S first-type received qualities.

In one embodiment, for any given reference signal in the first reference signal group, measuring the given reference signal within a first time interval is used to determine a first-type received quality corresponding to the given reference signal.

In one embodiment, for any given reference signal in the first reference signal group, the first node obtains a measurement used for computing a first-type received quality corresponding to the given reference signal only according to the given reference signal received within a first time interval.

In one embodiment, the measurement includes a channel measurement.

In one embodiment, the measurement includes an interference measurement.

In one embodiment, the first time interval is a consecutive duration.

In one embodiment, a length of the first time interval is equal to TE_{valuate_BFD_SSB} ms or TE_{valuate_BFD_CSI-RS} ms.

In one embodiment, the definitions of TE_{valuate_BFD_SSB} and TE_{valuate_BFD_CSI-RS} can be found in 3GPP TS38.133.

In one embodiment, any first-type received quality in the first-type received quality group comprises a Reference Signal Received Power (RSRP).

In one embodiment, any first-type received quality in the first-type received quality group comprises a L1-RSRP.

In one embodiment, any first-type received quality in the first-type received quality group is a L1-RSRP.

In one embodiment, any first-type received quality in the first-type received quality group comprises a Signal-to-noise and interference ratio (SINR).

In one embodiment, any first-type received quality in the first-type received quality group comprises a L1-SINR.

In one embodiment, any first-type received quality in the first-type received quality group is a L1-SINR.

In one embodiment, any first-type received quality in the first-type received quality group comprises a BLock Error Rate (BLER).

In one embodiment, any first-type received quality in the first-type received quality group is a BLER.

In one embodiment, a given reference signal is a reference signal in the first reference signal group.

In one subembodiment, an RSRP or a L1-RSRP of the given reference signal is used to determine a first-type received quality corresponding to the given reference signal.

In one subembodiment, a first-type received quality that corresponds to the given reference signal is equal to an RSRP or a L1-RSRP of the given reference signal.

In one subembodiment, a SINR or a L1-SINR of the given reference signal is used to determine a first-type received quality corresponding to the given reference signal.

In one subembodiment, a first-type received quality that corresponds to the given reference signal is equal to a SINR or a L1-SINR of the given reference signal.

In one subembodiment, the given reference signal is any reference signal in the first reference signal group.

In one embodiment, any first-type received quality in the first-type received quality group is obtained by looking up in tables of an RSRP, a L1-RSRP, a SINR or a L1-SINR of a corresponding reference signal.

In one embodiment, any first-type received quality in the first-type received quality group is obtained according to hypothetical PDCCH transmission parameters.

In one embodiment, the specific definition of the hypothetical PDCCH transmission parameters can be found in 3GPP TS38.133.

### Embodiment 21

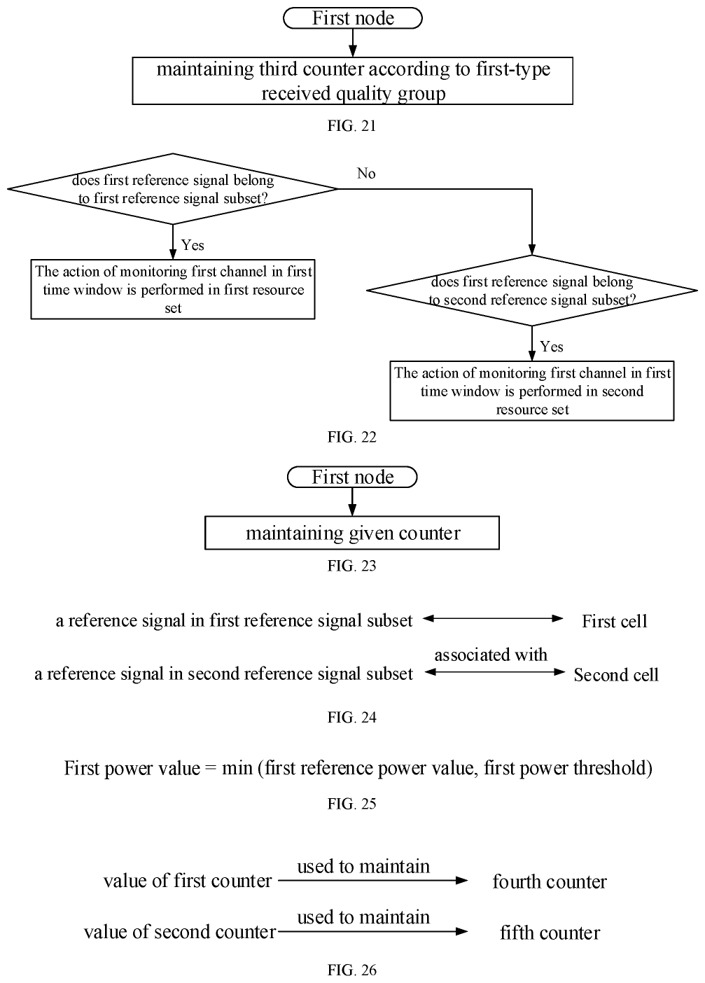

Embodiment 21 illustrates a schematic diagram of maintaining a third counter according to a first-type received quality group according to one embodiment of the present application; as shown in FIG. 21.

In one embodiment, the third counter is a BFI COUNTER.

In one embodiment, an initial value of the third counter is 0.

In one embodiment, an initial value of the third counter is a positive integer.

In one embodiment, a value of the third counter is a non-negative integer.

In one embodiment, the action of maintaining a third counter according to the first-type received quality group comprises that: the first-type received quality group is used to determine whether a value of the third counter is to be incremented by 1.

In one embodiment, the action of maintaining a third counter according to the first-type received quality group comprises that: if each first-type received quality in the first-type received quality group is poorer than a first reference threshold, the value of the third counter is incremented by 1.

In one embodiment, the action of maintaining a third counter according to the first-type received quality group comprises that: if at least one first-type received quality in the first-type received quality group is better than or equal to a first reference threshold, the value of the third counter is kept unchanged.

In one embodiment, the action of maintaining a third counter according to the first-type received quality group comprises that: if an average value of the first-type received qualities in the first-type received quality group is poorer than a first reference threshold, the value of the third counter is incremented by 1.

In one embodiment, the action of maintaining a third counter according to the first-type received quality group comprises that: if a beam failure instance indication is received from a lower layer, the value of the third counter is incremented by 1; the first-type received quality group is used by the lower layer to determine whether the beam failure instance indication is to be transmitted.

In one embodiment, if each first-type received quality in the first-type received quality group is poorer than a first reference threshold, the lower layer transmits the beam failure instance indication.

In one embodiment, if each first-type received quality in the first-type received quality group is poorer than or equal to a first reference threshold, the lower layer transmits the beam failure instance indication.

In one embodiment, if at least one first-type received quality in the first-type received quality group is better than or equal to a first reference threshold, the lower layer does not transmit the beam failure instance indication.

In one embodiment, if at least one first-type received quality in the first-type received quality group is better than a first reference threshold, the lower layer does not transmit the beam failure instance indication.

In one embodiment, if an average value of the first-type received qualities in the first-type received quality group is poorer than a first reference threshold, the lower layer transmits the beam failure instance indication.

In one embodiment, the lower layer is a physical layer.

In one embodiment, the first reference threshold is a real number.

In one embodiment, the first reference threshold is a non-negative real number.

In one embodiment, the first reference threshold is a non-negative real number no greater than 1.

In one embodiment, the first reference threshold is equal to one of Q_{out_L}, Q_{out_LR_SSB} or Q_{out_LR_CSI-RS}.

In one embodiment, for definitions of the Q_{out_LR}, Q_{out_LR_SSB} and Q_{out_LR_CSI-RS}, refer to 3GPP TS38.133.

In one embodiment, the first reference threshold is determined by a higher layer parameter rlmInSyncOutOfSyncThreshold.

In one embodiment, a number of reference thresholds comprised in a first reference threshold group is equal to the number of first-type received qualities comprised in the first-type received quality group, where all reference thresholds comprised in the first reference threshold group respectively correspond to all first-type received qualities comprised in the first-type received quality group.

In one embodiment, the action of maintaining a third counter according to the first-type received quality group comprises that: if each first-type received quality in the first-type received quality group is poorer than a corresponding reference threshold, the value of the third counter is incremented by 1.

In one embodiment, the action of maintaining a third counter according to the first-type received quality group comprises that: if at least one first-type received quality in the first-type received quality group is better than or equal to a corresponding reference threshold, the value of the third counter is kept unchanged.

In one embodiment, if each first-type received quality in the first-type received quality group is poorer than a corresponding reference threshold, the lower layer transmits the beam failure instance indication.

In one embodiment, if each first-type received quality in the first-type received quality group is poorer than or equal to a corresponding reference threshold, the lower layer transmits the beam failure instance indication.

In one embodiment, if at least one first-type received quality in the first-type received quality group is better than or equal to a corresponding reference threshold, the lower layer does not transmit the beam failure instance indication.

In one embodiment, if at least one first-type received quality in the first-type received quality group is better than a corresponding reference threshold, the lower layer does not transmit the beam failure instance indication.

In one embodiment, any reference threshold in the first reference threshold group is a real number.

In one embodiment, any reference threshold in the first reference threshold group is a non-negative real number.

In one embodiment, any reference threshold in the first reference threshold group is a non-negative real number no greater than 1.

In one embodiment, any reference threshold in the first reference threshold group is equal to one of Q_{out_L}, Q_{out_LR_SSB} or Q_{out_LR_CSI-RS}.

In one embodiment, any reference threshold in the first reference threshold group is determined by a higher layer parameter rlmInSyncOutOfSyncThreshold.

In one embodiment, there are two unequal reference thresholds in the first reference threshold group.

In one embodiment, there are two equal reference thresholds in the first reference threshold group.

In one embodiment, if a first-type received quality is one of an RSRP, a L1-RSRP, a SINR or a L1-SINR and the first-type received quality is smaller than/larger than a reference threshold; the first-type received quality is poorer than/better than the reference threshold.

In one embodiment, if a first-type received quality is a BLER and the first-type received quality is larger than/smaller than a reference threshold; the first-type received quality is poorer than/better than the reference threshold.

In one embodiment, a higher layer of the first node initializes the value of the third counter to 0.

In one embodiment, a higher layer of the first node sets the value of the third counter to an initial value.

In one embodiment, as a response to receiving a beam failure instance indication from a lower layer, a higher layer of the first node starts or restarts a first timer; when the first counter expires, the value of the third counter is cleared to 0.

In one embodiment, the first timer is a beamFailureDetectionTimer.

In one embodiment, an initial value of the first timer is a positive integer.

In one embodiment, an initial value of the first timer is a positive real number.

In one embodiment, a unit of measuring an initial value of the first timer is a Q_{out,LR} reporting periodicity of a beam failure detection RS.

In one embodiment, an initial value of the first timer is configured by a higher-layer parameter beamFailureDetectionTimer.

In one embodiment, an initial value of the first timer is configured by an IE.

In one embodiment, names of an IE for configuring an initial value of the first timer include RadioLinkMonitoring.

In one embodiment, if a random access procedure corresponding to the first signal is successfully finished, the value of the third counter is cleared to zero.

In one embodiment, if the first node receives a first PDCCH, the value of the third counter is cleared to zero; the first signal comprises a BFR MAC CE or a Truncated BFR MAC CE, and a Hybrid Automatic Repeat reQuest (HARQ) process number corresponding to the first signal is a first HARQ process number; the first PDCCH indicates a UL grant for a new transmission of the first HARQ process number, with CRC of the first PDCCH being scrambled by a C-RNTI.

In one embodiment, the third threshold is a positive integer.

In one embodiment, the third threshold is configurable.

In one embodiment, the third threshold is fixed.

In one embodiment, the third threshold is configured by a higher layer parameter.

In one embodiment, the third threshold is configured by an RRC parameter.

In one embodiment, the third threshold is configured by a physical layer signaling.

In one embodiment, names of a higher layer parameter configuring the third threshold include beamFailureInstanceMaxCount.

In one embodiment, the third threshold is equal to the value of a higher layer parameter beamFailureInstanceMaxCount.

### Embodiment 22

Embodiment 22 illustrates a schematic diagram of monitoring a first channel in a first time window according to one embodiment of the present application; as shown in FIG. 22. In Embodiment 22, when the first reference signal belongs to the first reference signal subset, the action of monitoring a first channel in a first time window is performed in a first resource set; when the first reference signal belongs to the second reference signal subset, the action of monitoring a first channel in a first time window is performed in a second resource set.

In one embodiment, when the first reference signal belongs to the first reference signal subset, the target resource set is the first resource set; when the first reference signal belongs to the second reference signal subset, the target resource set is the second resource set.

In one embodiment, the first resource set comprises a search space set.

In one embodiment, the first resource set is a search space set.

In one embodiment, the first resource set comprises one or more PDCCH candidates.

In one embodiment, the first resource set comprises all or partial PDCCH candidates in a search space set.

In one embodiment, the first resource set comprises a COntrol REsource SET (CORESET).

In one embodiment, the first resource set is a CORESET.

In one embodiment, a search space set to which the first resource set belongs is identified by a recoverySearchSpaceId.

In one embodiment, a search space set to which the first resource set belongs is configured by a higher layer parameter ra-SearchSpace.

In one embodiment, a search space set to which the first resource set belongs is identified by a SearchSpaceId different from a recoverySearchSpaceId.

In one embodiment, the first resource set comprises a positive integer number of Physical Resource Block(s) (PRB(s)) in frequency domain.

In one embodiment, the first resource set comprises a positive integer number of multicarrier symbol(s) in time domain.

In one embodiment, the second resource set comprises a search space set.

In one embodiment, the second resource set is a search space set.

In one embodiment, the second resource set comprises one or more PDCCH candidates.

In one embodiment, the second resource set comprises all or partial PDCCH candidates in a search space set.

In one embodiment, the second resource set comprises a CORESET.

In one embodiment, the second resource set is a CORESET.

In one embodiment, a search space set to which the second resource set belongs is identified by a recoverySearchSpaceId.

In one embodiment, a search space set to which the second resource set belongs is identified by a SearchSpaceId different from a recoverySearchSpaceId.

In one embodiment, a search space set to which the second resource set belongs is configured by a higher layer parameter ra-SearchSpace.

In one embodiment, the second resource set comprises a positive integer number of PRB(s) in frequency domain.

In one embodiment, the second resource set comprises a positive integer number of multicarrier symbol(s) in time domain.

In one embodiment, the first resource set and the second resource set respectively belong to different search space sets.

In one embodiment, the first resource set and the second resource set are respectively associated with different CORESETs.

In one embodiment, the first resource set and the second resource set respectively correspond to different SearchSpaceIds.

In one embodiment, the first resource set and the second resource set respectively correspond to different ControlResourceSetIds.

### Embodiment 23

Embodiment 23 illustrates a schematic diagram of maintaining a given counter according to one embodiment of the present application; as shown in FIG. 23. In Embodiment 23, the given counter is the first counter or the second counter.

In one embodiment, the given counter is the first counter.

In one embodiment, the given counter is the second counter.

In one embodiment, the first counter is a PREAMBLE_TRANSMISSION_COUNTER.

In one embodiment, an initial value of the first counter is 0.

In one embodiment, an initial value of the first counter is 1.

In one embodiment, an initial value of the first counter is a positive integer.

In one embodiment, the second counter is a PREAMBLE_TRANSMISSION_COUNTER.

In one embodiment, an initial value of the second counter is 0.

In one embodiment, an initial value of the second counter is 1.

In one embodiment, an initial value of the second counter is a positive integer.

In one embodiment, a value of the given counter is a non-negative integer.

In one embodiment, a value of the given counter is a positive integer.

In one embodiment, the action of maintaining the given counter comprises: when a Random Access Procedure is started, setting the value of the given counter to an initial value.

In one embodiment, if a reference signal indicated by a random access preamble corresponding to the Random Access Procedure belongs to the first reference signal subset, the given counter is the first counter; if a reference signal indicated by a random access preamble corresponding to the Random Access Procedure belongs to the second reference signal subset, the given counter is the second counter.

In one embodiment, if a PRACH resource occupied by a random access preamble corresponding to the Random Access Procedure belongs to the first PRACH resource set, the given counter is the first counter; if a PRACH resource occupied by a random access preamble corresponding to the Random Access Procedure belongs to the second PRACH resource set, the given counter is the second counter.

In one embodiment, as a response to the random access procedure being started, a random access preamble is triggered.

In one embodiment, as a response to a random access preamble being triggered, the random access procedure is started.

In one embodiment, as a response to the first signal being triggered, the random access procedure is started.

In one embodiment, as a response to the random access procedure being started, the first signal is triggered.

In one embodiment, the first signal comprises a random access preamble that belongs to the random access procedure.

In one embodiment, the action of maintaining the given counter comprises: incrementing the value of the given counter by 1, provided that a random access preamble is transmitted and a random access procedure to which the random access preamble belongs is not determined to be successful.

In one embodiment, the action of maintaining the given counter comprises: incrementing the value of the given counter by 1, provided that a random access preamble is transmitted and a random access response corresponding to the random access preamble is determined to be unsuccessful.

In one embodiment, the action of maintaining the given counter comprises: keeping the value of the given counter unchanged, provided that a random access preamble is transmitted and a random access procedure to which the random access preamble belongs is determined to be successful.

In one embodiment, the action of maintaining the given counter comprises: keeping the value of the given counter unchanged, provided that a random access preamble is transmitted and a random access response corresponding to the random access preamble is determined to be successful.

In one embodiment, the action of maintaining the given counter comprises: incrementing the value of the given counter by 1, provided that a random access preamble is transmitted and contention resolution corresponding to the random access preamble is not determined to be successful.

In one embodiment, the action of maintaining the given counter comprises: keeping the value of the given counter unchanged, provided that a random access preamble is transmitted and contention resolution corresponding to the random access preamble is determined to be successful.

In one embodiment, if a reference signal indicated by the random access preamble belongs to the first reference signal subset, the given counter is the first counter; if a reference signal indicated by the random access preamble belongs to the second reference signal subset, the given counter is the second counter.

In one embodiment, if a PRACH resource occupied by the random access preamble belongs to the first PRACH resource set, the given counter is the first counter; if a PRACH resource occupied by the random access preamble belongs to the second PRACH resource set, the given counter is the second counter.

In one embodiment, whether the first channel is received in the first time window is used to maintain the given counter.

In one embodiment, whether the first channel is received in the first time window is used to determine whether the value of the given counter is incremented by 1.

In one embodiment, the action of maintaining the given counter comprises: if the first channel is received in the first time window, a value of the given counter keeping unchanged.

In one embodiment, the action of maintaining the given counter comprises: if the first channel is not received in the first time window, a value of the given counter being incremented by 1.

In one embodiment, if the first reference signal belongs to the first reference signal subset, the given counter is the first counter; if the first reference signal belongs to the second reference signal subset, the given counter is the second counter.

In one embodiment, the first counter and the second counter respectively correspond to two different random access procedures.

In one embodiment, a MAC entity of the first node maintains the two different random access procedures simultaneously.

In one embodiment, a random access procedure corresponds to a UE variable group; a UE variable group comprises more than one UE variable.

In one embodiment, a UE variable group comprises part or all of variables PREAMBLE INDEX, PREAMBLE_TRANSMISSION_COUNTER, PREAMBLE_POWER_RAMPING_COUNTER, PREAMBLE_POWER_RAMPING_STEP, PREAMBLE_RECEIVED_TARGET_POWER, PREAMBLE_BACKOFF, PCMAX, SCALING_FACTOR_BI, TEMPORARY_C-RNTI, RA_TYPE, POWER_OFFSET_2STEP_RA, or MSGA_PREAMBLE_POWER_RAMPING_STEP.

In one embodiment, different random access procedures correspond to different UE variable groups.

In one embodiment, different random access procedures do not share variables in respective UE variable groups.

In one embodiment, the first counter and the second counter are respectively UE variables comprised in UE variable groups corresponding to the two different random access procedures.

In one embodiment, when any one of the two different random access procedures is determined to be successful, the other of the two different random access procedures is also determined to be successful.

In one embodiment, the two different random access procedures respectively correspond to two timers, when any given random access procedure in the two different random access procedures is started, a corresponding timer is started.

In one embodiment, when both the two timers are expired, the random access problem indication is transmitted to a higher layer.

In one embodiment, when at least one of the two timers is expired, the random access problem indication is transmitted to a higher layer.

In one embodiment, an initial value of any one of the two timers is configured by a higher layer parameter.

In one embodiment, names of a higher layer parameter for configuring an initial value of one of the two timers include beamFailureRecoveryTimer.

In one embodiment, names of a higher layer parameter for configuring an initial value of any of the two timers include beamFailureRecoveryTimer.

In one embodiment, when any random access procedure of the two different random access procedures is determined to be successful, a corresponding timer is stopped.

In one embodiment, initial values of the two timers are the same.

In one embodiment, initial values of the two timers are different.

In one embodiment, when the first condition is satisfied, a value of the given counter is set to an initial value.

In one embodiment, whether the first condition is satisfied is used to determine whether the random access procedure is started.

In one embodiment, as a response to the first condition being satisfied, the random access procedure is started.

In one embodiment, if the first condition is not satisfied, no random access procedure is started.

In one embodiment, as a response to the first condition being satisfied, a random access preamble is triggered.

In one embodiment, if the first condition is not satisfied, no random access preamble is triggered.

In one embodiment, if an Msg2 triggered by a random access preamble is correctly received, a random access procedure to which the random access preamble belongs is determined to be successful.

In one embodiment, if a PDCCH transmission identified by a C-RNTI indicated by an MsgA associated with a random access preamble is correctly received, a random access procedure to which the random access preamble belongs is determined to be successful.

In one embodiment, if a PDCCH transmission identified by a C-RNTI indicated by an Msg3 associated with a random access preamble is correctly received, a random access procedure to which the random access preamble belongs is determined to be successful.

In one embodiment, if an Msg4 associated with a random access preamble is correctly received, a random access procedure to which the random access preamble belongs is determined to be successful.

In one embodiment, if a PDCCH transmission identified by a temporary-C-RNTI triggered by an Msg3 associated with a random access preamble is correctly received and a MAC Protocol Data Unit (PDU) scheduled by the PDCCH transmission comprises a UE contention resolution identifier matching with a Common Control Channel (CCCH) Service Data Unit (SDU) indicated by the Msg3 associated with the random access preamble, a random access procedure to which the random access preamble belongs is determined to be successful.

In one embodiment, if a PDCCH transmission identified by a C-RNTI triggered by a random access preamble is correctly received, a random access procedure to which the random access preamble belongs is determined to be successful.

In one embodiment, if a PDCCH transmission identified by a C-RNTI indicated by an MsgA or Msg3 associated with the random access preamble that is triggered by a random access preamble is correctly received, a random access procedure to which the random access preamble belongs is determined to be successful.

In one embodiment, if a random access response (RAR) triggered by a random access preamble is correctly received, a random access procedure to which the random access preamble belongs is determined to be successful.

In one embodiment, if a random access response (RAR) triggered by a random access preamble is correctly received and the RAR comprises a random access preamble identifier for the random access preamble, a random access procedure to which the random access preamble belongs is determined to be successful.

In one embodiment, if a random access response (RAR) triggered by a random access preamble is correctly received and the RAR comprises a MAC subPDU with only a RAPID, a random access procedure to which the random access preamble belongs is determined to be successful.

In one embodiment, if the first node receives the first channel in the first time window, a random access procedure to which a random access preamble comprised in the first signal belongs is determined to be successful.

In one embodiment, if the random access procedure is determined to be successful, a value of the third counter is cleared to zero.

In one embodiment, if a random access procedure to which a random access preamble comprised in the first signal belongs is determined to be successful, a value of the third counter is cleared to zero.

In one embodiment, whether the first channel is received in the first time window is used to determine whether the value of the third counter is cleared to zero.

In one embodiment, if the first node receives the first channel in the first time window, a value of the third counter is cleared to zero.

In one embodiment, if any random access procedure of the two different random access procedures is determined to be successful, a value of the third counter is cleared to zero.

In one embodiment, when and only when the two different random access procedures are both determined to be successful, a value of the third counter is cleared to zero.

In one embodiment, when the random access procedure is initiated, a second timer is started; when the second timer is expired, the random access problem indication is transmitted to a higher layer.

In one embodiment, the second timer is a beamFailureRecoveryTimer.

In one embodiment, an initial value of the second timer is configured by a higher layer parameter.

In one embodiment, names of a higher layer parameter for configuring an initial value of the second timer include beamFailureRecoveryTimer.

In one embodiment, when the random access procedure is determined to be successful, the second timer is stopped.

In one embodiment, the first threshold is a positive integer.

In one embodiment, the first threshold is configurable.

In one embodiment, the first threshold is fixed.

In one embodiment, the first threshold is configured by a higher layer parameter.

In one embodiment, names of a higher layer parameter for configuring the first threshold include preambleTransMax.

In one embodiment, the first threshold is configured by an RRC parameter.

In one embodiment, the first threshold is configured by a physical layer signaling.

In one embodiment, the first threshold is equal to preambleTransMax+1.

In one embodiment, the first threshold is equal to preambleTransMax.

In one embodiment, the second threshold is a positive integer.

In one embodiment, the second threshold is configurable.

In one embodiment, the second threshold is fixed.

In one embodiment, the second threshold is configured by a higher layer parameter.

In one embodiment, names of a higher layer parameter for configuring the second threshold include preambleTransMax.

In one embodiment, the second threshold is configured by an RRC parameter.

In one embodiment, the second threshold is configured by a physical layer signaling.

In one embodiment, the second threshold is equal to preambleTransMax+1.

In one embodiment, the second threshold is equal to preambleTransMax.

In one embodiment, the first threshold is equal to the second threshold.

In one embodiment, the first threshold is unequal to the second threshold.

In one embodiment, when a value of the first counter reaches the first threshold or when a value of the second counter reaches the second threshold, the random access problem indication is transmitted to a higher layer.

In one embodiment, when a value of the first counter reaches the first threshold and a value of the second counter reaches the second threshold, the random access problem indication is transmitted to a higher layer.

In one embodiment, when and only when a value of the first counter reaches the first threshold and a value of the second counter reaches the second threshold, the random access problem indication is transmitted to a higher layer.

In one embodiment, when a value of the first counter reaches the first threshold and a value of the second counter hasn't reached the second threshold yet, the random access problem indication transmitted to a higher layer is used to indicate the first cell.

In one embodiment, when a value of the first counter hasn't reached the first threshold yet and a value of the second counter reaches the second threshold, the random access problem indication transmitted to a higher layer is used to indicate the second cell.

### Embodiment 24

Embodiment 24 illustrates a schematic diagram illustrating that there is a reference signal in a first reference signal subset being associated with a first cell, and there is a reference signal in a second reference signal subset being associated with a second cell according to one embodiment of the present application; as shown in FIG. 24. In Embodiment 24, the given cell is the first cell or the second cell.

In one embodiment, the sentence that a reference signal is associated with the given cell means that: a Physical Cell Identity (PCI) of the given cell is used for generating the reference signal.

In one embodiment, the sentence that a reference signal is associated with the given cell means that: the reference signal is QCL with an SSB of the given cell.

In one embodiment, the sentence that a reference signal is associated with the given cell means that: the reference signal is transmitted by the given cell.

In one embodiment, the sentence that a reference signal is associated with the given cell means that: a radio resource occupied by the reference signal is indicated by a configuration signaling, and a Radio Link Control (RLC) Bearer through which the configuration signaling is conveyed is configured via a CellGroupConfig IE, where a Special cell (Spcell) configured by the CellGroupConfig IE includes the given cell.

In one embodiment, the configuration signaling comprises an RRC signaling.

In one embodiment, the radio resource comprises a time-frequency resource.

In one embodiment, the radio resource comprises an RS sequence.

In one embodiment, the radio resource comprises a code-domain resource.

In one embodiment, the code-domain resource comprises one or more of a pseudo-random sequence, a low-PAPR sequence, a cyclic shift, an Orthogonal Cover Code (OCC), an orthogonal sequence, a frequency-domain orthogonal sequence or a time-domain orthogonal sequence.

In one embodiment, any reference signal in the first reference signal subset is associated with the first cell.

In one embodiment, there is a reference signal in the first reference signal subset being associated with the second cell.

In one embodiment, there is a reference signal in the first reference signal subset being associated with a cell different from the first cell.

In one embodiment, any reference signal in the first reference signal subset is associated with a serving cell of the first node.

In one embodiment, there is a reference signal in the first reference signal subset being associated with a non-serving cell of the first node.

In one embodiment, the non-serving cell in the present application can be used for transmitting data.

In one embodiment, the non-serving cell in the present application refers to a cell available as a candidate for receiving and transmitting data.

In one embodiment, any reference signal in the second reference signal subset is associated with the second cell.

In one embodiment, there is a reference signal in the second reference signal subset being associated with the first cell.

In one embodiment, any reference signal in the second reference signal subset is associated with the first cell or the second cell.

In one embodiment, there is a reference signal in the second reference signal subset being associated with a cell different from the first cell and the second cell.

In one embodiment, there is a reference signal in the second reference signal subset being associated with a non-serving cell of the first node.

In one embodiment, any reference signal in the second reference signal subset is associated with a non-serving cell of the first node.

In one embodiment, there is a reference signal in the second reference signal subset being associated with a serving cell of the first node.

In one embodiment, any reference signal in the second reference signal subset is associated with a serving cell of the first node.

In one embodiment, the first cell is different from the second cell.

In one embodiment, the first cell and the second cell are respectively identified by a first index and a second index, where the first index is different from the second index.

In one embodiment, the first cell corresponds to a different PCI from the second cell.

In one embodiment, a maintenance base station for the first cell is different from a maintenance base station for the second cell.

In one embodiment, a maintenance base station for the first cell is the same as a maintenance base station for the second cell.

In one embodiment, the first cell and the second cell are respectively a Primary Cell (Pcell) and a Primary Secondary Cell (PScell) Group Cell of the first node.

In one embodiment, the first cell and the second cell respectively belong to a Master Cell Group (MCG) and a Secondary Cell Group (SCG) of the first node.

In one embodiment, the first cell and the second cell respectively belong to two different Cell Groups (CGs) of the first node.

In one embodiment, the first cell and the second cell belong to a same CG of the first node.

In one embodiment, a frequency-domain resource occupied by the first cell and a frequency-domain resource occupied by the second cell are overlapping.

In one embodiment, a frequency-domain resource occupied by the first cell and a frequency-domain resource occupied by the second cell are mutually orthogonal.

In one embodiment, the first cell is a serving cell of the first node.

In one embodiment, the second cell is a non-serving cell of the first node.

In one embodiment, the second cell is a serving cell of the first node.

In one embodiment, the sentence that the given cell is a non-serving cell of the first node means that: the first node does not perform SCell addition for the given cell.

In one embodiment, the sentence that the given cell is a non-serving cell of the first node means that: a latest sCellToAddModList received by the first node does not comprise the given cell.

In one embodiment, the sentence that the given cell is a non-serving cell of the first node means that: neither of a latest sCellToAddModList and a latest sCellToAddModListSCG received by the first node comprises the given cell.

In one embodiment, the sentence that the given cell is a non-serving cell of the first node means that: the first node is not assigned with an SCellIndex for the given cell.

In one embodiment, the SCellIndex is a positive integer no greater than 31.

In one embodiment, the sentence that the given cell is a non-serving cell of the first node means that: the first node is not assigned with a ServCellIndex for the given cell.

In one embodiment, the ServCellIndex is a positive integer no greater than 31.

In one embodiment, the sentence that the given cell is a non-serving cell of the first node means that: the given cell is not a PCell of the first node.

In one embodiment, the sentence that the given cell is a non-serving cell of the first node means that: no RRC connection is established between the first node and the given cell.

In one embodiment, the sentence that the given cell is a non-serving cell of the first node means that: the C-RNTI of the first node is not assigned by the given cell.

In one embodiment, the sentence that the given cell is a serving cell of the first node means that: the first node performs SCell addition for the given cell.

In one embodiment, the sentence that the given cell is a serving cell of the first node means that: a latest sCellToAddModList received by the first node comprises the given cell.

In one embodiment, the sentence that the given cell is a serving cell of the first node means that: a latest sCellToAddModList or a latest sCellToAddModListSCG received by the first node comprises the given cell.

In one embodiment, the sentence that the given cell is a serving cell of the first node means that: the first node is assigned with an SCellIndex for the given cell.

In one embodiment, the sentence that the given cell is a serving cell of the first node means that: the first node is assigned with a ServCellIndex for the given cell.

In one embodiment, the sentence that the given cell is a serving cell of the first node means that: an RRC connection has been established between the first node and the given cell.

In one embodiment, the sentence that the given cell is a serving cell of the first node means that: the C-RNTI of the first node is assigned by the given cell.

In one embodiment, both the first cell and the second cell keep RRC connection with the first node.

In one embodiment, of the first cell and the second cell only the first cell keeps RRC connection with the first node.

In one embodiment, the second node is a maintenance base station for the first cell.

In one embodiment, the second node is a maintenance base station for the second cell.

In one embodiment, the second node is a maintenance base station for the first cell as well as a maintenance base station for the second cell.

In one embodiment, the second node is not a maintenance base station for the first cell.

In one embodiment, the second node is not a maintenance base station for the second cell.

### Embodiment 25

Embodiment 25 illustrates a schematic diagram of a first power value according to one embodiment of the present application; as shown in FIG. 25. In Embodiment 25, the first power value is a smallest value between a first reference power value and a first power threshold; the first reference power value is linear with a first target power value, where a linear coefficient between the first reference power value and the first target power value is equal to 1.

In one embodiment, if the first reference signal belongs to the first reference signal subset, a value of the fourth counter is used by the first node to determine the first power value; if the first reference signal belongs to the second reference signal subset, a value of the fifth counter is used by the first node to determine the first power value.

In one embodiment, the first power value is measured in Watts.

In one embodiment, the first power value is measured in dBm.

In one embodiment, the first power threshold is measured in Watts.

In one embodiment, the first power threshold is measured in dBm.

In one embodiment, the first power threshold is a maximum output power configured by the first node.

In one embodiment, the first power threshold is a maximum power for the first node in the uplink.

In one embodiment, the first reference power value is measured in Watts.

In one embodiment, the first reference power value is measured in dBm.

In one embodiment, the first target power value is measured in Watts.

In one embodiment, the first target power value is measured in dBm.

In one embodiment, the first target power value is linear with a first component, where a linear coefficient between the first target power value and the first component is equal to 1; when the first reference signal belongs to the first reference signal subset, the first component is equal to a product of a value of the fourth counter minus 1 being multiplied by a first step-size; when the first reference signal belongs to the second reference signal subset, the first component is equal to a product of a value of the fifth counter minus 1 being multiplied by a second step-size;

the first step-size and the second step-size are positive real numbers, respectively.

In one embodiment, the first component is equal to 0.

In one embodiment, the first component is greater than 0.

In one embodiment, the first step-size is configured by a higher layer parameter.

In one embodiment, names of a higher layer parameter configuring the first step-size include powerRampingStep.

In one embodiment, the first step-size is equal to a value of a first higher-layer parameter, and names of the first higher-layer parameter include powerRampingStep.

In one embodiment, the first step-size is equal to PREAMBLE_POWER_RAMPING_STEP.

In one embodiment, the second step-size is configured by a higher layer parameter.

In one embodiment, names of a higher layer parameter configuring the second step-size include powerRampingStep.

In one embodiment, the second step-size is equal to a value of a second higher-layer parameter, and names of the second higher-layer parameter include powerRampingStep.

In one embodiment, the second step-size is equal to PREAMBLE_POWER_RAMPING_STEP.

In one embodiment, the first step-size is the second step-size.

In one embodiment, the first step-size is equal to the second step-size.

In one embodiment, the first step-size is unequal to the second step-size.

In one embodiment, the first step-size and the second step-size are respectively UE variables comprised in UE variable groups corresponding to the two different random access procedures.

In one embodiment, the first target power value is linear with a second component, where a linear coefficient between the first target power value and the second component is equal to 1; the second component is a random access preamble power.

In one embodiment, the second component is configured by a higher layer parameter.

In one embodiment, names of a higher layer parameter configuring the second component include preambleReceivedTargetPower.

In one embodiment, a value of the second component is related to the first reference signal.

In one embodiment, if the first reference signal belongs to the first reference signal subset, a value of the second component is equal to a first parameter; if the first reference signal belongs to the second reference signal subset, a value of the second component is equal to a second parameter; the first parameter and the second parameter are higher-layer parameters, respectively.

In one embodiment, names of both the first parameter and the second parameter include preambleReceivedTargetPower.

In one embodiment, the first parameter is equal to the second parameter.

In one embodiment, the first parameter is unequal to the second parameter.

In one embodiment, the first parameter and the second parameter are respectively UE variables comprised in UE variable groups corresponding to the two different random access procedures.

In one embodiment, the first target power value is linear with a third component, where a linear coefficient between the first target power value and the third component is equal to 1; the third component is a random access preamble power offset.

In one embodiment, a value of the third component is related to a format of a random access preamble comprised in the first signal.

In one embodiment, the first reference power value is linear with a first pathloss value, with a linear coefficient between the first reference power value and the first pathloss value being 1.

In one embodiment, the first pathloss value is measured in dB.

In one embodiment, the first pathloss value is equal to a transmit power of the first reference signal being subtracted by an RSRP of the first reference signal.

In one embodiment, the first pathloss value is equal to a transmit power of a third reference signal being subtracted by an RSRP of the third reference signal.

In one embodiment, if the first reference signal belongs to the first reference signal subset, the first power value is unrelated to a value of the fourth counter.

In one embodiment, if the first reference signal belongs to the second reference signal subset, the first power value is unrelated to a value of the fifth counter.

In one embodiment, the first reference signal is used to determine the first power value is related to a value of which one of the fourth counter and the fifth counter.

In one embodiment, the first reference signal subset corresponds to the fourth counter, while the second reference signal subset corresponds to the fifth counter.

In one embodiment, the first counter corresponds to the fourth counter, while the second counter corresponds to the fifth counter.

In one embodiment, the first counter and the fourth counter correspond to a same random access procedure.

In one embodiment, the first counter and the fourth counter are respectively two UE variables comprised in a UE variable group corresponding to a same random access procedure.

In one embodiment, the second counter and the fifth counter correspond to a same random access procedure.

In one embodiment, the second counter and the fifth counter are respectively two UE variables comprised in a UE variable group corresponding to a same random access procedure.

### Embodiment 26

Embodiment 26 illustrates a schematic diagram of relations among a first counter, a second counter, a fourth counter and a fifth counter according to one embodiment of the present application; as shown in FIG. 26. In Embodiment 26, a value of the first counter is used to maintain the fourth counter, while a value of the second counter is used to maintain the fifth counter.

In one embodiment, the fourth counter is a PREAMBLE_POWER_RAMPING_COUNTER.

In one embodiment, an initial value of the fourth counter equals 1.

In one embodiment, when a random access procedure is started, the value of the fourth counter is set to an initial value.

In one embodiment, when a random access procedure is started and a reference signal indicated by a random access preamble corresponding to the random access procedure belongs to the first reference signal subset, the value of the fourth counter is set to an initial value.

In one embodiment, when a random access procedure is started and a PRACH resource occupied by a random access preamble corresponding to the random access procedure belongs to the first PRACH resource set, the value of the fourth counter is set to an initial value.

In one embodiment, when a random access procedure corresponding to the first counter is started, the value of the fourth counter is set to an initial value.

In one embodiment, the fifth counter is a PREAMBLE_POWER_RAMPING_COUNTER.

In one embodiment, an initial value of the fifth counter equals 1.

In one embodiment, when a random access procedure is started, the value of the fifth counter is set to an initial value.

In one embodiment, when a random access procedure is started and a reference signal indicated by a random access preamble corresponding to the random access procedure belongs to the second reference signal subset, the value of the fifth counter is set to an initial value.

In one embodiment, when a random access procedure is started and a PRACH resource occupied by a random access preamble corresponding to the random access procedure belongs to the second PRACH resource set, the value of the fifth counter is set to an initial value.

In one embodiment, when a random access procedure corresponding to the second counter is started, the value of the fifth counter is set to an initial value.

In one embodiment, a value of the first counter is used to determine a value of the fourth counter.

In one embodiment, if a value of the first counter is greater than 1, a value of the fourth counter is incremented by 1.

In one embodiment, if a value of the first counter is greater than 1 and the first reference signal belongs to the first reference signal subset, a value of the fourth counter is incremented by 1.

In one embodiment, if a value of the first counter is greater than 1 and the first reference signal belongs to the first reference signal subset, and the first reference signal and the second reference signal are a same reference signal, a value of the fourth counter is incremented by 1; the second reference signal is a last one reference signal before the first signal which is indicated by a random access preamble by which each reference signal indicated belongs to the first reference signal subset.

In one embodiment, the sentence that a value of the fourth counter is incremented by 1 means: the value of the fourth counter being incremented by 1 before the first signal is transmitted.

In one embodiment, if a value of the first counter is no greater than 1, a value of the fourth counter is kept unchanged.

In one embodiment, if the first reference signal belongs to the second reference signal subset, the value of the fourth counter keeps unchanged.

In one embodiment, if the first reference signal is different from the second reference signal, the value of the fourth counter keeps unchanged.

In one embodiment, a value of the second counter is used to determine a value of the fifth counter.

In one embodiment, if a value of the second counter is greater than 1, a value of the fifth counter is incremented by 1.

In one embodiment, if a value of the second counter is greater than 1 and the first reference signal belongs to the second reference signal subset, a value of the fifth counter is incremented by 1.

In one embodiment, if a value of the first counter is greater than 1 and the first reference signal belongs to the second reference signal subset, and the first reference signal and the fifth reference signal are a same reference signal, a value of the fifth counter is incremented by 1; the fifth reference signal is a last one reference signal before the first signal which is indicated by a random access preamble by which each reference signal indicated belongs to the second reference signal subset.

In one embodiment, the sentence that a value of the fifth counter is incremented by 1 means: the value of the fifth counter being incremented by 1 before the first signal is transmitted.

In one embodiment, if a value of the second counter is no greater than 1, a value of the fifth counter is kept unchanged.

In one embodiment, if the first reference signal belongs to the first reference signal subset, the value of the fifth counter keeps unchanged.

In one embodiment, if the first reference signal is different from the fifth reference signal, the value of the fifth counter keeps unchanged.

In one embodiment, if a reference signal and another reference signal correspond to a same reference signal resource, the reference signal and the other reference signal are the same reference signal.

In one embodiment, if a reference signal and another reference signal correspond to a same reference signal identifier, the reference signal and the other reference signal are the same reference signal.

### Embodiment 27

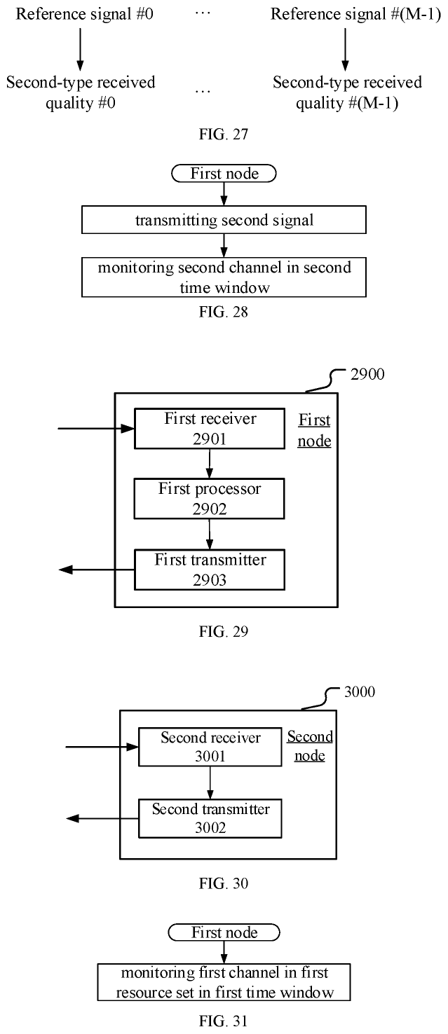

Embodiment 27 illustrates a schematic diagram of M reference signals and M second-type received qualities according to one embodiment of the present application; as shown in FIG. 27. In Embodiment 27, measurements on the M reference signals are respectively used to determine the M second-type received qualities; a second-type received quality corresponding to the first reference signal among the M second-type received qualities is no worse than the second reference threshold. In FIG. 27, indexes of the M reference signals and the M second-type received qualities are respectively #0 . . . , and #(M−1).

In one embodiment, the first reference signal subset only comprises one reference signal among the M reference signals.

In one embodiment, the first reference signal subset comprises multiple reference signals among the M reference signals.

In one embodiment, there is one reference signal among the M reference signals that does not belong to the first reference signal subset.

In one embodiment, the first reference signal subset comprises the M reference signals.

In one embodiment, the second reference signal subset only comprises one reference signal among the M reference signals.

In one embodiment, the second reference signal subset comprises multiple reference signals among the M reference signals.

In one embodiment, there is one reference signal among the M reference signals that does not belong to the second reference signal subset.

In one embodiment, the second reference signal subset comprises the M reference signals.

In one embodiment, the M reference signals consist of the first reference signal subset and the second reference signal subset.

In one embodiment, there isn't any reference signal among the M reference signals that belongs to the first reference signal subset and the second reference signal subset simultaneously.

In one embodiment, there is a reference signal among the M reference signals that belongs to the first reference signal subset and the second reference signal subset simultaneously.

In one embodiment, any reference signal among the M reference signals belongs to at least one of the first reference signal subset or the second reference signal subset.

In one embodiment, any of the M reference signals comprises a CSI-RS or an SSB.

In one embodiment, a reference signal resource occupied by any reference signal among the M reference signals comprises a CSI-RS resource or SSB resource.

In one embodiment, for any given reference signal among the M reference signals, measuring the given reference signal within a second time interval is used to determine a second-type received quality corresponding to the given reference signal.

In one embodiment, for any given reference signal among the M reference signals, the first node obtains a measurement used for computing a second-type received quality corresponding to the given reference signal only according to the given reference signal received within a second time interval.

In one embodiment, the second time interval is a consecutive duration.

In one embodiment, a length of the second time interval is equal to TE_{valuate_CBD_SSB} ms or TE_{valuate_CBD_CSI-RS} ms.

In one embodiment, the definition of TE_{valuate_CBD_SSB} or TE_{valuate_CBD_CSI-RS} can be found in 3GPPTS38.133.

In one embodiment, any second-type received quality among the M second-type received qualities is an RSRP.

In one embodiment, any second-type received quality among the M second-type received qualities is a L1-RSRP.

In one embodiment, any second-type received quality among the M second-type received qualities is a SINR.

In one embodiment, any second-type received quality among the M second-type received qualities is a L1-SINR.

In one embodiment, any second-type received quality among the M second-type received qualities is a BLER.

In one embodiment, if a second-type received quality is one of an RSRP, a L1-RSRP, a SINR or a L1-SINR and the second-type received quality is larger than or equal to a reference threshold, the second-type received quality is no poorer than the reference threshold.

In one embodiment, if a second-type received quality is a BLER and the second-type received quality is smaller than or equal to a reference threshold, the second-type received quality is no poorer than the reference threshold.

In one embodiment, a given reference signal is a reference signal among the M reference signals.

In one subembodiment, an RSRP or a L1-RSRP of the given reference signal is used to determine a second-type received quality corresponding to the given reference signal.

In one subembodiment, a second-type received quality that corresponds to the given reference signal is equal to an RSRP or a L1-RSRP of the given reference signal.

In one subembodiment, a second-type received quality that corresponds to the given reference signal is equal to a L1-RSRP obtained by scaling a receiving power of the given reference signal according to a value indicated by a higher-layer parameter powerControlOffsetSS.

In one subembodiment, a SINR or a L1-SINR of the given reference signal is used to determine a second-type received quality corresponding to the given reference signal.

In one subembodiment, a second-type received quality that corresponds to the given reference signal is equal to a SINR or a L1-SINR of the given reference signal.

In one subembodiment, the given reference signal is any reference signal among the M reference signals.

In one embodiment, any second-type received quality among the M second-type received qualities is obtained by looking up in tables of an RSRP, a L1-RSRP, a SINR or a L1-SINR of a corresponding reference signal.

In one embodiment, the second reference threshold is a real number.

In one embodiment, the second reference threshold is a non-negative real number.

In one embodiment, the second reference threshold is a non-negative real number no greater than 1.

In one embodiment, the second reference threshold is equal to Q_{in_LR}.

In one embodiment, the definition of the Q_{in_LR} can be found in 3GPP TS38.133.

In one embodiment, the second reference threshold is configured by a higher layer parameter rsrp-ThresholdSSB.

In one embodiment, the M second-type received qualities respectively correspond to M reference thresholds, where the second reference threshold is a reference threshold corresponding to the first reference signal among the M reference thresholds.

In one embodiment, any of the M reference thresholds is equal to the second reference threshold.

In one embodiment, any of the M reference thresholds is a real number.

In one embodiment, any of the M reference thresholds is a non-negative real number.

In one embodiment, any of the M reference thresholds is a non-negative real number no greater than 1.

In one embodiment, there are two equal reference thresholds among the M reference thresholds.

In one embodiment, there are two unequal reference thresholds among the M reference thresholds.

In one embodiment, the M reference thresholds are mutually unequal.

In one embodiment, any of the M reference thresholds is configured by a higher layer parameter rsrp-ThresholdSSB.

In one embodiment, a reference threshold corresponding to any reference signal in the first reference signal subset among the M reference thresholds is equal to a first value, while a reference threshold corresponding to any reference signal in the second reference signal subset among the M reference thresholds is equal to a second value; the first value and the second value are respectively real numbers, the first value being unequal to the second value.

In one embodiment, upon reception of a higher-layer request, a physical layer of the first node transmits a second information block to a higher layer; herein, the second information block indicates M0 reference signal(s) and M0 second-type received quality/qualities, any one of the M0 reference signal(s) being one of the M reference signals, M0 being a positive integer no greater than the M; the M0 second-type received quality/qualities is/are respectively second-type received quality/qualities corresponding to the M0 reference signal(s) among the M second-type received qualities.

In one subembodiment, M0 is equal to 1.

In one subembodiment, M0 is greater than 1.

In one subembodiment, any of the M0 second-type received quality/qualities is no poorer than the second reference threshold.

In one subembodiment, any of the M0 second-type received quality/qualities is no poorer than a corresponding reference threshold.

In one subembodiment, the first reference signal is one of the M0 reference signal(s).

In one embodiment, the first condition set comprises a second condition, the second condition comprising that there exists a second-type received quality among the M second-type received qualities that is no poorer than the second reference threshold.

In one embodiment, the first condition set comprises a second condition, the second condition comprising that there exists a second-type received quality among the M second-type received qualities that is no poorer than a corresponding reference threshold.

In one embodiment, the first condition set comprises the first condition and the second condition.

In one embodiment, when and only when the first condition and the second condition are both satisfied, the first condition set is satisfied.

In one embodiment, if the second condition is unsatisfied, the first condition set is not satisfied.

In one embodiment, the second condition is that there exists a second-type received quality among the M second-type received qualities that is no poorer than the second reference threshold.

In one embodiment, the second condition is that there exists a second-type received quality among the M second-type received qualities that is no poorer than a corresponding reference threshold.

In one embodiment, M configuration information blocks respectively indicate the M reference signals; among the M configuration information blocks each configuration information block corresponding to a reference signal transmitted by the first cell comprises a first index, the first cell being identified by the first index; among the M configuration information blocks each configuration information block corresponding to a reference signal transmitted by the second cell comprises a second index, the second cell being identified by the second index; the first index and the second index are non-negative integers, respectively.

In one embodiment, the first index and the second index are respectively comprised of Q1 bits and Q2 bits, where Q1 and Q2 are two positive integers different from each other; Q2 is greater than Q1.

In one embodiment, any configuration information block among the M configuration information blocks is carried by an RRC signaling.

In one embodiment, any configuration information block among the M configuration information blocks comprises information in all or partial fields in an IE.

In one embodiment, any configuration information block among the M configuration information blocks comprises partial or all information in a candidateBeamRSList field in a BeamFailureRecoveryConfig IE.

In one embodiment, the first index is a SCellIndex corresponding to the first cell.

In one embodiment, the first index is a ServCellIndex corresponding to the first cell.

In one embodiment, the first index is a CellIdentity corresponding to the first cell.

In one embodiment, the first index is a PhysCellId corresponding to the first cell.

In one embodiment, the second index is a SCellIndex corresponding to the second cell.

In one embodiment, the second index is a ServCellIndex corresponding to the second cell.

In one embodiment, the second index is a CellIdentity corresponding to the second cell.

In one embodiment, the second index is a PhysCellId corresponding to the second cell.

### Embodiment 28

Embodiment 28 illustrates a schematic diagram of a second signal and a second signaling according to one embodiment of the present application; as shown in FIG. 28. In Embodiment 28, as a response to the action of transmitting a second signal, the first node monitors the second channel in the second time window, time-domain resources occupied by the second signal being used to determine the second time window.

In one embodiment, if the first node does not receive the second channel in the second time window, the first signal is triggered.

In one embodiment, when the first condition is satisfied, the second signal is triggered.

In one embodiment, the second signal comprises a baseband signal.

In one embodiment, the second signal comprises a radio signal.

In one embodiment, the second signal comprises a radio frequency signal.

In one embodiment, the second signal comprises a second characteristic sequence.

In one embodiment, the second characteristic sequence comprises one or more of a pseudo-random sequence, a Zadoff-Chu sequence or a low-PAPR sequence.

In one embodiment, the second characteristic sequence is different from the first characteristic sequence.

In one embodiment, the second characteristic sequence comprises a CP.

In one embodiment, the second signal comprises the first characteristic sequence.

In one embodiment, the second signal comprises a random access preamble.

In one embodiment, the second signal comprises a contention-free random access preamble.

In one embodiment, the second signal comprises a contention-free random access preamble used for a Beam Failure Recovery Request.

In one embodiment, the second signal comprises a RACH preamble.

In one embodiment, the second signal comprises UCI.

In one embodiment, the second signal comprises an LRR.

In one embodiment, the second signal comprises a MAC CE.

In one embodiment, the second signal comprises a BFR MAC CE or a Truncated BFR MAC CE.

In one embodiment, a channel occupied by the second signal includes a PRACH.

In one embodiment, a channel occupied by the second signal includes a PUSCH.

In one embodiment, a PRACH resource occupied by the second signal implicitly indicates a position of time-frequency resources of a PUSCH occupied by the second signal.

In one embodiment, a channel occupied by the second signal includes a UL-SCH.

In one embodiment, a random access preamble comprised in the first signal and a random access preamble comprised in the second signal correspond to a same random access preamble identifier.

In one embodiment, a random access preamble comprised in the first signal and a random access preamble comprised in the second signal correspond to different random access preamble identifiers.

In one embodiment, a random access preamble comprised in the first signal and a random access preamble comprised in the second signal belong to a same random access procedure.

In one embodiment, a random access preamble comprised in the first signal and a random access preamble comprised in the second signal respectively belong to the two different random access procedures.

In one embodiment, the sentence of monitoring a second channel has a same meaning as the sentence of monitoring a first channel, except for that the first channel is replaced by the second channel.

In one embodiment, the sentence of receiving/not receiving the second channel has a same meaning as the sentence of receiving/not receiving the first channel, except for that the first channel is replaced by the second channel.

In one embodiment, the action of monitoring a second channel in a second time window is performed in a third resource set.

In one embodiment, the sentence of monitoring a second channel has a same meaning as the sentence of monitoring a first channel, except for that the first channel is replaced by the second channel and the target resource set is replaced by the third resource set.

In one embodiment, the sentence of receiving/not receiving the second channel has a same meaning as the sentence of receiving/not receiving the first channel, except for that the first channel is replaced by the second channel and the target resource set is replaced by the third resource set.

In one embodiment, the third resource set is the first resource set.

In one embodiment, the third resource set is the second resource set.

In one embodiment, the second signal indicates a sixth reference signal; when the sixth reference signal belongs to the first reference signal subset, the third resource set is the first resource set; when the sixth reference signal belongs to the second reference signal subset, the third resource set is the second resource set.

In one embodiment, the second channel comprises a physical layer channel.

In one embodiment, the second channel comprises a layer 1 (L1) channel.

In one embodiment, the second channel is for an RNTI in the first identifier set.

In one embodiment, the second channel is identified by an RNTI in the first identifier set.

In one embodiment, the second channel comprises a downlink physical layer control channel (i.e., a downlink channel only capable of bearing physical layer signaling).

In one embodiment, the second channel comprises a PDCCH.

In one embodiment, the second channel is a PDCCH.

In one embodiment, the second channel is a PDCCH for an RNTI in the first identifier set.

In one embodiment, a second signaling is transmitted in the second channel.

In one embodiment, the second channel bears a second signaling.

In one embodiment, the first node monitors the second channel to detect a second signaling.

In one embodiment, the sentence of monitoring a second channel has a same meaning as the sentence of monitoring a first channel, except for that the first channel is replaced by the second channel and the first signaling is replaced by the second signaling.

In one embodiment, the sentence of receiving/not receiving the second channel has a same meaning as the sentence of receiving/not receiving the first channel, except for that the first channel is replaced by the second channel and the first signaling is replaced by the second signaling.

In one embodiment, the second signaling comprises a physical-layer signaling.

In one embodiment, the second signaling comprises a layer 1 (L1) signaling.

In one embodiment, the second signaling comprises DCI.

In one embodiment, an RNTI used for scrambling CRC of the second signaling includes a C-RNTI.

In one embodiment, an RNTI used for scrambling CRC of the second signaling includes a MCS-C-RNTI.

In one embodiment, an RNTI used for scrambling CRC of the second signaling includes a RA-RNTI.

In one embodiment, the second signaling comprises a random access response (RAR).

In one embodiment, the second signaling comprises a random access response (RAR) corresponding to a random access preamble comprised in the second signal.

In one embodiment, the second signaling comprises a second random access preamble identifier, the second random access preamble identifier matching with a random access preamble comprised in the second signal.

In one embodiment, the second signaling is transmitted on a PDCCH.

In one embodiment, the third resource set comprises a search space set.

In one embodiment, the third resource set is a search space set.

In one embodiment, the third resource set comprises one or more PDCCH candidates.

In one embodiment, the third resource set comprises all or partial PDCCH candidates in a search space set.

In one embodiment, the third resource set comprises a CORESET.

In one embodiment, the third resource set is a CORESET.

In one embodiment, the third resource set and the first resource set belong to a same search space set.

In one embodiment, the third resource set and the first resource set are associated with a same CORESET.

In one embodiment, the third resource set and the second resource set belong to a same search space set.

In one embodiment, the third resource set and the second resource set are associated with a same CORESET.

In one embodiment, the second time window is a consecutive duration.

In one embodiment, the second time window includes a ra-ResponseWindow.

In one embodiment, the second time window is a ra-ResponseWindow.

In one embodiment, the second time window comprises a time unit in which a ra-ResponseWindow is running.

In one embodiment, the second time window comprises a time unit in which a ra-ContentionResolutionTimer is running.

In one embodiment, the second time window includes a msgB-ResponseWindow.

In one embodiment, the second time window is a msgB-ResponseWindow.

In one embodiment, the second time window comprises a time unit in which a msgB-ResponseWindow is running.

In one embodiment, the second time window comprises one or more than one time unit.

In one embodiment, a unit of length of the second time window is a time unit.

In one embodiment, a number of time unit(s) comprised in the second time window is configurable.

In one embodiment, a number of time unit(s) comprised in the second time window is configured by a higher layer parameter.

In one embodiment, names of a higher layer parameter for configuring a number of time unit(s) comprised in the second time window include ra-Response Window.

In one embodiment, a first time unit in the second time window is after a time unit occupied by the second signal.

In one embodiment, a first time unit in the second time window is a time unit to which a PDCCH occasion for a first said third resource set following an end of a PRACH resource occupied by the second signal belongs.

In one embodiment, the second time window starts with a PDCCH occasion for a first said third resource set following an end of a PRACH resource occupied by the second signal.

In one embodiment, an end of the second time window is earlier than a start of the first time window.

In one embodiment, the second signal is earlier than the first signal in time domain.

In one embodiment, a length of the second time window is the same as a length of the first time window.

In one embodiment, a length of the second time window is different from a length of the first time window.

In one embodiment, the second signal carries an MsgA, while the second channel bears an MsgB, the second time window being a msgB-ResponseWindow.

In one embodiment, the second signal carries an Msg1, while the second channel bears an Msg2, the second time window being a ra-ResponseWindow.

In one embodiment, the second signal carries an Msg3, while the second channel bears an Msg4, the second time window comprising a time unit in which a ra-ContentionResolutionTimer is running.

In one embodiment, the second signal indicates a sixth reference signal; when the sixth reference signal belongs to the first reference signal subset, whether the second channel is received in the second time window is used to determine whether a value of the first counter is incremented by 1; when the sixth reference signal belongs to the second reference signal subset, whether the second channel is received in the second time window is used to determine whether a value of the second counter is incremented by 1.

In one embodiment, if the sixth reference signal belongs to the first reference signal subset and the second channel is not received in the second time window, the value of the first counter is incremented by 1.

In one embodiment, if the sixth reference signal belongs to the first reference signal subset and the second channel is received in the second time window, the value of the first counter is kept unchanged.

In one embodiment, if the sixth reference signal belongs to the second reference signal subset and the second channel is not received in the second time window, the value of the second counter is incremented by 1.

In one embodiment, if the sixth reference signal belongs to the second reference signal subset and the second channel is received in the second time window, the value of the second counter is kept unchanged.

In one embodiment, the sixth reference signal is one of the M reference signals.

In one embodiment, the first signal and the second signal respectively comprise two random access preambles that belong to a same random access procedure.

In one embodiment, the first signal and the second signal respectively comprise two random access preambles that belong to the two different random access procedures.

In one embodiment, whether the second channel is received in the second time window is used to determine whether the value of the third counter is cleared to zero.

In one embodiment, if the second channel is received in the second time window, the value of the third counter is cleared to zero.

In one embodiment, for the monitoring on the second channel in the second time window, the first node assumes a QCL parameter the same as the sixth reference signal.

In one embodiment, the first node assumes that a DMRS of the second channel and the sixth reference signal are QCL.

In one embodiment, the first node receives the sixth reference signal and monitors the second channel in the second time window using a same spatial domain filter.

In one embodiment, large-scale properties of a channel over which the sixth reference signal is conveyed can be used to infer large-scale properties of a channel over which the second channel is conveyed.

In one embodiment, the first condition set comprises the first condition, the second condition and the third condition.

In one embodiment, the first condition set consists of the first condition, the second condition and the third condition.

In one embodiment, when and only when all of the first condition, the second condition and the third condition are satisfied, the first condition set is satisfied.

In one embodiment, the first condition set comprises the first condition and the third condition.

In one embodiment, the first condition set consists of the first condition and the third condition.

In one embodiment, when and only when the first condition and the third condition are both satisfied, the first condition set is satisfied.

In one embodiment, if the third condition is unsatisfied, the first condition set is not satisfied.

In one embodiment, the third condition is not receiving the second channel in the second time window.

### Embodiment 29

Embodiment 29 illustrates a structure block diagram of a processing device used in a first node according to one embodiment of the present application; as shown in FIG. 29. In FIG. 29, a processing device 2900 in the first node comprises a first receiver 2901, a first processor 2902 and a first transmitter 2903.

In Embodiment 29, the first receiver 2901 receives a first reference signal group to determine a first-type received quality group, and as a response to the action of transmitting a first signal, monitors a first channel in a first time window; the first processor 2902 maintains a third counter according to the first-type received quality group; and the first transmitter 2903 transmits the first signal.

In Embodiment 29, the first-type received quality group comprises at least one first-type received quality, and time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the third counter is no less than a third threshold; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the first processor 2902 maintains at least one of the first counter or the second counter; herein, whether there is one condition being satisfied between a fourth condition and a fifth condition is used to determine whether to transmit a random access problem indication to a higher layer; the fourth condition comprises that a value of the first counter reaches a first threshold, and the fifth condition comprises that a value of the second counter reaches a second threshold.

In one embodiment, the first processor 2902 maintains the first counter and the second counter simultaneously.

In one embodiment, the first processor 2902 maintains the first counter and the second counter.

In one embodiment, a time duration in which the first processor 2902 maintains the first counter and a time duration in which the first processor 2902 maintains the second counter are overlapped.

In one embodiment, the first processor 2902 only maintains the first counter of the first counter and the second counter.

In one embodiment, the first processor 2902 only maintains the second counter of the first counter and the second counter.

In one embodiment, there is a reference signal in the first reference signal subset being associated with a first cell, and there is a reference signal in the second reference signal subset being associated with a second cell.

In one embodiment, a transmit (Tx) power of the first signal is equal to a first power value; when the first reference signal belongs to the first reference signal subset, a value of a fourth counter is used to determine the first power value; when the first reference signal belongs to the second reference signal subset, a value of a fifth counter is used to determine the first power value.

In one embodiment, the first processor 2902 maintains at least one of the fourth counter or the fifth counter; herein, a value of the first counter is used to maintain the fourth counter, while a value of the second counter is used to maintain the fifth counter.

In one embodiment, the first processor 2902 maintains the fourth counter and the fifth counter simultaneously.

In one embodiment, the first processor 2902 maintains the fourth counter and the fifth counter.

In one embodiment, a time duration in which the first processor 2902 maintains the fourth counter and a time duration in which the first processor 2902 maintains the fifth counter are overlapped.

In one embodiment, the first processor 2902 only maintains the fourth counter of the fourth counter and the fifth counter.

In one embodiment, the first processor 2902 only maintains the fifth counter of the fourth counter and the fifth counter.

In one embodiment, the first receiver 2901 receives M reference signals, where M is a positive integer greater than 1; herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

In one embodiment, the first transmitter 2903 transmits a second signal; as a response to the action of transmitting a second signal, the first receiver monitors a second channel in a second time window; herein, time-domain resources occupied by the second signal are used to determine the second time window; as a response to the first condition being satisfied, the second signal is triggered; the first condition set comprises a third condition, the third condition comprising not receiving the second channel in the second time window.

In one embodiment, the first node is a UE.

In one embodiment, the first node is a relay node.

In one embodiment, the first receiver 2901 comprises at least one of the antenna 452, the receiver 454, the receiving processor 456, the multi-antenna receiving processor 458, the controller/processor 459, the memory 460 or the data source 467 in Embodiment 4.

In one embodiment, the first processor 2902 comprises at least one of the receiver/transmitter 454, the receiving processor 456, the transmitting processor 468, the multi-antenna receiving processor 458, the multi-antenna transmitting processor 457, the controller/processor 459, the memory 460 or the data source 467 in Embodiment 4.

In one embodiment, the first transmitter 2903 comprises at least one of the antenna 452, the transmitter 454, the transmitting processor 468, the multi-antenna transmitting processor 457, the controller/processor 459, the memory 460 or the data source 467 in Embodiment 4.

### Embodiment 30

Embodiment 30 illustrates a structure block diagram of a processing device used in a second node according to one embodiment of the present application; as shown in FIG. 30. In FIG. 30, a processing device 3000 in the second node comprises a second receiver 3001 and a second transmitter 3002.

In Embodiment 30, the second receiver 3001 receives a first signal; as a response to the action of receiving a first signal, the second transmitter 3002 transmits a first channel in a first time window.

In Embodiment 30, time-domain resources occupied by the first signal are used to determine the first time window; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset.

In one embodiment, the second transmitter 3002 transmits a first reference signal sub-group; herein, any reference signal in the first reference signal sub-group belongs to the first reference signal group.

In one embodiment, there is a reference signal in the first reference signal subset being associated with a first cell, and there is a reference signal in the second reference signal subset being associated with a second cell.

In one embodiment, a transmit (Tx) power of the first signal is equal to a first power value; when the first reference signal belongs to the first reference signal subset, a value of a fourth counter is used to determine the first power value; when the first reference signal belongs to the second reference signal subset, a value of a fifth counter is used to determine the first power value.

In one embodiment, a value of the first counter is used to maintain the fourth counter, while a value of the second counter is used to maintain the fifth counter.

In one embodiment, the second transmitter 3002 transmits M1 reference signal(s), any reference signal of the M1 reference signal(s) being one of the M reference signals, M being a positive integer greater than 1 and M1 being a positive integer no greater than M; herein, any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

In one embodiment, the second receiver 3001 receives a second signal; as a response to the action of receiving a second signal, the second transmitter 3002 transmits a second channel in a second time window; herein, time-domain resources occupied by the second signal are used to determine the second time window; as a response to the first condition being satisfied, the second signal is triggered; the first condition set comprises a third condition, the third condition comprising that the second channel is not received in the second time window.

In one embodiment, the second node is a base station.

In one embodiment, the second node is a UE.

In one embodiment, the second node is a relay node.

In one embodiment, the second receiver 3001 comprises at least one of the antenna 420, the receiver 418, the receiving processor 470, the multi-antenna receiving processor 472, the controller/processor 475 or the memory 476 in Embodiment 4.

In one embodiment, the second transmitter 3002 comprises at least one of the antenna 420, the transmitter 418, the transmitting processor 416, the multi-antenna transmitting processor 471, the controller/processor 475 or the memory 476 in Embodiment 4.

### Embodiment 31

Embodiment 31 illustrates a schematic diagram of monitoring a first channel in a first time window according to one embodiment of the present application, as shown in FIG. 31. In Embodiment 31, whether the first reference signal belongs to the first reference signal subset or the second reference signal subset, the action of monitoring a first channel in a first time window is always performed in a first resource set.

In one embodiment, the target resource set is the first resource set.

### Embodiment 32

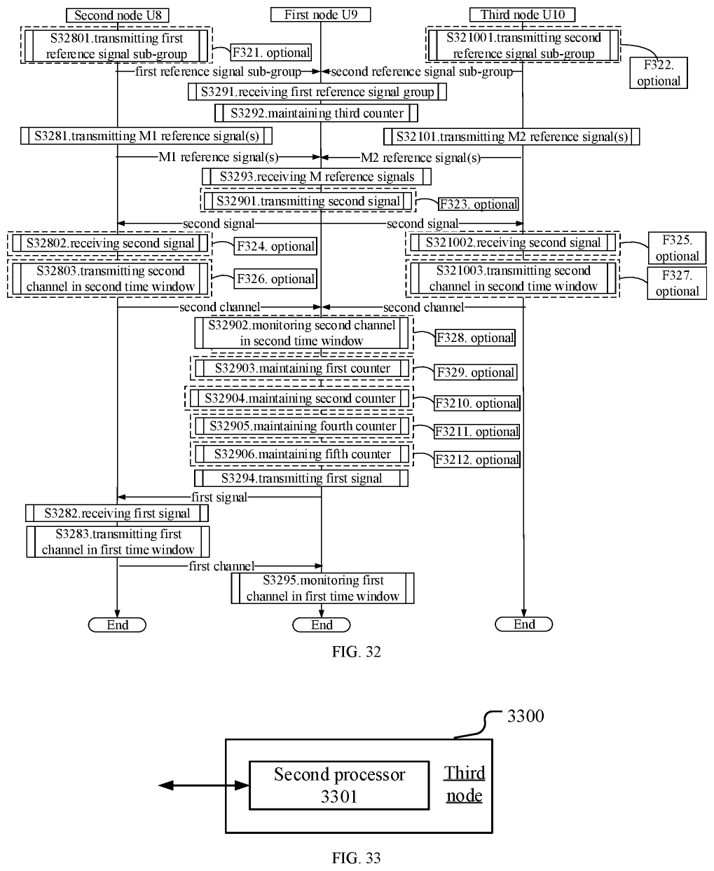

Embodiment 32 illustrates a flowchart of wireless transmission according to one embodiment of the present application, as shown in FIG. 32. In FIG. 32, a second node U8, a first node U9 and a third node U10 are communication nodes that mutually transmit through air interfaces. In FIG. 32, steps marked by boxes F321 to F3212 are optional, respectively.

The second node U8 transmits a first reference signal sub-group in step S32801; transmits M1 reference signal(s) in step S3281; receives a second signal in step S32802; and as a response to the action of receiving a second signal, transmits a second channel in a second time window in step S32803; receives a first signal in step S3282; and as a response to the action of receiving a first signal, transmits a first channel in a first time window in step S3283.

The first node U9 receives a first reference signal group in step S3291; maintains a third counter in step S3292; receives M reference signals in step S3293; and transmits a second signal in step S32901; as a response to the action of transmitting a second signal, monitors a second channel in a second time window in step S32902; maintains a first counter in step S32903; maintains a second counter in step S32904; maintains a fourth counter in step S32905; and maintains a fifth counter in step S32906; transmits a first signal in step S3294; and as a response to the action of transmitting a first signal, monitors a first channel in a first time window in step S3295.

The third node U10 transmits a second reference signal sub-group in step S321001; and transmits M2 reference signal(s) in step S32101; receives a second signal in step S321002; and as a response to the action of receiving a second signal, transmits a second channel in a second time window in step S321003.

In Embodiment 32, any reference signal of the M2 reference signal(s) belongs to the first reference signal subset or the second reference signal subset.

In one embodiment, the first node U9 is the first node in the present application.

In one embodiment, the second node U8 is the second node in the present application.

In one embodiment, the third node U10 is the third node in the present application.

In one embodiment, the third node U10 is a maintenance base station for a serving cell of the transmitter of the first signal.

In one embodiment, the third node U10 is a maintenance base station for a non-serving cell of the transmitter of the first signal.

In one embodiment, the second node is a maintenance base station for the first cell, while the third node is a maintenance base station for the second cell.

In one embodiment, there is one reference signal among the M reference signals that does not belong to the M2 reference signal(s).

In one embodiment, there isn't any reference signal among the M reference signals belonging to both the M1 reference signal(s) and the M2 reference signal(s).

In one embodiment, a sum of M1 and M2 is less than the M.

In one embodiment, a sum of M1 and M2 is equal to the M.

In one embodiment, there is a reference signal among the M reference signals belonging to neither the M1 reference signal(s) nor the M2 reference signal(s).

In one embodiment, any of the M reference signals belongs to the M1 reference signal(s) or the M2 reference signal(s).

In one embodiment, there is one reference signal among the M2 reference signal(s) that belongs to the second reference signal subset.

In one embodiment, any of the M2 reference signal(s) belongs to the second reference signal subset.

In one embodiment, there is one reference signal among the M2 reference signal(s) that belongs to the first reference signal subset.

In one embodiment, any of the M2 reference signal(s) belongs to the first reference signal subset.

In one embodiment, there aren't two reference signals among the M2 reference signals that belong to the first reference signal subset and the second reference signal subset respectively.

In one embodiment, there are two reference signals among the M2 reference signals that belong to the first reference signal subset and the second reference signal subset respectively.

In one embodiment, the step marked by the box F322 exists, any reference signal in the second reference signal sub-group belonging to the first reference signal group.

In one embodiment, there is one reference signal in the first reference signal group that does not belong to the second reference signal sub-group.

In one embodiment, the second reference signal sub-group comprises only one reference signal in the first reference signal group.

In one embodiment, the second reference signal sub-group comprises multiple reference signals in the first reference signal group.

In one embodiment, the first reference signal group consists of the first reference signal sub-group and the second reference signal sub-group.

In one embodiment, any reference signal in the first reference signal sub-group does not belong to the second reference signal sub-group.

In one embodiment, any reference signal in the second reference signal sub-group does not belong to the first reference signal sub-group.

In one embodiment, there isn't any reference signal in the first reference signal group that belongs to both the first reference signal sub-group and the second reference signal sub-group.

In one embodiment, any reference signal in the first reference signal group belongs to the first reference signal sub-group or the second reference signal sub-group.

In one embodiment, there is a reference signal in the first reference signal group that belongs to neither the first reference signal sub-group nor the second reference signal sub-group.

In one embodiment, the step marked by the box F322 in FIG. 32 does not exist.

In one embodiment, the step marked by the box F324 and the step marked by the box F325 cannot co-exist.

In one embodiment, the step marked by the box F324 exists, while the step marked by the box F325 does not exist.

In one embodiment, the step marked by the box F324 does not exist, while the step marked by the box F325 exists.

In one embodiment, the step marked by the box F326 and the step marked by the box F327 cannot co-exist.

In one embodiment, the steps marked by the box F324 and the box F326 both exist, while the steps marked by the box F325 and the box F327 do not exist.

In one embodiment, the steps marked by the box F324 and the box F326 do not exist, while the steps marked by the box F325 and the box F327 both exist.

### Embodiment 33

Embodiment 33 illustrates a structure block diagram of a processing device used in a third node according to one embodiment of the present application; as shown in FIG. 33. In FIG. 33, a processing device 3300 in the third node comprises a second processor 3301.

In Embodiment 33, the second processor 3301 transmits M2 reference signal(s), M2 being a positive integer.

In Embodiment 33, as a response to a first condition set being satisfied, a first signal is triggered; the first condition set comprises one or more conditions, when each condition in the first condition set is satisfied, the first condition set is satisfied; the first condition set comprises a first condition, the first condition comprising that a value of a third counter is no less than a third threshold; a first-type received quality group is used to maintain the third counter, and a first reference signal group is used to determine the first-type received quality group, the first-type received quality group comprising at least one first-type received quality; the first signal is used for random access; as a response to the action of transmitting the first signal, a transmitter of the first signal monitors a first channel in a first time window; time-domain resources occupied by the first signal are used to determine the first time window; the first signal indicates a first reference signal, the first reference signal belonging to a first reference signal subset or a second reference signal subset; when the first reference signal belongs to the first reference signal subset, whether the first channel is received in the first time window is used to determine whether a value of a first counter is incremented by 1; when the first reference signal belongs to the second reference signal subset, whether the first channel is received in the first time window is used to determine whether a value of a second counter is incremented by 1; the first reference signal subset comprises at least one reference signal, while the second reference signal subset comprises at least one reference signal, at least one reference signal in the second reference signal subset not belonging to the first reference signal subset; any reference signal of the M2 reference signal(s) belongs to the first reference signal subset or the second reference signal subset.

In one embodiment, the second processor 3301 transmits a second reference signal sub-group; herein, any reference signal in the second reference signal sub-group belongs to the first reference signal group.

In one embodiment, there is a reference signal in the first reference signal subset being associated with a first cell, and there is a reference signal in the second reference signal subset being associated with a second cell.

In one embodiment, a transmit (Tx) power of the first signal is equal to a first power value; when the first reference signal belongs to the first reference signal subset, a value of a fourth counter is used to determine the first power value; when the first reference signal belongs to the second reference signal subset, a value of a fifth counter is used to determine the first power value.

In one embodiment, a value of the first counter is used to maintain the fourth counter, while a value of the second counter is used to maintain the fifth counter.

In one embodiment, any reference signal of the M2 reference signal(s) is one of the M reference signals, M being a positive integer greater than 1 and M2 being a positive integer no greater than M; any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

In one embodiment, the second processor 3301 receives a second signal; as a response to the action of receiving a second signal, the second processor 3301 transmits a second channel in a second time window; herein, time-domain resources occupied by the second signal are used to determine the second time window; as a response to the first condition being satisfied, the second signal is triggered; the first condition set comprises a third condition, the third condition comprising that the second channel is not received in the second time window.

In one embodiment, the third node is a base station.

In one embodiment, the third node is a UE.

In one embodiment, the third node is a relay node.

In one embodiment, the second processor 3301 comprises at least one of the antenna 420, the transmitter/receiver 418, the transmitting processor 416, the receiving processor 470, the multi-antenna transmitting processor 471, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first reference signal group to determine a first-type received quality group, the first-type received quality group comprising at least one first-type received quality;
a first processor, maintaining a second counter according to the first-type received quality group; and
a first transmitter, transmitting a first signal;
wherein the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

2. The first node according to claim 1, wherein there is a reference signal in the first reference signal subset being associated with a first cell, and there is a reference signal in the second reference signal subset being associated with a second cell.

3. The first node according to claim 1, wherein as a response to the action of transmitting a first signal, the first receiver monitors a first signaling in a first time window; where time-domain resources occupied by the first signal are used to determine the first time window.

4. The first node according to claim 1, wherein the first processor maintains the first counter; where when the value of the first counter reaches a third threshold, indicating a random access problem to a higher layer, the third threshold being greater than the first threshold.

5. The first node according to claim 1, wherein the first transmitter transmits a second signal; as a response to the action of transmitting a second signal, the first receiver monitors a second signaling in a second time window; where time-domain resources occupied by the second signal are used to determine the second time window; as a response to the first condition being satisfied, the second signal is triggered; the first condition set comprises a second condition, the second condition comprising not receiving the second signaling in the second time window.

6. The first node according to claim 5, wherein the second signal is used to determine a second reference signal, a transmit (Tx) power of the first signal being equal to a first power value; whether the first reference signal and the second reference signal are a same reference signal is used to determine the first power value.

7. The first node according to claim 1, wherein the first receiver receives M reference signals, M being a positive integer greater than 1; where any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

8. A second node for wireless communications, comprising:
a second transmitter, transmitting a first reference signal sub-group, any reference signal in the first reference signal sub-group belonging to a first reference signal group, the first reference signal group being used to determine a first-type received quality group, the first-type received quality group comprising at least one first-type received quality; and
a second receiver, blind detecting a first signal;
wherein the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold; the first-type received quality group is used to maintain the second counter.

9. The second node according to claim 8, wherein there is a reference signal in the first reference signal sub set being associated with a first cell, and there is a reference signal in the second reference signal subset being associated with a second cell; the second node is a maintenance base station of the first cell;
or, as a response to an action of detecting the first signal, the second transmitter transmits a first signaling in a first time window; where the second receiver detects the first signal; time-domain resources occupied by the first signal are used to determine the first time window.

10. The second node according to claim 9, wherein whether the first signaling is received in the first time window is used to maintain the first counter.

11. The second node according to claim 8, wherein the second receiver blind detects a second signal; when the second signal is detected, as a response to the action of detecting the second signal, the second transmitter transmits a second signaling in a second time window; where time-domain resources occupied by the second signal are used to determine the second time window; as a response to the first condition being satisfied, the second signal is triggered; the first condition set comprises a second condition, the second condition comprising that the second signaling is not received in the second time window.

12. The second node according to claim 11, wherein the second signal is used to determine a second reference signal, a transmit (Tx) power of the first signal being equal to a first power value; whether the first reference signal and the second reference signal are a same reference signal is used to determine the first power value.

13. The second node according to claim 8, wherein the second transmitter transmits M1 reference signal(s) among M reference signals, M being a positive integer greater than 1 and M1 being a positive integer no greater than M; where any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.

14. A method in a first node for wireless communications, comprising:
receiving a first reference signal group to determine a first-type received quality group, the first-type received quality group comprising at least one first-type received quality;
maintaining a second counter according to the first-type received quality group; and
transmitting a first signal;
wherein the first signal is used for random access; the first signal indicates a first reference signal; the first reference signal is related to a value of a first counter; when the value of the first counter is no greater than a first threshold, the first reference signal belongs to a first reference signal subset; when the value of the first counter is greater than the first threshold, the first reference signal belongs to a second reference signal subset; the first reference signal subset comprises at least one reference signal, while the second reference signal subset comprises at least one reference signal, at least one reference signal in the second reference signal subset not belonging to the first reference signal subset; as a response to a first condition set being satisfied, the first signal is triggered; the first condition set comprises one or more conditions, when each condition in the first condition set is satisfied, the first condition set is satisfied; the first condition set comprises a first condition, the first condition comprising that a value of the second counter is no less than a second threshold.

15. The method according to claim 14, wherein there is a reference signal in the first reference signal subset being associated with a first cell, and there is a reference signal in the second reference signal subset being associated with a second cell.

16. The method according to claim 14, comprising:
as a response to the action of transmitting a first signal, monitoring a first signaling in a first time window;
wherein time-domain resources occupied by the first signal are used to determine the first time window.

17. The method according to claim 14, comprising:
maintaining the first counter;
wherein when the value of the first counter reaches a third threshold, indicating a random access problem to a higher layer, the third threshold being greater than the first threshold.

18. The method according to claim 14, comprising:
transmitting a second signal; and
as a response to the action of transmitting a second signal, monitoring a second signaling in a second time window;
wherein time-domain resources occupied by the second signal are used to determine the second time window; as a response to the first condition being satisfied, the second signal is triggered; the first condition set comprises a second condition, the second condition comprising not receiving the second signaling in the second time window.

19. The method according to claim 18, wherein the second signal is used to determine a second reference signal, a transmit (Tx) power of the first signal being equal to a first power value; whether the first reference signal and the second reference signal are a same reference signal is used to determine the first power value.

20. The method according to claim 14, comprising:
receiving M reference signals, M being a positive integer greater than 1;
wherein any reference signal in the first reference signal subset is one of the M reference signals, and any reference signal in the second reference signal subset is one of the M reference signals; measurements on the M reference signals are respectively used to determine M second-type received qualities; a second-type received quality corresponding to the first reference signal among the M second-type received qualities is no worse than a second reference threshold.
